(19) United States
(12) Patent Application Publication
(10) Pub. No.: US 2012/0158516 A1
(43) Pub. Date: Jun. 21, 2012

(54) SYSTEM AND METHOD FOR CONTEXT, COMMUNITY AND USER BASED DETERMINATIION, TARGETING AND DISPLAY OF RELEVANT SALES CHANNEL CONTENT

(76) Inventors: William Eric Wooten, III, Georgetown, TX (US); Tomasz Piotr Wala, Austin, TX (US)

(21) Appl. No.: 13/187,322

(22) Filed: Jul. 20, 2011

Related U.S. Application Data
(60) Provisional application No. 61/399,939, filed on Jul. 20, 2010.
(60) Provisional application No. 61/399,916, filed on Jul. 20, 2010.

(51) Int. Cl. G06Q 30/02

(52) U.S. Cl. 705/14.66

(57) ABSTRACT

In some embodiments, a method includes providing a set of content items to a user and receiving, from the user, a signal representing an opinion associated with a content item from the set of content items. A signal representing a request to pull the content item to a content collection of the user based on the opinion is received from the user. The request indicates an endorsement of the content item. A status of the content item is modified based on the opinion and the endorsement such that a second user is presented with the content item based on the status and not with the remaining content items from the set of content items.

### CROSS-REFERENCE TO RELATED APPLICATIONS

This application claims priority to and the benefit of U.S. Provisional Patent Application No. 61/399,939, filed Jul. 20, 2010, and entitled “System And Method For Internet-Connected Sales Channel Content Aggregation And Distribution,” and U.S. Provisional Patent Application No. 61/399,916, filed Jul. 20, 2010, and entitled “System And Method For Context, Community And User Based Determination, Targeting And Display Of Relevant Sales Channel Content,” each of which is incorporated herein by reference in its entirety.

### BACKGROUND

This invention relates generally to the field of advertising across various internet-connected channels. More particularly, embodiments of the invention relate to the provisioning of user-controlled and context-relevant content. Even more specifically, embodiments of this invention relate generally to the field of advertising, social media, social business and eCommerce; and specifically to companies, brands, agencies, media companies and marketers that advertise Items (including branding campaigns, products, media content, etc.) on their own or partner websites, social networks, mobile applications, IPTV or other internet-connected Sales Channels.

Today, individual consumers and internet-connected communities of consumers (“Customers”) are shown content, media, brand, product, and service (“Item”) advertisements on the Internet that are selected and “pushed” at Customers by Item manufacturers, service companies, brand companies, advertising agencies, affiliate marketers marketing/sales distribution companies, etc. (“Brands”). The Items that are shown are those that Brands pay advertising networks, social networks, mobile networks, search companies, etc. (“Advertisers”) and/or content portals, website owners, media companies, etc. (“Publishers”) to put in front of Customers for the purpose of driving demand and sales of Brand products and/or services. Most of the time, these advertisements are not what Customers are interested in, not delivered in a timely manner, not relevant to the context of the content they are viewing or conversations they are having, and not endorsed by trusted buying advisors (friends, experts, enthusiast community, social network, etc.) of the Customer. The ultimate goal in this model is revenue and margin through mass content distribution not delivering to the Customer the Item with the highest quality, best value and highest relevancy to the content or conversations the Customer is interested in.

The most common method for internet-based advertising consists of Brands paying Advertisers and Publishers to push their Item advertisements at Customers. The ads can be displayed as display ads, text, video, animation, pop-ups and other formats. The goal is to get the Customer's attention when they are viewing content in various internet-connected websites, social networks, media channels, intranets/extranets (for enterprise customers), mobile devices, IPTV broadcasts, etc. For example, Advertisers decide what Item advertisements are shown, and on which website properties in their network to display them based on their analysis of each website's content. That decision is often made by selecting an ad from the Brand that paid the most to have it displayed to a Customer—not based on what is the most appropriate Item or the best Item quality/value/relevance for the Customer. A second method is for Brands to utilize search engines to advertise Items. Search engine companies associate Brand advertisements to the Customer's search results based on which Brand paid the highest price to be associated with the Customer's search terms. In either of these two methods, the Customer is unable to distinguish or validate if other Customers would endorse this Item to them based on the Item's quality, value or relevance. A third method is a Customer going to an Item Brand's website and searching for an Item based on keywords and/or categories. Occasionally, these Items are rated by users of the website, giving the Customer some indication of Item quality. However, the Items shown are only those carried by that particular Brand, the Item ratings are not determined by the quality of the Customer's confidence/trust/relationship in the reviewer, and Items are not compared “head-to-head” against one another, across all available Items in the market/industry/channel

### SUMMARY

Embodiments of the systems and methods target and display Item Lists of highly-relevant advertisements by utilizing User-input and system-determined data and multiple processes which enables a Customer (“User”) or groups of Customers (“User Types”) to select, decide and/or influence: (1) which advertisements/endorsements/branding campaigns/media content/user-generated content (collectively, “advertisements”) should be targeted/displayed to system User(s) (including themselves) based on Item Quality, Item engagement, Buyer validation, context/channel relevance. etc., (2) which User or groups of Users (“User Types”, including online Communities) should be targeted and shown these highly-relevant advertisement(s), and (3) what content, context and sales channel should the advertisement(s)/campaign(s) be associated with (displayed in, next to, after viewing, etc.) to be most relevant to the User and/or User Type, across multiple internet-connected Sales Channels on a per display iteration basis.

Embodiments of the current invention make use of systems and methods to target and display highly-engaging, Customer-endorsed, Buyer-validated, contextually-relevant, Community-relevant, personalized and user-optimized (“highly-relevant”) brands, content, products and services (“Items”) as advertisements across multiple internet-connected Sales Channels, on a per-content iteration basis.

Embodiments of the current invention make use of systems and methods to target, deliver and display highly-engaging, Customer-endorsed, Buyer-validated, contextually-relevant, Community-relevant, personalized and user-optimized (“highly-relevant”) Items and Item Lists as advertisements via multiple Sales Channels including, but not limited to, websites (online content sites, forums, blogs, newspapers, communities, social networks, company intranets/extranets, etc.), communication clients/devices (email, chat, SMS, VoIP, etc.), mobile devices (cellphones, GPS, etc.), set-top devices (DVRs, Cable Modems, etc.), digital broadcasts (IPTV/Cable/SAT TV/Radio broadcasts), digital media (film, music, video, etc.), portable media devices (e.g. eReaders, iPods, digital radio, etc.), gaming systems (dedicated device [Xbox, Wii], Online, Client-installed, etc.), smart appliances (some LG refrigerators, Fugoo appliances, etc.), etc. (collectively, “Sales Channels”).

Embodiments of the current invention make use of systems and methods to target and display stackranked (for the purpose of determining display frequency and order) Item Lists as highly-relevant advertisements in one or more Sales Channels based on quantified Customer (including Buyer, Community, etc.) opinion feedback about quality, value, descriptions and other Customer-generated and system-generated data about Items, Customers/Users/Communities/Partners, Brands, User/Community Opinions/Endorsements, Content (e.g. websites, broadcasts, emails, branded videos, TV commercials, etc.), Sales Channel (e.g. IPTV, mobile device, etc.) and other types of data that the system tracks (collectively, “Entities”) utilizing a novel competitive “head-to-head” environment.

Embodiments of the current invention make use of systems and methods to target and display stackranked Item Lists as highly-relevant advertisements to system Users (individual Users, User Types, groups of Users, etc.) in one or more Sales Channels based on quantified Item Quality indicators (e.g. rating scores, review scores, purchases, Buyer satisfaction survey, Item social sharing, etc.) of Items in the system to display highly-engaging brands, content, products and services (“Items”) or lists of Items (“Item Lists”) as advertisements across multiple internet-connected Sales Channels (“Quality Targeting”).

Embodiments of the current invention make use of systems and methods to target and deliver and display Item/Item Lists as highly-relevant advertisements which have been validated by various types of Buyers (e.g. friends, communities, world, etc.) who purchased Items in the system, all for the purpose of increasing likelihood that a Customer will purchase a product based on the increase in relevancy, quality and trusted source of the Item endorsement (i.e. “Buyer-validated Targeting”).

Embodiments of the current invention make use of systems and methods to target and display stackranked Item Lists as highly-relevant advertisements in one or more Sales Channels based on quantified Customer engagement (e.g. numbers of impressions, ratings, reviews, purchases, detail views, brand comments, content social sharing, etc.) with Items in the system to display highly-engaging brands, content, products and services (“Items”) or lists of Items (“Item Lists”) as advertisements across multiple internet-connected Sales Channels (“Engagement Targeting”).

Embodiments of the current invention make use of systems and methods to target and display stackranked Item Lists as highly-relevant advertisements in one or more Sales Channels based on weighted Item quality opinion feedback (“Quality Targeting”) and Item Engagement feedback (“Engagement Targeting”) and, in addition, uses feedback from Buyers (and any other User Type, including Community, Friends, etc.) to validate both sets of feedback (“Buyer-validated Item Targeting”/“User Type-validated Item Targeting”).

Embodiments of the current invention make use of systems and methods to target and display Item Lists as advertisements which are highly-relevant to Users or groups of Users (“User Types”, including Users who are members of an online Community and/or location of a specific Community domain/property/device, such as Mothering.com, iPhone users, etc.), based on: (a) User(s)'s selection of individual/groups of Customers in the system they deem to be most appropriate to view them (e.g. based on interests, social network/community affiliations [used for “Social Targeting”], preferences, demographics, etc.) as well as which Item List display channel is most relevant; and/or (b) system-managed data about the User or groups of Users/User Types (e.g. item endorsements to other Customers, Customer profile, social network/community affiliations [used for “Social Targeting”], settings/preferences, item feedback ratings/reviews, purchase history, items viewed, item/content engagement, preferences of like-minded Customers, demographics data, etc.), via the system's “Personalized Targeting” process.

Embodiments of the current invention make use of systems and methods to enable Users to apply personalized settings and filters, such as a Personalized Item Score preference (indicating which User Types the Customer values opinions from, preferred brands, media companies/providers, Community content engagement, price ranges, value scores, interests, etc.). These stored settings are used when calculating and determining which Items to target and display to the User across multiple Sales Channels (“Personalized Targeting”).

Embodiments of the current invention make use of systems and methods to target and display Item Lists as highly-relevant advertisements based on Item quality opinion feedback and Item content engagement gathered by the system and various User Types, including World (all Users), Buyers, Top Reviews, Advisors (experts), Community (groups of users based on selection criteria, in particular those users that visit or are members of a “Partner” website, such as social network, enthusiast community, etc.) and Trusted Advisors (friends). The method and system enable User(s) to personalize (i.e. “Personalized Targeting”) their Item List display by selecting the weighted importance placed on the Item opinions of each Customer User Type.

Embodiments of the current invention make use of systems and methods to enable Users (such as a Community domain owner, Publisher site owner, social network owner, media company channel owner and/or members/viewers of those domains, social networks, media channels and individual Customers) to apply settings and filters (such as preferred brands, preferred products, preferred content/type, interests, price ranges, value scores, etc.). These stored settings are used when calculating and determining which Items to target and display as highly-relevant advertisements to User(s) visiting that property (e.g. community domain, publisher site, media channel, mobile device network, social network, etc.) across multiple Sales Channels (“Community Targeting”).

Embodiments of the current invention make use of systems and methods to target and display highly contextually-relevant lists of Items or lists of Items (“Item Lists”) as advertisements, based on Customers selection of Items most relevant as advertisements based on: (1) content and context as defined by system and/or User(s)-generated metadata, (2) content and context as defined by content keywords, and (3) sales channel(s) selected by the system and/or User(s), via the system's “Contextual/Channel Targeting” process.

Embodiments of the current invention make use of systems and methods to target and display user-optimized Item Lists (e.g. based on Item quality, Item engagement, buyer-validation, etc.), which combine high contextual-relevancy with relevancy to User(s), as advertisements of highly Customers-endorsed, Buyer-validated, highly-engaging Items based on combining the context/content/channel and personal/social preferences of the User(s) viewing the content, via the system's “Optimized Targeting” process.

Embodiments of the current invention make use of the method and system to target, deliver and display interactive, optimized Item Lists as advertisements/advertising campaigns across multiple internet-connected Sales Channels. The method and system enable Customers to personalize their display of Item Lists at any time, based on personal filters and preference settings, for an individual piece of content viewed in a specific sales channel (“Optimized Targeting”).

Embodiments of the current invention make use of systems and methods to enable Customers to easily find highly-relevant, highly-engaging, Customer-endorsed, Buyer-validated Items and share them with others through both system communication channels (e.g. system website, cross-website browser toolbar, embedded widgets [e.g. embedded in Partner websites/properties including, but not limited, to Facebook pages (both personal and brand-managed), Twitter, NewYorkTimes.com, NewsCorp/Fox Broadcasting, etc.], applications [e.g. iPhone application, Facebook application, etc.], personal web storefronts/blogs, etc.) and non-system communication channels (e.g. Items links/displays in email, chats, forums, Twitter, Facebook, Skype, etc.), etc., by making and/or receiving direct and/or indirect Item endorsements.

Embodiments of the current invention make use of systems and methods that utilize multiple Sales Channels as interfaces to a single integrated system of business logic and data repository(ies) to deliver and display highly-relevant, highly-engaging, Customer-endorsed, Buyer-validated interactive Items and Items Lists as advertisements (“Platform as a Service”).

Aspects and embodiments of the invention will provide the technical advantage of increasing advertising relevance, content relevance, user engagement, User targeting accuracy, Item marketing/quality/value data, sales conversion rates, and Customer satisfaction in purchased Items. The system enables Customers to more effectively find highly-engaging, highly-rated, buyer-validated and context/channel/user-relevant Items as advertisements based on endorsements made by system users they trust and select to help them in their purchase decisions. In addition, Customers will gain personal control over what and where Items are advertised across which multiple internet-connected Sales Channels, instead of impersonal and disconnected Advertisers and Publishers pushing often irrelevant/low-quality/low-engagement Items at them via traditional online/other Sales Channel marketing efforts in an attempt to drive purchases. Thus, the user relevancy, context relevancy or social relevancy of Items presented may be effectively increased in addition to allowing Items or other content to be pulled by Users (e.g. online Community member(s), media channel owner, etc.) from or placed in a collection of Items in a particular Sales Channel.

Accordingly, embodiments of the present invention may be effectively utilized with systems and methods for the aggregation and distribution of Sales Channel content. Embodiments of such systems and methods are disclosed in the provisional patent application entitled “System and Method for Internet-connected Sales Channel Content Aggregation and Distribution” by the same inventors, which is included herein in Appendix A.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1A is a block diagram illustrating one embodiment of a topology which may be used in conjunction with an implementation of embodiments of the present invention including one embodiment of an internet-connected content distribution system.

FIGS. 1B-1D are a process diagram of an embodiment of systems and methods whereby a Customer uses various presentation layers (“Sales channels”) to view, engage with, and purchase Item endorsements (e.g. content, products, services, etc.) which are displayed as advertisements/brand campaigns (e.g. branded content, TV commercials, YouTube videos, etc.), media content, and/or user-generated content made by another User (“Customer”), group of Users (“User Type”, including online community), company/brand/agency and/or the system (“Platform as a Service”) based on Customer Item opinions/endorsements, Buyer-validation, system interaction and personal preferences.

FIGS. 2A and 2B are an illustration of an embodiment of systems and methods whereby a User (“Customer”), groups of Users (“Communities”) and/or the system, (“Platform as a Service”) directly or indirectly select (e.g. to endorse, recommend/not recommend, provide opinion, etc.) an Item by filtering a system-targeted Item or Item List (e.g. containing content, products, services, etc.) which are displayed as content, including as advertisements (e.g. brand campaigns, TV commercials, etc.), to other system and non-system Users.

FIG. 3 is a diagram illustration of an example embodiment of the various Sales Channels across which the method and system can target, deliver and display highly-relevant, highly-engaging, Customer-endorsed and Buyer-validated advertisements including, but not limited to, a unique webpage/site, chat/email, IPTV broadcast, Cable/SAT TV broadcast, mobile device, e-Reader, digital radio broadcast, smart appliances and others.

FIG. 4 is a diagram illustration of an example embodiment of the various Sales Channels across which the method and system can target, deliver and display highly-relevant, highly-engaging, Customer-endorsed and Buyer-validated advertisements including, but not limited to, media company properties/assets, community sites, social networks, content publisher websites/properties/assets, communication company properties/assets, and others.

FIG. 5 is a process diagram illustrating an example embodiment of how the system intakes various example user and data inputs across Sales Channels in order to target and display highly-relevant, highly-engaging, Customer-endorsed, Buyer-validated and channel-formatted product endorsements back across those same sales channels (or other sales channels) in a closed-loop process.

FIG. 6 is a process diagram illustrating an example embodiment of how the system intakes user engagement and data inputs, across multiple processes to “close-the-loop” between delivering advertising campaigns and eCommerce purchases, in order to optimize the order (and campaign content) to display highly-engaging, Customer-endorsed, Buyer-validated, and user/content-relevant Items endorsements back across those and other sales channels.

FIG. 7 is an illustration of an example embodiment of method whereby a Customer can provide and rank the relative importance of metadata-based descriptions for an entity (in this case webpage categories and keywords).

FIG. 8 is an illustration of an example embodiment of a method using a standardized schema used to categorize system Entities such as webpages, items, etc. (in this case the DMOZ directory).

FIGS. 9A and 9B an illustration of an example embodiment of method for system to search Sales Channel data (e.g. URL, website source code, email text, IPTV broadcast metadata, digital radio show metadata, etc.) for keywords, categories, descriptions, etc.

FIG. 10 is an illustration of an example embodiment of method for Customers to input and rank the relative relevance of metadata such as categories, subcategories, keywords, channels, etc. associated with an entity (in this case an Item).

FIG. 11 is an illustration of an example embodiment of a method for Customers to provide and rank the relative relevance of metadata descriptions of an entity (in this case a User's interests, social/community affiliations, preferences (e.g. alert, channel, shopping, etc.), etc.

FIG. 12 is an illustration of an example embodiment of a method for a Customer to provide associations and relevancy between multiple Entities (e.g. single-Item-to-many-webpages, many-Items-to-many-webpages, Items-to-users, Items-to-multiple sales channels, etc.).

FIGS. 13A-13C are an illustration of a process diagram showing an example embodiment of how the system associates, prioritizes and determines the relative relevancy of metadata keywords between Entities that is used primarily for the purpose of creating lists of Items related to a specific piece of content (such as a unique webpage), Item categories and Customer interests.

FIG. 14 is an illustration of an example embodiment of a diagram showing a method to determine the priority assigned to and relative relevance between keywords associated with a “Primary Entity”, in this example a webpage (whose context is a man playing Frisbee in a park with his dog on a hot sunny day). Keywords are either manually associated with an Entity by users, or automatically by the system, as shown in FIGS. 5 through 10.

FIG. 15 is an illustration of an example embodiment of a scoring system used in the prioritization of Entity associations (e.g. relative relevancy) between Primary and Secondary Entities.

FIG. 16 is an illustration of an example embodiment of a process diagram showing a method to determine the overall score that a “Secondary Entity” (for example, a category of Entities in the system) is given when the keywords associated with those Entities are compared to (for example, individual relevance to) the keywords of the “Primary Entity”. Keywords are either manually associated with an Entity by users, or automatically by the system, as shown in FIGS. 5 through 10.

FIG. 17 is an illustration of an example embodiment of a process diagram showing a method to determine the overall score that a “Secondary Entity” (in this case, Items in the system) is given when the keywords associated with those Entities are compared to (for example, their individual relevance to) the keywords of the “Primary Entity”. Keywords are either manually associated with an Entity by users, or automatically by the system, as shown in FIGS. 5 through 10.

FIGS. 18A and 18B are an illustration of an example embodiment of a process flow showing how Item Lists are created based on an Entity's metadata tags.

FIGS. 19A and 19B are an illustration of an example embodiment of method for system to target and display a stackranked Item List based on a comparison of keyword data between any two or more Entities compiled based on their relevancy to the Sales Channel context (e.g. the subject(s)/topic(s) of a webpage, IPTV show, email, etc.) of one or more of the Entities (“Contextual Targeting”).

FIGS. 20A-20C are an illustration of an example embodiment of a method for the system to target and display a stackranked Item List based on the relevancy to the Customer using the system, including social/community/user relationships within or outside the system (used for “social targeting”), system transactions/interaction, etc. (“Personalized Targeting”).

FIG. 21 is an illustration of an example embodiment of a method for the system to target and display a stackranked Item List based on the combined relevancy of the Sales Channel context and the relevancy to the Customer using the system (“Optimized Targeting”).

FIG. 22 is an illustration of a process diagram showing an example embodiment of a method to calculate the World Item Score for an Item based on aggregating the individual Item Scores provided by all users/Customers in the system.

FIGS. 23A and 23B are an illustration of a process diagram showing an example embodiment of a method to calculate the System Item Score for an Item by aggregating the average Item Scores for a particular Item provided by each User Type of Customers, including World (all Customers), Buyers, Top Reviews, Community, Advisors (experts) and Trusted Advisors (friends) in the system.

FIGS. 24A and 24B are an illustration of a process diagram showing an example embodiment of method for system to calculate the stackranking (highest to lowest value) of all Items based on their individual Item Scores and/or Item Engagement Scores for the purpose of determining item display frequency and order within a particular Channel and/or to a particular User/User Type (e.g. specific online community such as Mothering.com). For example, the System Item Score may be calculated as a weighted average between the System Item Score (i.e. measure of quality) and the System Item Engagement Score (i.e. measure of content engagement) for each Item, and then all Items are stackranked based on their calculated scores.

FIG. 25 is an illustration of an example embodiment of a method and system to utilize an advertising delivery/eCommerce website to target and display highly-relevant, highly-engaging, Customer-endorsed, Buyer-validated Item Lists as advertisements to a Customer (“User”) or groups of Customers (“User Type”).

FIG. 26 is an illustration of an example embodiment of method and system to utilize a cross-website browser toolbar to deliver and display highly-relevant, highly-engaging Customer-endorsed, Buyer-validated Item Lists as advertisements to a Customer (“User”) or group of Customers (“User Type(s)”).

FIG. 27 is an illustration of an example embodiment of method and system to utilize a widget (for embedding in a Partner website) to target, deliver and display highly-relevant, highly-engaging, Customer-endorsed, Buyer-validated Item Lists as advertisements to a Customer or groups of Customers (“system member(s)” and/or “non-system member(s)”) viewing the partner website.

FIG. 28 is an illustration of an example embodiment of systems and methods to utilize an embeddable widget to target, deliver and display highly-relevant, highly-engaging, Customer-endorsed, Buyer-validated Item or Item Lists as advertisements (in this case, one personal collection of Items includes branded content as part of two brand campaigns) to a Customer or group of Customers in a sales channel. (in this case, the interactive widget is embedded in a Partner website property).

FIG. 29 is an illustration of an example embodiment of a system to enable users to easily configure their advertising/shopping experience in an advertising delivery/eCommerce website based on personal preferences so that only Items endorsed by a particular group of system users (e.g. their friends or advisors, social networks, enthusiast communities, users that have purchased the items they are viewing, users that have been identified as providing expert product opinions, etc.) are targeted and displayed in the system's advertising delivery/eCommerce website.

FIG. 30 is an illustration of an example embodiment of a system to enable users to easily configure their shopping experience via a widget embedded in a partner website so that only Items endorsed by a particular group of system users they wish to see (e.g. their friends or advisors, social network(s), enthusiast community(ies), users that have purchased the items they are viewing, users that have been identified as providing expert product opinions, etc.) are targeted and displayed in the widget.

FIGS. 31A and 31B are an illustration of an example embodiment of a process diagram showing a method to determine and display highly-relevant, highly-engaging, Customer-endorsed, Buyer-validated Item Lists based on user-determined the level of importance given to each average Item Score provided by individual User Types in the system, calculated as the Personalized Item Score. For example, the system can calculate the Personalized Item Score by using the following Customer-specified score: 30% of World Item Score (all Customers), 10% of Buyer Item Score, 10% of Top Reviews Item Score, 40% of Advisor Item Score, 0% of Community Item Score and 10% of Trusted Advisor Item Score.

FIG. 32 is an illustration of an example embodiment of a system to enable users to easily configure their advertising/shopping experience in on an advertising delivery/eCommerce website based on personal preferences so that only Items with property scores (e.g. price, value, style, eco-friendliness, etc.) that fall within a user-specified range are displayed. Property scores are either set by the Item manufacturer/Brand (e.g. price, availability, MPG, etc.) or by the system users such as Item buyers, reviewers, etc. (e.g. value, style, durability, etc.) are displayed in the system's advertising delivery/eCommerce website.

FIG. 33 is an illustration of an example embodiment of a process diagram showing a method to determine and display highly-relevant, highly-engaging, Customer-endorsed, Buyer-validated Item Lists through the system determining what Items appear in the primary Item list to the User/User Types per viewing session per Channel, or the User (in particular, Partner site owners and/or Partner-selected Community members) determining what Items appear in the primary Item list to the User/User Types per viewing session per Channel, or both are happening in parallel. An example of an implementation where the system is the primary driver would be the system using stored system data to determine Item display, whereas an example of a user/Partner being the primary driver would be a Partner-branded storefront in which the Partner is manually selecting specific Items (from the highly-relevant, highly-engaging, Customer-endorsed, Buyer-validated list of Items) ad-hoc for display as advertisements.

FIGS. 34A and 34B are an illustration of a process diagram showing an example embodiment of a method for the system to determine, target and display new stackranked highly-relevant, highly-engaging, Customer-endorsed, Buyer-validated Item Lists based on the Customer selecting new Item metadata to personalize their display list.

FIG. 35 is an illustration of an example embodiment of a process diagram showing a method to determine, target and display new stackranked highly-relevant, highly-engaging, Customer-endorsed, Buyer-validated Item Lists as advertisements based on the Customer selecting new keyword/search metadata to personalize the displayed Item List.

FIG. 36 is an illustration of an example embodiment of a process diagram showing a method to determine, target and display new stackranked Item Lists based on the Customer selecting new value setting for an Item Property (e.g. cost, value, style, MPG, etc.) to personalize the displayed highly-relevant, highly-engaging, Customer-endorsed, Buyer-validated Item List being displayed as advertisements.

FIG. 37 is an illustration of an example embodiment of a process diagram showing a method to determine, target and display new stackranked highly-relevant, highly-engaging, Customer-endorsed, Buyer-validated Item Lists based on the Customer selecting the opinions of a new User Type (Advisor, Community, Trusted Advisor, Buyer, Top Reviews, etc.) to personalize the displayed Item List.

FIGS. 38A and 38B are an illustration of an example embodiment of a method for determining, targeting and displaying new highly-relevant, highly-engaging, Customer-endorsed, Buyer-validated Item Lists that are relevant to the Customer when they override the currently displayed Item Lists by searching for an Item in the system, browsing to a new webpage, etc.

FIG. 39 is an illustration of an example embodiment of a method for determining, targeting and displaying new highly-relevant, highly-engaging, Customer-endorsed, Buyer-validated Item Lists as advertisements based on a Customer search for an Item in the system.

FIGS. 40A and 40B are an illustration of process diagram showing how the Customer makes a purchase, of highly-relevant, highly-engaging, Customer-endorsed, and Buyer-validated Item(s), in the system.

FIG. 41 is an illustration of an example embodiment of method and system to enable the Customer to make a purchase, of highly-relevant, highly-engaging, Customer-endorsed, and Buyer-validated Item(s), in the cross-website browser toolbar.

FIG. 42 is an illustration of an example embodiment of Customer making a purchase, of highly-relevant, highly-engaging, Customer-endorsed, and Community Buyer-validated Item(s), through the system via a widget embedded in a partner website, in this case Facebook (e.g. Ning, MySpace, LinkedIn, Digg, Wall Street Journal Online, CNNMoney, Fortune, etc.).

FIG. 43 is an illustration of an example embodiment of method and system to enable the Customer to find and select the fulfillment vendor that was most highly endorsed by Customers in the system for that particular Item.

FIG. 44 is an illustration of an example embodiment of how a Customer who previously purchased an Item (“Buyer”) provides a opinion data on: the Item, any Customers (“Promoters”) that influenced the purchase decision (including Customers that wrote Item Reviews), the fulfillment vendor that the buyer purchased the Item from, Item category/keywords, and a Buyer Item Score as part of the Buyer Satisfaction Survey (“CSAT”). The Buyer Item Score is utilized to validate the System Item Score as well as the Item Scores provided for other Customer User Types (e.g. world, community, friends, etc.).

FIG. 45 is an illustration of an example embodiment of a method for the system to update Entity (Item/User/Vendor/Brand) Scores (e.g. System Item Score) and associated metadata based on the opinions of a Customer that has purchased an Item in the system and completed the Buyer satisfaction survey (“CSAT”). The Buyer Item Score (as calculated for an individual Customer User Type) is also used to validate each Customer User Type Item Score.

FIG. 46 is an illustration of an example embodiment of method and system to target and display a stack-ranked highly-relevant, highly-engaging, Customer-endorsed, Buyer-validated Item List as advertisements (in this case, a Brand campaign scrolling with multiple Items/advertisements, which are being shown one at a time) via an embedded widget to a Customer viewing a content site including, but not limited to, in this case the NewYorkTimes.com (e.g. WallStreetJournal.com, CNNMoney.com [e.g. Fortune.com], FoxNews.com, etc.).

FIG. 47 is an illustration of an example embodiment of method and system to target and display a stack-ranked highly-relevant, highly-engaging, Customer-endorsed, Buyer-validated Item List (in this, case an advertising campaign scrolling with multiple Items, which are being shown one at a time) via an embedded widget to a Customer viewing a content aggregation site including, but not limited to, in this case Yahoo News (e.g. Google News, Yahoo News, MSN News, AOL News, YouTube, etc.).

FIG. 48 is an illustration of an example embodiment of method and system to target and display a stack-ranked highly-relevant, highly-engaging, Customer-endorsed and Community Buyer-validated Item List as advertisements via a Partner/Publisher website (in this case, an advertising campaign delivered inside a blog post). In the Partner/Publisher website, the Partner/Publisher and their community are the primary driver of the method whereby Items are displayed in the list based on the feedback (thumb up/down, comments, alternative ad suggestions, etc.) by the Community members of what ads should continue to be displayed in the ad display interface (in this case, an embeddable interactive widget).

FIG. 49 is an illustration of an example embodiment of method and system to target and display a stack-ranked highly-relevant, highly-engaging, Customer-endorsed and Community Buyer-validated Item List as advertisements via a “Partner branded” version of the system interface. In the Partner-branded site, the Partner is the primary driver of the method whereby Items are displayed in the list. For example, the Partner decides if they want to manually select which Items display, whether their Partner site users (their “Community”) can influence Item display, or whether the Partner wants to use the overall system recommendations from other Sales Channels.

FIG. 50 is an illustration of example embodiment of Customer sharing an highly-relevant, highly-engaging, Customer-endorsed, Buyer-validated Item display (from Partner-embedded widget) via a social network including, but not limited to, in this case Twitter (e.g. Facebook, Ning, MySpace, Bebo, LinkedIn, etc.).

FIG. 51 is an illustration of example embodiment of Customer sharing an highly-relevant, highly-engaging, Customer-endorsed, Buyer-validated Item display (in this case, a Brand campaign scrolling with multiple Items/advertisements, which are being shown one at a time) delivered in Partner-embedded widget via a social network including, but not limited to, in this case Twitter (e.g. Ning, MySpace, Bebo, LinkedIn, etc.).

FIG. 52 is an illustration of example embodiment of Customer sharing an highly-relevant, highly-engaging, Customer-endorsed, Buyer-validated Item display (in this case, two separate Brand campaigns scrolling with multiple Items/advertisements, which are being shown one at a time) delivered in two Partner-embedded widgets via a social network including, but not limited to, in this case Facebook (e.g. Ning, MySpace, Bebo, LinkedIn, etc.).

FIG. 53 is an illustration of example embodiment of Customer sharing a highly-relevant, highly-engaging, Customer-endorsed, Buyer-validated Item display (within their personal space [e.g. Facebook “Wall”]) via a social network including, but not limited to, in this case Facebook (e.g. Ning, MySpace, Bebo, LinkedIn, etc.).

FIG. 54 is an illustration of example embodiment of Customer sharing a highly-relevant, highly-engaging, Customer-endorsed, Buyer-validated Item display via an online forum including, but not limited to, in this case Mothering.com's forums (e.g. blog, etc.).

FIG. 55 is an illustration of an example embodiment of Customer sharing a highly-relevant, highly-engaging, Customer-endorsed, Buyer-validated Item display via a messaging client including, but not limited to, such as Skype.

FIG. 56 is an illustration of an example embodiment of method and system to target and display a stack-ranked highly-relevant, highly-engaging, Customer-endorsed, Buyer-validated Item List to a Customer utilizing a mobile device including, but not limited to, in this case an iPhone (e.g. Blackberry, Droid, etc.)

FIG. 57 is an illustration of an example embodiment of method and system to target and display a stack-ranked highly-relevant, highly-engaging, Customer-endorsed, Buyer-validated Item List as advertisements to a Customer viewing a digital media broadcast including, but not limited to such as Hulu (e.g. ABC.com, Viacom, etc.), in this case using a embeddable interactive widget.

FIG. 58 is an illustration of an example embodiment of method and system to target and display a stack-ranked highly-relevant, highly-engaging, Customer-endorsed, Buyer-validated Item List as advertisements to a Customer utilizing including, but not limited to, an IPTV, Cable TV, Satellite TV, etc. broadcast, in this case via an embeddable toolbar below the channel content (e.g. TV show).

FIG. 59 is an illustration of an example embodiment of method and system to target and display a stack-ranked Item List as advertisements to a Customer utilizing a portable media device/eReader including, but not limited to, in this case an Amazon Kindle (e.g. Sony Reader, Apple iPad, etc.).

FIG. 60 is an illustration of an example embodiment of method and system to target and display a stack-ranked highly-relevant, highly-engaging, Customer-endorsed, Buyer-validated Item List to a Customer utilizing a digital radio broadcast including, but not limited to, in this case Sirius/XM radio.

FIG. 61 is an illustration of an example embodiment of method and system to target and display a stack-ranked highly-relevant, highly-engaging, Customer-endorsed, Buyer-validated Item List to a Customer utilizing an internet-connected gaming including, but not limited to, in this case Grand Theft Auto (e.g. Xbox, Farmville, PS3, NCSoft, etc.)

FIG. 62 is an illustration of an example embodiment of method and system to display a stack-ranked Item List to a Customer utilizing a smart appliance including, but not limited to, in this case LG Smart Refrigerator (e.g. Fugoo appliance, etc.).

FIG. 63 is an illustration of example embodiment of systems and methods delivering highly-relevant, highly-engaging, Customer-endorsed, Buyer-validated Item display (in this case, multiple branded campaigns displaying Items/advertisements which include TV commercials, YouTube video, celebrity endorsements, eCommerce products, interactive games, etc.) delivered via the system's advertising delivery/eCommerce system.

FIGS. 64A and 64B are an illustration of a process diagram showing an example embodiment of a method to calculate the System Item Engagement Score for an Item by aggregating the average Item Engagement Scores for a particular Item provided by each User Type of Customers, including World (all Customers), Buyers, Top Reviews, Community, Advisors (experts) and Trusted Advisors (friends) in the system based on the engagement of Users with the Item weighted by User Type settings.

FIG. 65 is an illustration of an example embodiment of systems and methods to utilize the Multi-Dimensional Scaling (MDS) methodology to determine and optimize the relevancy between properties associated with the various entities in the system (Items, Users, User Types, Vendor, Brands, etc.). For example, Item properties would be quality scores, engagement scores, associated interest keywords, etc. User/User Type (such as Community) properties would be demographic properties, interest properties, engagement properties, etc. The MDS methodology analyzes entity-to-entity data as a matrix of I vectors in N-dimensional space (specified a priori) in which a distance function is defined, δi,j:=distance between iₜₕ and jₜₕ objects. These distances produce a dissimilarity matrix, such as shown in FIG. 65.

The goal of MDS is, given Δ, to find I vectors χ₁, . . . , χ_{I}ε [symbol] ^{N} such that ∥χᵢ−χⱼ∥≈δ_{i,j} for all i,jεI, where ∥•∥ is a vector norm. This norm is usually the Euclidean distance, but more generally it may be a metric or arbitrary distance function. MDS attempts to find an embedding from the I objects into R^{N} such that distances are preserved. If the dimension N is chosen to be 2 or 3, vectors xᵢ can be plotted to obtain a visualization of the similarities between the I objects. Note that the vectors xi are not unique: with the Euclidean distance, they may be arbitrarily translated and rotated since these transformations do not change the pairwise distances ∥χᵢ−χⱼ∥. There are various approaches to determining the vectors xᵢ. By examining variations of (χ₁, . . . , χ_{I}), for example,

$${min}_{{x}_{1} , … , {x}_{I}} {\sum }_{i < j} {( ‖ {x}_{i} - {x}_{j} ‖ - {δ}_{i , j} )}^{2} ,$$

MDS can be used to optimize data sets. Embodiments of the systems and methods utilize MDS to optimize entity similarities and maximize advertising relevancy to Users. As an alternative approach, the weighted multi-dimensional methodology (WMDS) can be utilized to optimize the advertising relevancy between the Item quality, Item engagement and User/Community Interest(s) (as well as Contextual Interests).

FIG. 66 is an illustration of an example embodiment of a method in which opinions from ten distinct communities (having the interest property keyword ‘strollers’) regarding five different Items related with the same keyword are captured in a matrix.

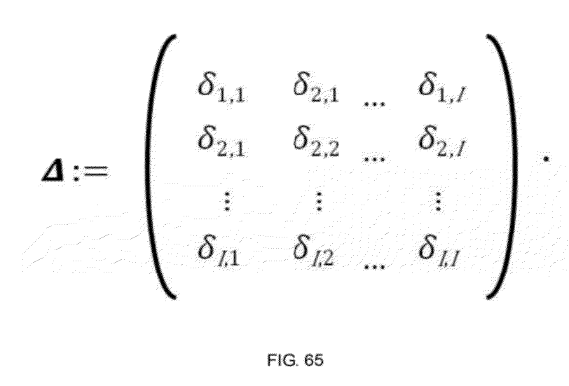

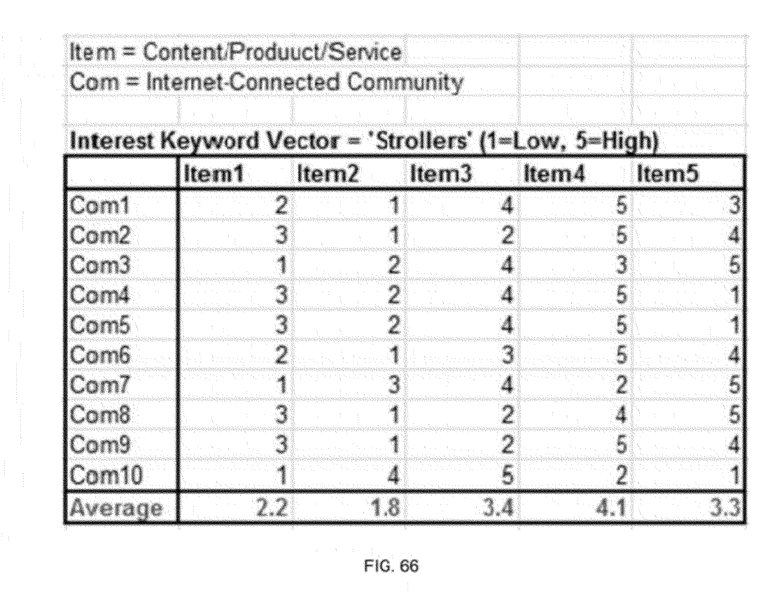

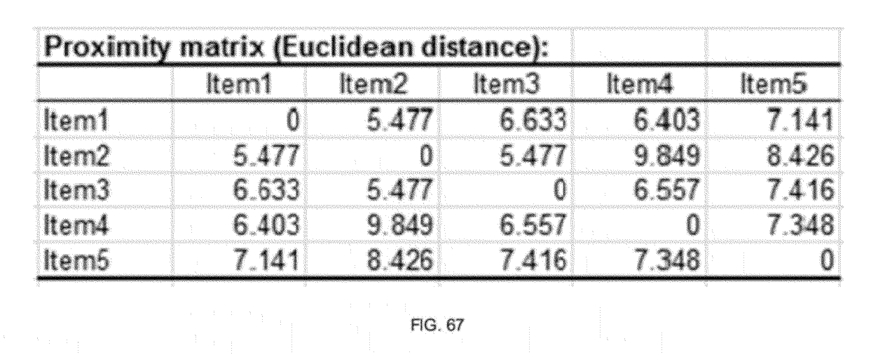

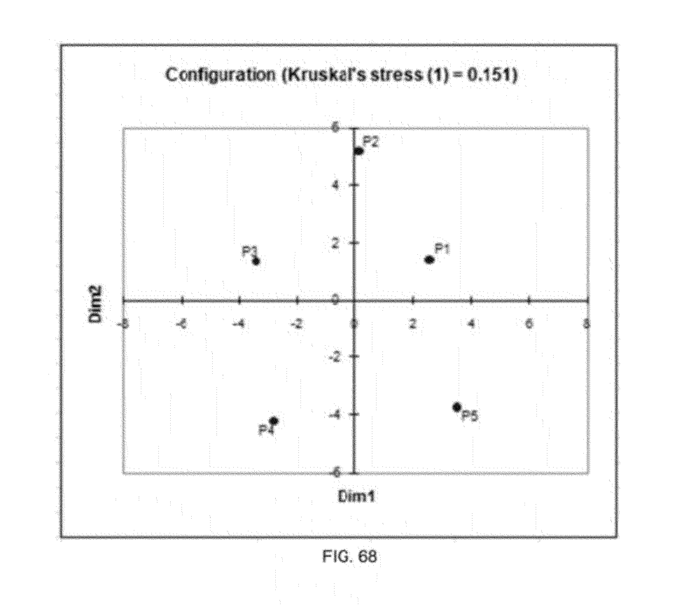

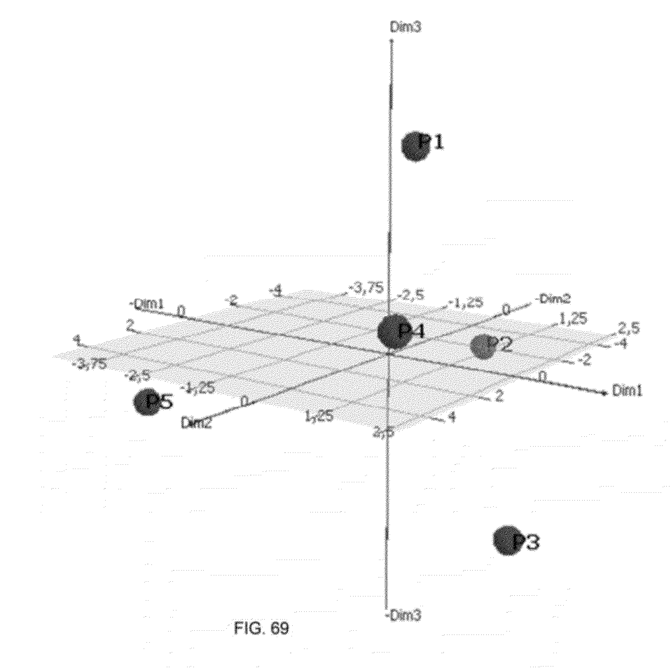

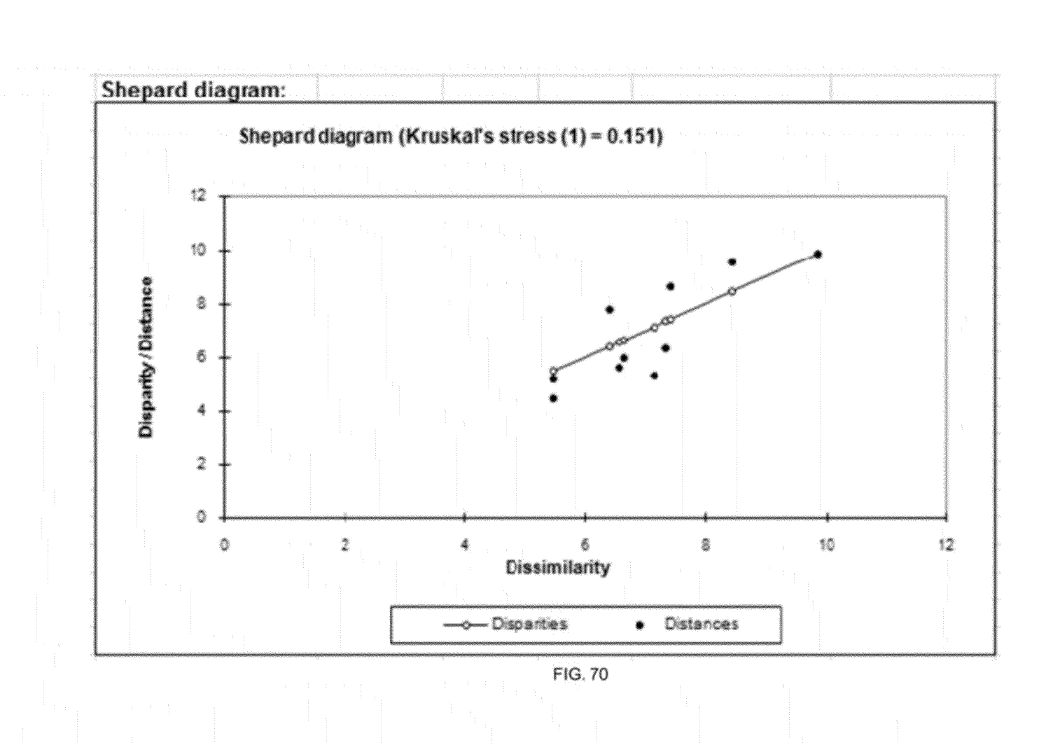

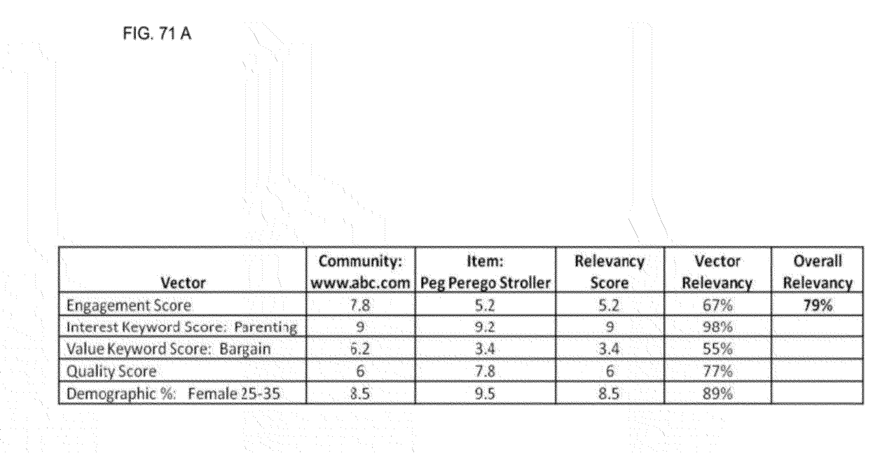

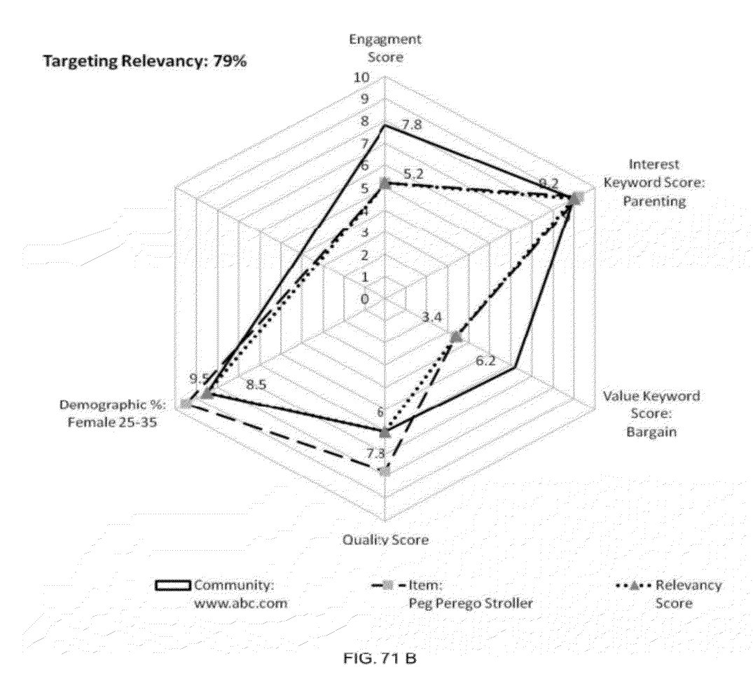

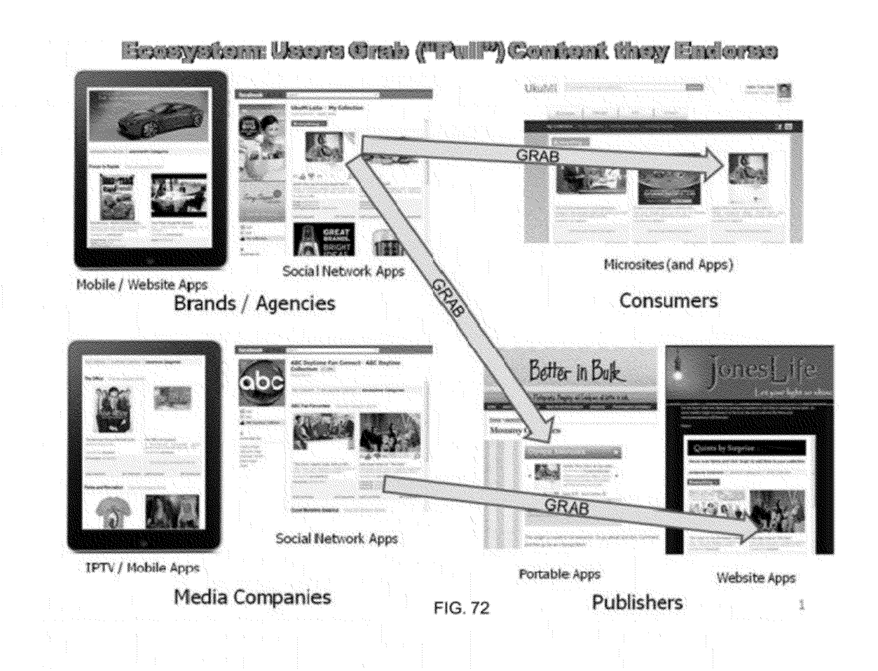

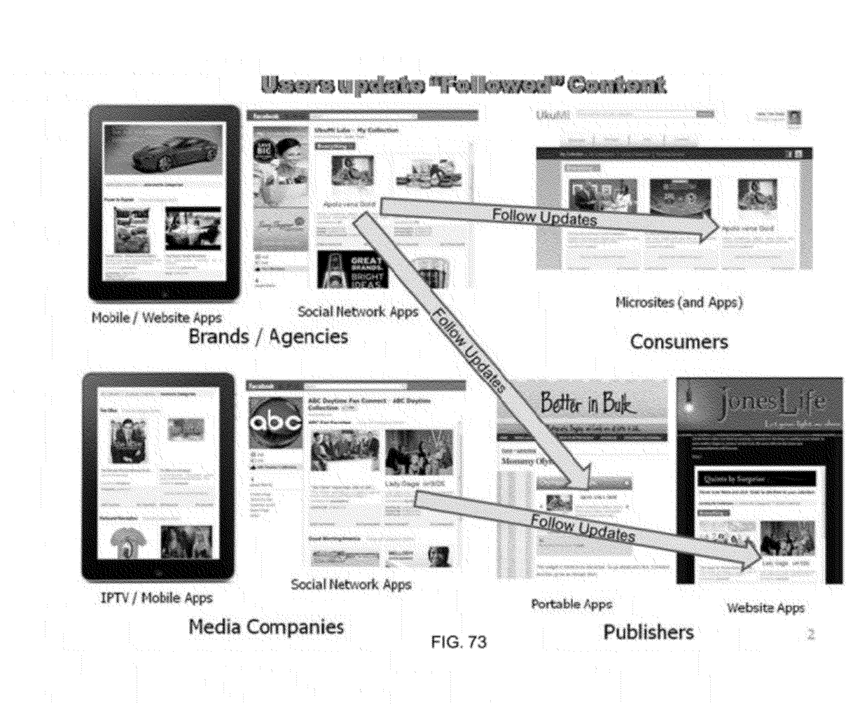

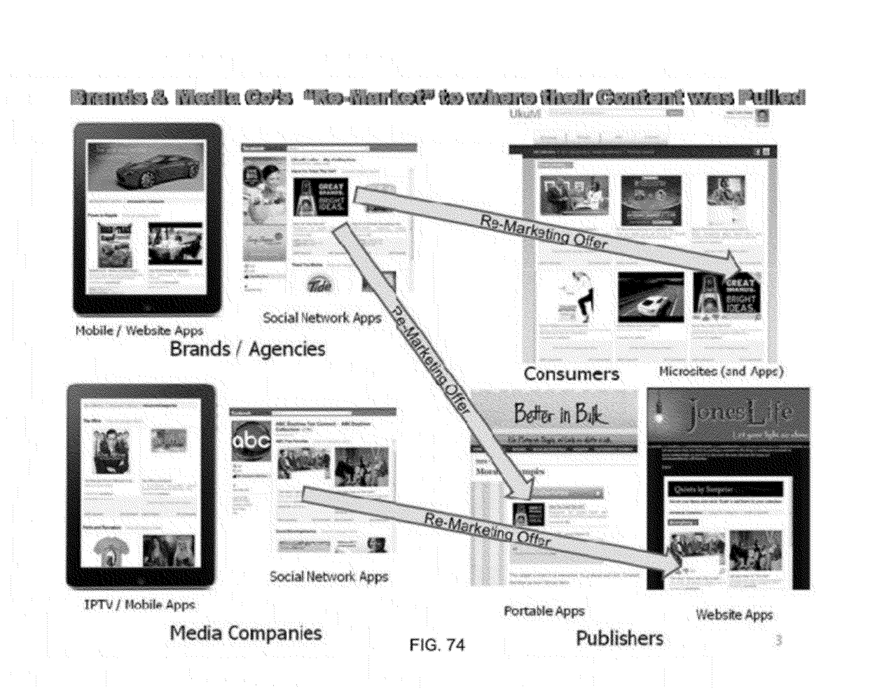

FIG. 67 is an illustration of an example embodiment of method in which Multi-Dimensional scaling (MDS) methodology is used to produce a proximity matrix from the data in FIG. 65 demonstrating Euclidean distance between the Item opinions.

FIG. 68 is an illustration of an example embodiment of method in which Multi-Dimensional Scaling (MDS) methodology is used to produce a 2D chart from the proximity matrix in FIG. 66 demonstrating that Communities with the interest of ‘strollers’ have collectively distinguished between Items 1-5. Item 2 (P2) shows more relevance to the keyword ‘strollers’ than Item 4 (P4), which is the least associated with the keyword.

FIG. 69 is an illustration of an example embodiment of method in which a 3D chart using the compiled Multi-Dimensional Scaling (MDS) data in FIGS. 66-67 demonstrates that Items 2 (P2) and 4 (P4) are dimensionally opposed. By looking at the initial data set, we can see that Communities (e.g. online communities, viewers of a TV broadcast, mobile device users, etc.) have significantly preferred Item 2 (P2). We can also see that, although they have similar average scores, Item 3 (P3) and Item 5 (P5) are not in close proximity due to Community opinions being opposed on occasion. This can be explained by analyzing a related property keyword (such as the brand of the stroller), which influences which strollers are preferred by some Communities and not by others.

FIG. 70 is an illustration of an example embodiment of method in which a Shepard diagram derived from Multi-Dimensional Scaling (MDS) data can be used to gain an indicator of the quality of the MDS analysis. The Shepard diagram produces a scatter plot in which the abscissa represents the observed disparities, and the ordinates are the matrix distances generated by the MDS analysis. The closer that the ordinate points are to the abscissa, the more confidence in the relevancy measurement. If the abscissa closely follows the ordinates the chart is reliable. If the points are on the same line, then the relevance and correlation between entities and their measured properties is perfect. In this case, the ordinate points parallel the abscissa fairly closely, indicating high confidence in the MDS analysis results for that scoring matrix.

FIGS. 71A and 71B are an illustration of an example embodiment of an alternative method in which to compare relevancy between system entities (such as an Item and Community). Using various property scores (engagement, interest, value, quality, etc.) within the system (all Users, specific User Types, etc.) associated with both the Community and the Item, a simple, high-level relevancy indicator between two or more entities (Items, Users, User Types, Communities, Vendors, Brands, etc.) can be obtained. This is done by entering in property scores (in this case engagement scores, interest keyword scores, quality scores and demographics scores) for the entities (in this case Community “www.abc.com” and Item Peg Perego stroller) into a scoring matrix and plotting them on a radar chart. The overlap of the entities is then calculated using the lower bound of each entity scores per property (the “Relevancy Score”), and this is plotted over the entities. The Relevancy score is divided by the upper bound of the entity property scores to produce a relevancy score per property (the “Vector Relevancy”). By taking the average (or the weighted average) of the Vector Relevancies (in this instance a simple average), the overall high-level relevancy match between the two entities can be obtained (the “Overall Relevancy”). This relevancy score can be used to drive various system and User activities, in this case indicating a 79% relevancy in targeting the Peg Perego stroller advertisement to the www.abc.com Community. For instance, the 79% score could trigger a system process causing the ad to be automatically displayed in this Community due to its high relevancy projection for Community members.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, diagram, article, or apparatus that comprises a list of elements is not necessarily limited only those elements but may include other elements not expressly listed or inherent to such process, diagram, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. For example, though certain embodiments of the present invention will be described with respect to applications in electronic commerce (eCommerce), it will be understood that other embodiments may be equally usefully applied in other contexts such as in decision engines, reputation engines, discovery platforms for content, or in other desired contexts not specifically elaborated on herein. Similarly, and in conjunction with the above, though the term “Customer” has been used in describing certain embodiments of the application in an eCommerce context, it should be noted that a “Customer” is a specific example of a user in a eCommerce context and should not be taken as in any way limiting as other types of users may utilize other embodiments of the present invention with equal utility and efficacy. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment,”

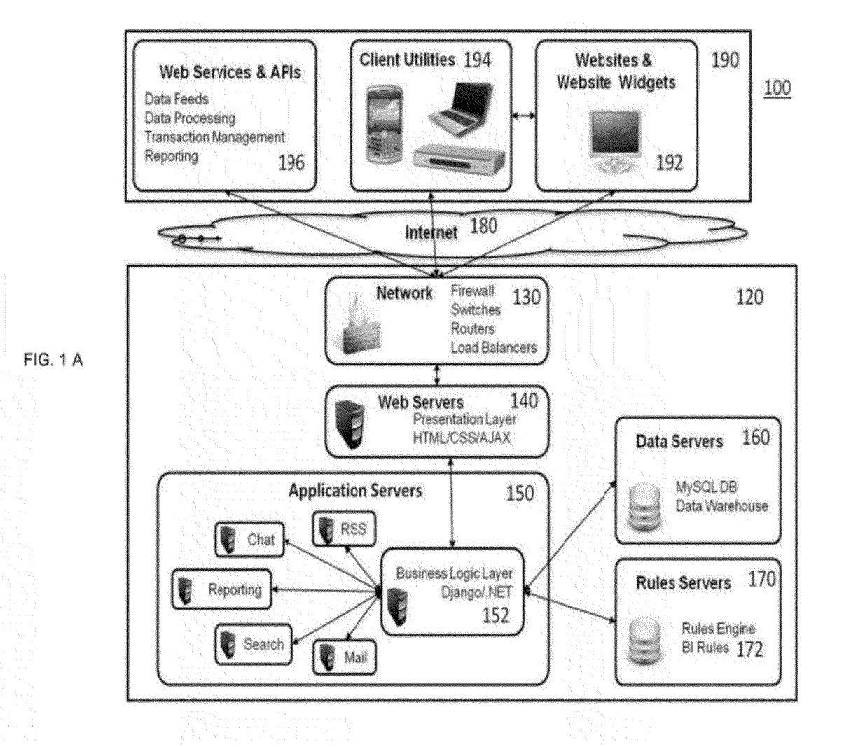

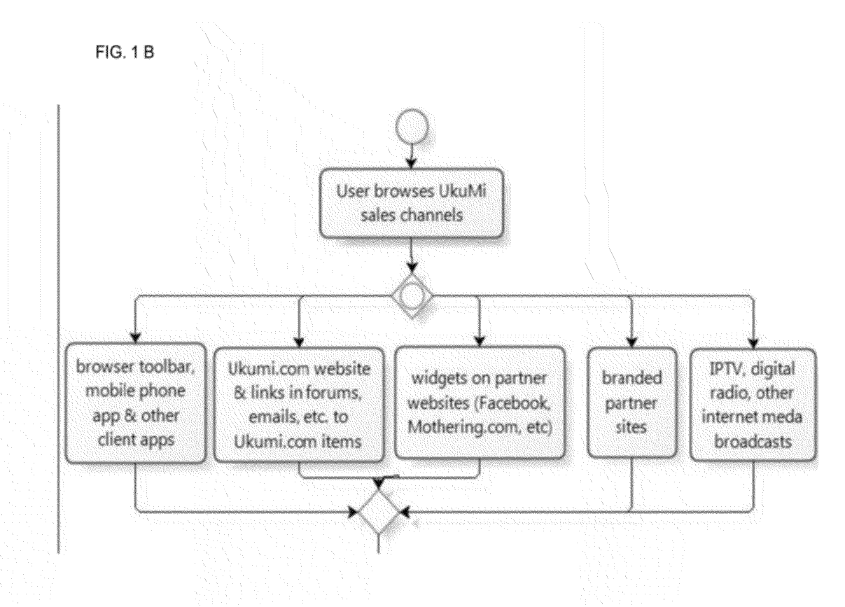

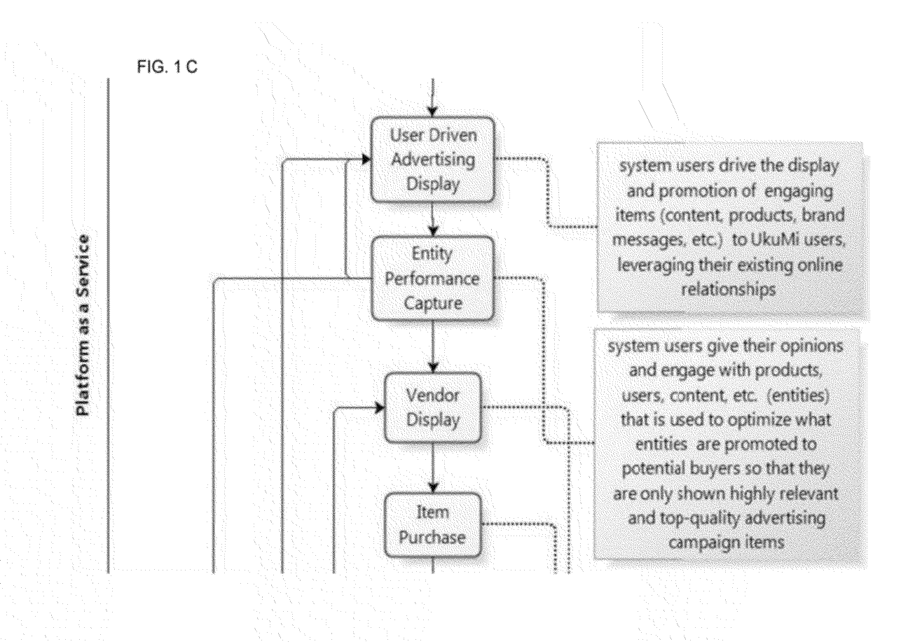

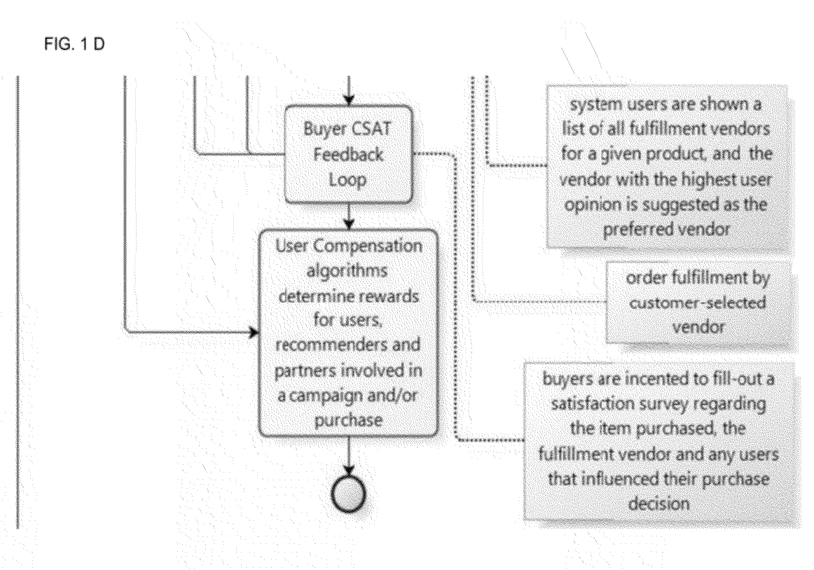

Embodiments of the systems and methods of the present invention may be better explained with reference to FIG. 1A which depicts one embodiment of a topology which may be used to implement embodiments of the systems and methods of the present invention. Topology 100 comprises internet-connected content distribution system 120 comprising one or more computing devices which implement a network layer 130, one or more computing devices which implement presentation layer 140, one or more computing devices which implement business logic layer 150, one or more computing devices which implement data server 160 and one or more computing devices which implement rules server 170. These computing devices may, for example, be organized as a cluster which may be a loosely or tightly coupled cluster.

Accordingly, computing devices comprising internet-connected content distribution system 120 may be coupled to one another and network 180 utilizing network layer 130 which may comprise computing devices such as firewalls, switches, routers, load balancers, etc. More specifically, internet-connected content distribution system 120 may be coupled through network 180 to one or more computing devices 190 (e.g. computer systems, personal data assistants, mobile devices [cellphones, portable multimedia players, e-book readers, etc.], personal shopping devices, digital video recorders, kiosks, cable modems, set-top boxes, VoIP devices, IPTV devices, smart appliances, dedicated terminals, etc). These computing devices 190 may comprise user computing devices and third-party data sources which are operable to provide, for example, market data, advertising data, product data, reporting data, affiliate data, transaction data, etc. through a variety of mechanisms which may include, for example, web services and/or APIs 196 or almost any other way of providing such data. Network 180 may be for example, the Internet, a wide area network (WAN), a local area network (LAN) or any other type of conventional or non-electronic communication link such as cellular networks cable networks (e.g. for television or other content), mail, courier services or the like.

Generally speaking then, users at computing devices 190 may view a wide variety of content through network 180 (which may be provided by other computing devices coupled to network 180 which are not shown in FIG. 1A), including content related to various Items, services, etc. (collectively referred to herein as products or Items) which they may be interested in purchasing or otherwise obtaining. Before purchasing or obtaining such goods, services, etc., however, a user may wish to be appraised of alternatives, reviews, ratings, endorsements, satisfaction ratings or other information related to an Item in which he is interested.

In many cases, users may access reviews or endorsements by accessing a site on network 180 where reviews, ratings, etc. are submitted by users, however there is no guarantee about how these reviews, ratings, rankings, etc. are obtained or determined by such a third-party site. Similarly it may be imagined that reading such reviews and rankings, etc. on a site at which an Item may be purchased (such as a manufacturer's or retailer's site) may also be suspect. Thus, in most cases, today a user cannot trust Brand and or marketer provided internet-connected content related to Items.

This situation is exacerbated when it comes to ads for various Items. In almost all cases, users are only shown advertisements for Items which are selected and pushed by manufactures or retailers. Consequently, Items that are presented to a user through advertisements are driven strictly through the desire to generate revenue and margin and are not necessarily in the user's best interest or in some cases may not even be user context driven. As a consequence, in most cases, when a user wishes to obtain content related to an Item in which he is interested in, he must manually seek out and obtain such content and manually evaluate such data based on nothing else but his own knowledge base.

What is desired then are systems and methods through which a user can effectively find, purchase or otherwise obtain information on Items in which they are interested. In particular, it may be desired that a user can be presented with Items or other content pertinent to their interests, where the Items or other content provided has been determined based, at least in part, on information from one or more trusted sources (such as friends, members of a social network, affinity communities, etc.) or actual purchasers of the provided Items or content. Specifically, it may be desired by a user to be presented with context sensitive data, where this context sensitive data has been determined at least in part, through other sources and methods than either the provider of the context itself or the manufacturer or retailer of the Item.

To that end, user computer devices 190 may have installed on them a client utility 194 which is operable to present data generated by internet-connected content distribution system 120 to the user, or alternatively a website provided by a computing device which may be accessed by a user at a computing device 190 may have an embedded website widget 192 operable to present such content (in the following description, the functionality of embodiments of the present invention will be described with respect to client utility 194, however, it should be understood that the description of this functionality may equally well apply to embodiments of an embedded website widget 192 or other means to access or provide content through including client utilities, such as a browser, a toolbar integrated into a browser, various applications (for example, used in conjunction with a DVR, mobile device, etc.), a dedicated website which the user may access (for example, UkuMi.com), embedded widgets or pages on certain websites, etc.), etc. In particular, client utility 194 may be integrated with, for example, a web browser on a user's computing device 190 such that context information related to a user's activity (for example, a URL or source code related to a URL which the user is accessing) may be provided to the internet-connected content distribution system 120.

The internet-connected content distribution system 120 may then generate context sensitive content to be provided to the user, where the context sensitive content is generated based on that context utilizing business logic layer 152 implemented by the computing devices at business logic layer 150, a rules engine 172 implemented at the one or more computing devices implementing the rules server 170 and the data in data server 160. The context sensitive content may, for example, comprise a ranked list of Items associated, at least in part, with the context of content the user is viewing. This content may then be formatted or otherwise tailored to a user (for example, to a user's device, browser, language, etc.) by the presentation layer 140 and sent to the client utility 194 on the user computer device 190 for display to the user in conjunction with the context of the user (for example, the web page, Item, etc. which the user is currently viewing). The user may also interact with client utility 194 to refine the context sensitive content presented. In one embodiment, a user may specify parameters associated with a category or a class of users and the context sensitive content will be refined based upon the user specified parameters.

Moreover, client utility 194 may provide the ability for a user to generate content associated with the context being viewed, be presented with context sensitive content or manipulate data associated with the context sensitive content, such that the user generated content or manipulated data may be returned to internet-connected content distribution system. Specifically, in certain embodiments, client utility 194 may provide the ability for a user to reorder the Items presented to reflect the user's preferences, to generate reviews, ratings, endorsements rankings, associate or disassociate categories or keywords with presented Items or the user context, etc. such that this user generated content or manipulated data may be sent from client utility 194 to internet-connected content distribution system 120. Furthermore, when a user purchases an Item the internet-connected content distribution system 120 may track information associated with such a purchase, including, for example, any user who made an endorsement which led to the purchase, relationships between a purchaser and an endorser, etc. A user satisfaction survey may also be presented to a user through client utility 194 so a user can validate the quality of the Item as well as accuracy of an endorsement.

The data obtained through client utility 194 may be stored in the data servers 160 along with data obtained from one or more computing device 190 which may be third-party data source. These third party data sources may for example, provide data such as Item catalogs, reporting information, affiliate information or other forms of data relating to manufacturers, vendors, Brands, retailers sites, etc. In one embodiment, these third party data sources may comprise web services 196 such that internet-connected content distribution system 120 wishes to obtain data from a third party data source a web services request may be sent from internet-connected content distribution system 120 to the computing device 190 of the third-party data source and receive the desired information in return. AS will be noted, in addition to obtaining data using web services and APIs, data may also be served using these same methods. In general, in certain embodiments, data may be both obtained and served using web services, APIs, etc.

Application servers 150 implementing business logic layer 152 may, in turn, utilize the data in data servers 160 to generate context sensitive content to present to user. More specifically, in one embodiment, business logic layer 152 may receive context information and user specified parameter information (if any) in conjunction with an internet-connected Sales Channel (such as a web channel, a mobile device channel, a chat channel, a search channel, a mail channel, an RSS channel, a reporting channel, etc.) and select content from data servers 160 to be presented to the user based on the context information and user specified parameter information. This content may be selected based upon rules implemented by rules engine 172.

Thus, rules engine 172 implemented on the one or more rules server 170 may be operable to implement a set of rules to apply to select, rank or otherwise evaluate or organize content in data servers 160. Thus, based on a context and any user specified parameters and using rules engine 170, context sensitive content such as a ranked list of Items may be selected for presentation to a user.

For example, in operation, a user may “surf” to a particular website or page of a website using a browser application on the user computing device 190. Data associated with the context being viewed by the user (for example, a URL, source code associated with the URL of the website) or other information may be collected by the client utility 194 on the user computing device 190 and sent to the internet-connected content distribution network 120.

Application servers 150 may receive the context data and any other data. Rules engine 172 at rules server 170 may be accessed by business logic layer 152 using the received context and other data to select data from data servers 160. The selected data may comprise context sensitive content including a ranked list of Items and any desired associated information such as categories associated with the user's context or ranked Items. This context sensitive content may then be passed to the web servers at the presentation layer 140 to be formatted or otherwise configured for presentation to the user. The configured context sensitive content is then passed to client utility 194 on the user's computing device 190 where it is presented to the user in conjunction with the context the user is currently viewing (in other words, the user may be viewing the context and the context sensitive content generated based on that context presented through client utility 194 simultaneously).

The user may then interact with client utility 194 to refine the context sensitive content being presented to the user. For example, the user may specify one or more parameters (e.g. type of user, category, interest keyword, etc.) such that the content presented may be refined using this specified parameter. In one embodiment, the client utility 194 may send this user specified parameter to internet-connected content distribution system 120 where application servers 150 may receive the user specified parameter and once again business logic layer 152 may use rules engine 172 at rules server 170 to select data from data servers 160 using the specified parameter such that this newly selected context sensitive content may presented to the user through client utility 194.

The user may also use client utility 194 to generate, or manipulate, content associated with the context being viewed in the browser or the context sensitive content being presented through client utility 194. This user generated or manipulated content may then be sent to internet-connected content distribution system 120 where business logic layer 152 on application servers 150 may save this user generated or manipulated content in data servers 160 such that this user generated or manipulated content may in the future affect which content is selected by rules engine 172 (for example, by influencing the ranking or the rules implemented by rules engine 172, etc.).

Thus, embodiments of the present invention provide the novel ability to enable Customers (“Users”) to select, decide, influence, endorse and/or pull (e.g. into collection of favorite Items) which Items are targeted and displayed as highly-relevant advertisements within discrete pieces of content (e.g. a webpage, digital broadcast, email, etc) that are delivered across multiple Sales Channels (e.g. web, mobile device, IPTV, Cable/SAT TV, eReader, gaming, etc.); the novel ability to enable Users to select, decide, influence, endorse and/or pull which Items are targeted and displayed to specific audiences (e.g. viewers with a particular interest, visitors to a specific domain/media property [Mothering.com, Facebook.com, NewYorkTimes on Apple iPad, etc.] or within a particular demographic, etc.) within discrete piece(s) of content and across various Sales Channels; the novel ability to use captured direct “word-of-mouth” endorsements between a Customer (“system user”) and another Customer(s), whether they are “system user(s)” or “non-system user(s)”, to quantify and calculate a normalized System Item Score for each Item in order to target and display Customer-endorsed and Buyer-validated Item Lists as highly-relevant advertisements; the novel ability to target and display a stackranked (high-to-low) list of Items based on Item quality opinion feedback, Item content engagement and Buyer-validation of that feedback and relevancy about/with each Item and related pieces of content and/or users via data gathered across multiple feedback processes and Sales Channels in order to determine Item display frequency, method, Channel, order, etc.; the novel ability to track Customer opinion feedback about Items, content and users, and then analyze, target and display this opinion, endorsement and pull data by social relationships (“User Types”) as related to the Customer—such as Trusted Advisors (Customer-selected friends and community members), Advisors (Customer-selected experts), World (all Customers), Community (“Partner” website domain, members of Facebook, etc.), Buyers (users that have bought the Item the Customer is interested in), etc.; the novel ability to factor in Customer-determined opinion of the context of any piece of content in a particular sales channel to determine relevancy of any Item in the system Item catalog, and select the highest-relevancy Items to target and display as advertisements in relation to that content and with that/other sales channel(s); the novel ability for a User(s) to personalize the targeting and display of Item Lists as highly-relevant advertisements based on individual preferences and system setting; and the novel ability to continually update the Items that are targeted and displayed in Item Lists as highly-relevant advertisements based on additional User(s) and system data including, but not limited to, Item opinion feedback, Item content engagement, preferences/settings, changes in content and/or channel, etc., across multiple sales channels, at the same time (e.g. IPTV, mobile, web, eReader, etc.).

Embodiments of the systems and methods enable a Customer or groups of Customers (“Users”) to select, decide and/or influence which advertisements/endorsements/branding campaigns/media content/user-generated content (collectively, “advertisements”) are displayed as an Item or Item List to a single User or groups of Users (“User Types”, including online Communities), across multiple internet-connected Sales Channels.

Embodiments of the systems and methods target and display Item Lists of highly-relevant advertisements by utilizing User(s)-inputed and/or system-determined data which enables a Customer (“User”) and/or groups of Customers (“User Types”) to select, decide and/or influence: (1) which advertisements/endorsements/branding campaigns/media content/user-generated content (collectively, “advertisements”) should be targeted/displayed to other User(s) (based on Item Quality, Item engagement, Buyer validation, context/channel relevance, etc.), (2) which User or groups of Users (“User Types”, including online Communities) should be targeted and shown those highly-relevant advertisement(s), and (3) what content, context and sales channel should the advertisement(s) be associated with and displayed in/next to be most relevant to the User and/or User Type, across multiple internet-connected Sales Channels on a per display iteration basis (“Optimized Targeting”).

Embodiments of the systems and methods utilize a closed-loop platform (“Platform as a Service”) which: (1) enables User(s) to filter/select/pull the Item/Item Lists that the User(s) endorse/promote as advertisements (“User-Driven Advertising Display”), (2) captures User/system feedback about the Item/Item Lists displayed as advertisements, including Item Quality opinion, Item Content Engagement feedback, etc. (“Entity Performance Capture”), (3) displays User(s)-endorsed Brands for the Item (“Brand Display”), (4) processes/enables purchases of User(s)-endorsed Item(s) (“Item Purchase”), (5) obtains Buyer CSAT feedback to validate the Item endorsements of User(s) and/or User Type(s), including Community(ies), Advisors, Friends, etc. (“Buyer CSAT Feedback Loop”) and (6) can compensate User(s) (“User Compensation”) for their Item endorsements in order to improve and optimize the Item and Item Lists being shown as advertisements by the system, as shown in FIGS. 1B-1D (“Platform as a Service”).

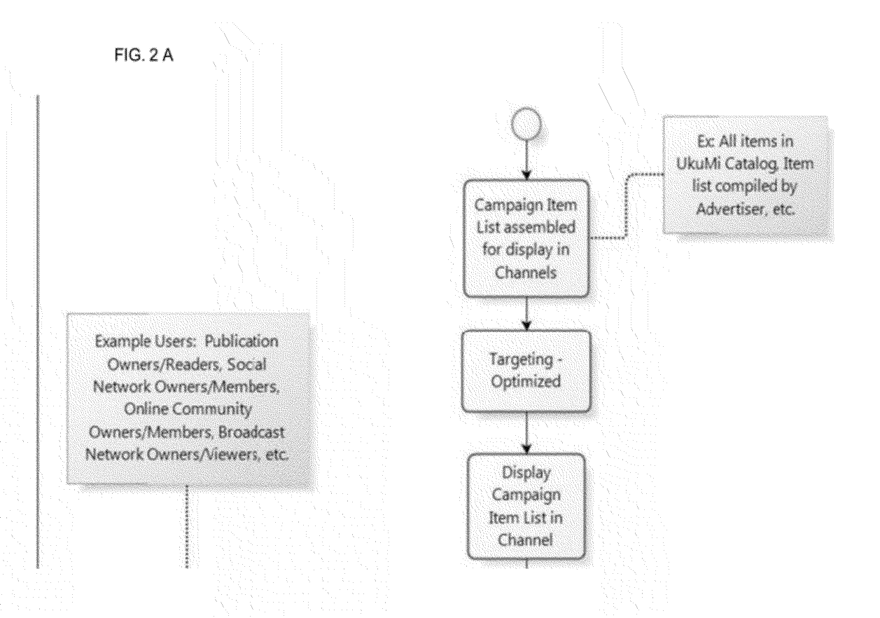

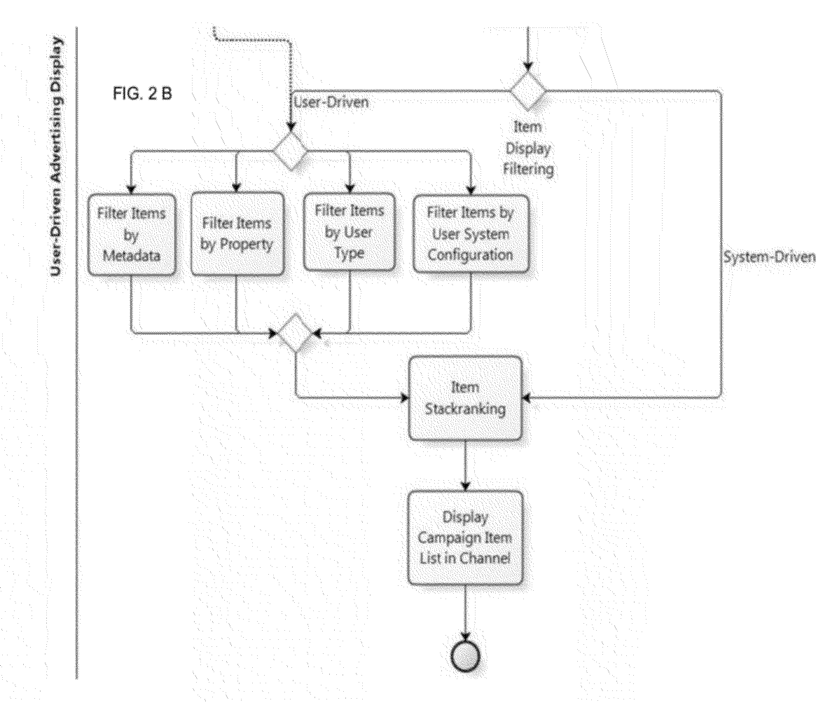

Embodiments of the systems and methods enable a User or groups of Users (“User Types”, including online Communities) to select, decide, influence, and/or pull which Item or Item Lists are highly engaging, Customer-endorsed, Buyer-validated and relevant to channel context and user, in order to target and display as advertisements to Users across multiple sales channels. The system and methods provide User(s) with ability to select and/or pull (e.g. into User(s) collection of favorite content) Items to be shown as advertisements by filtering the system Item catalog and/or system-targeted Item/Item List (e.g. filtering and/or searching by metadata, item property/name, user type, user system configuration, preferences, etc,) and, as a result, the system uses this and other inputs to stackrank (from highest-to-lowest value) the displayed Item/Item List (“Item Stackranking”), as shown in FIGS. 2A and 2B (“User-Driven Advertising Display”).

Embodiments of the systems and methods quantify and utilize captured User(s) data and generated system data (“Entity Performance Capture”) within the closed-loop platform (“Platform as a Service”) to determine optimal targeting of subsequent Item/Item List(s) shown as advertisements to other Users by the system, as seen in FIG. 1.

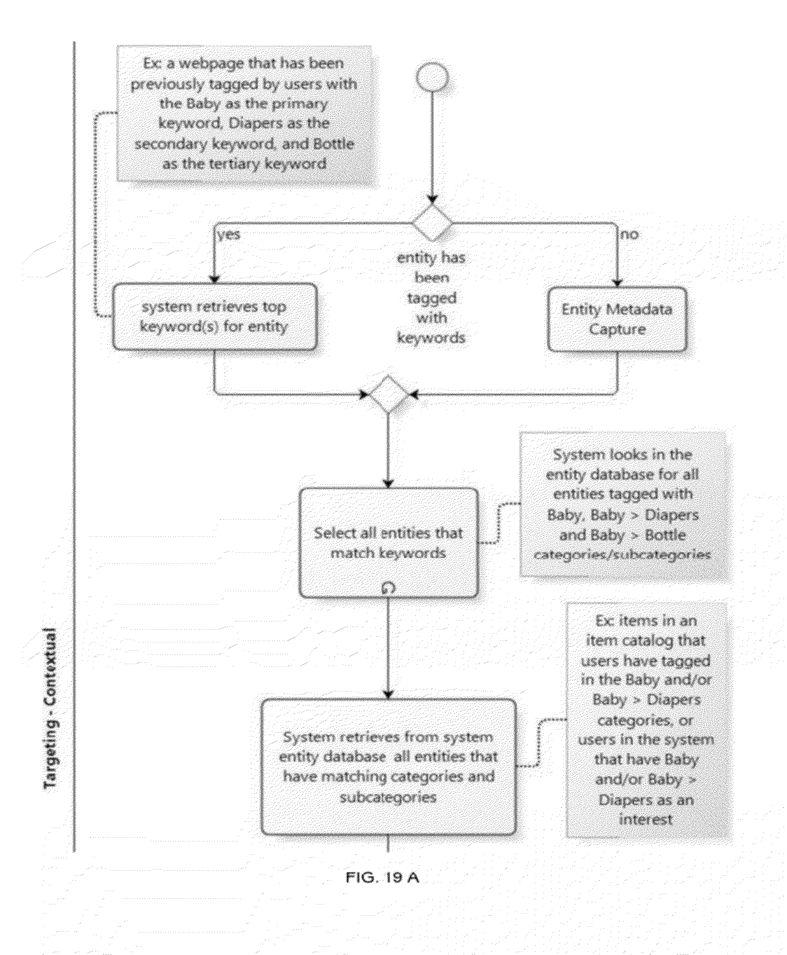

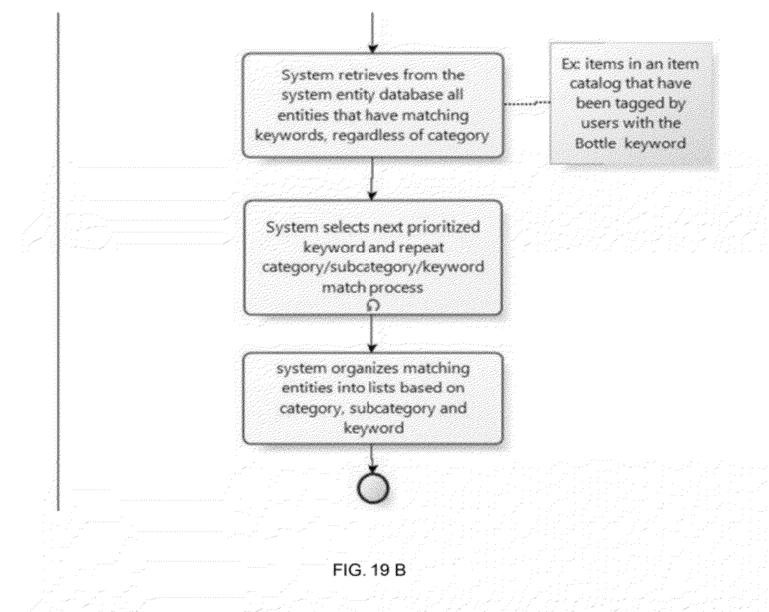

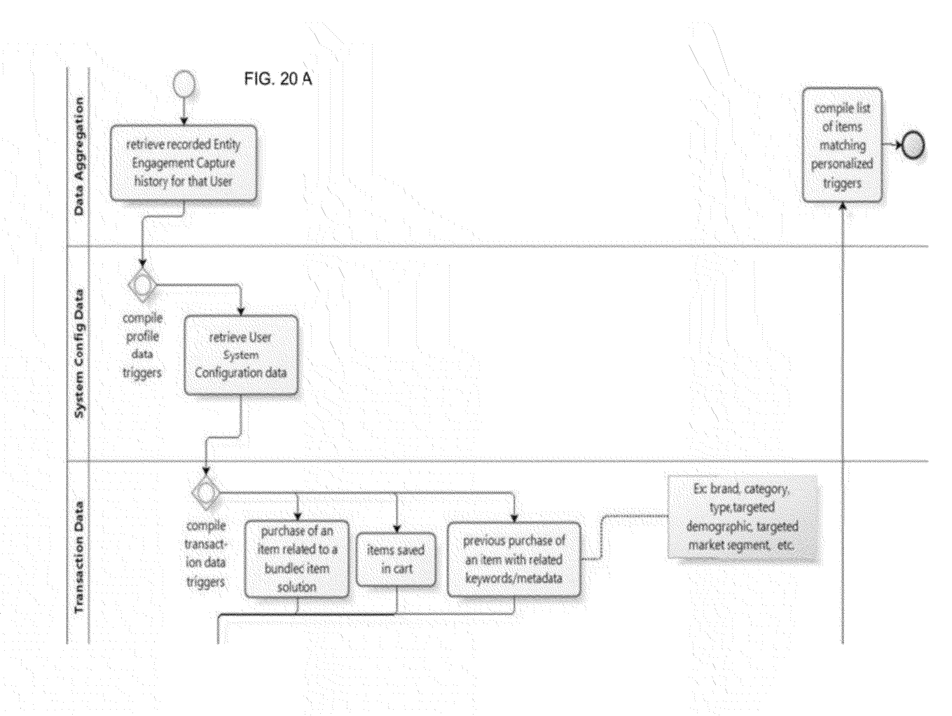

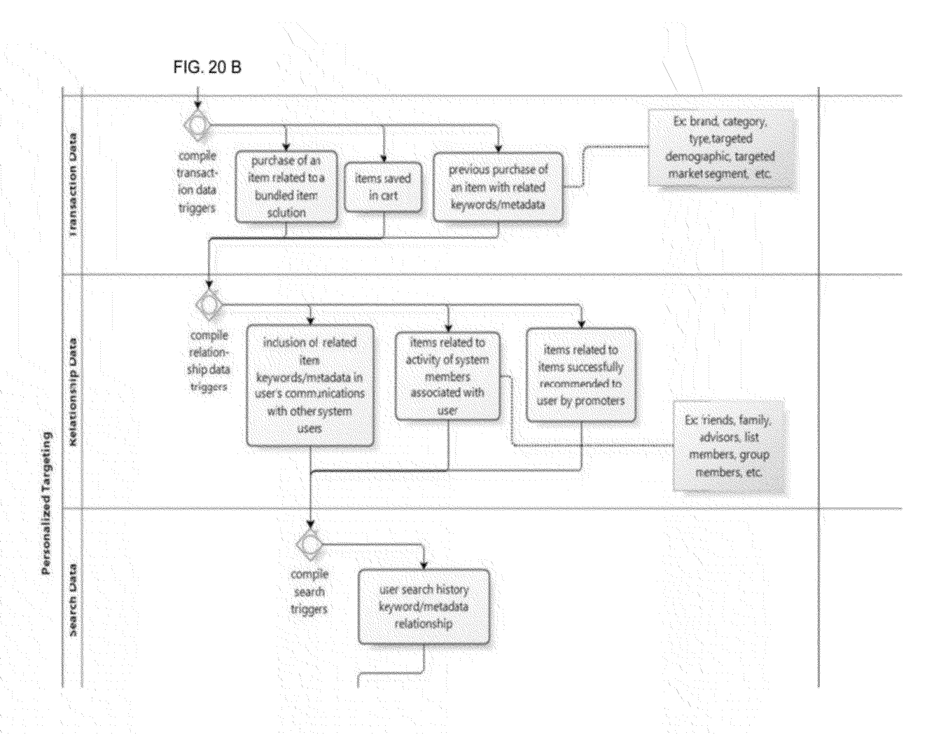

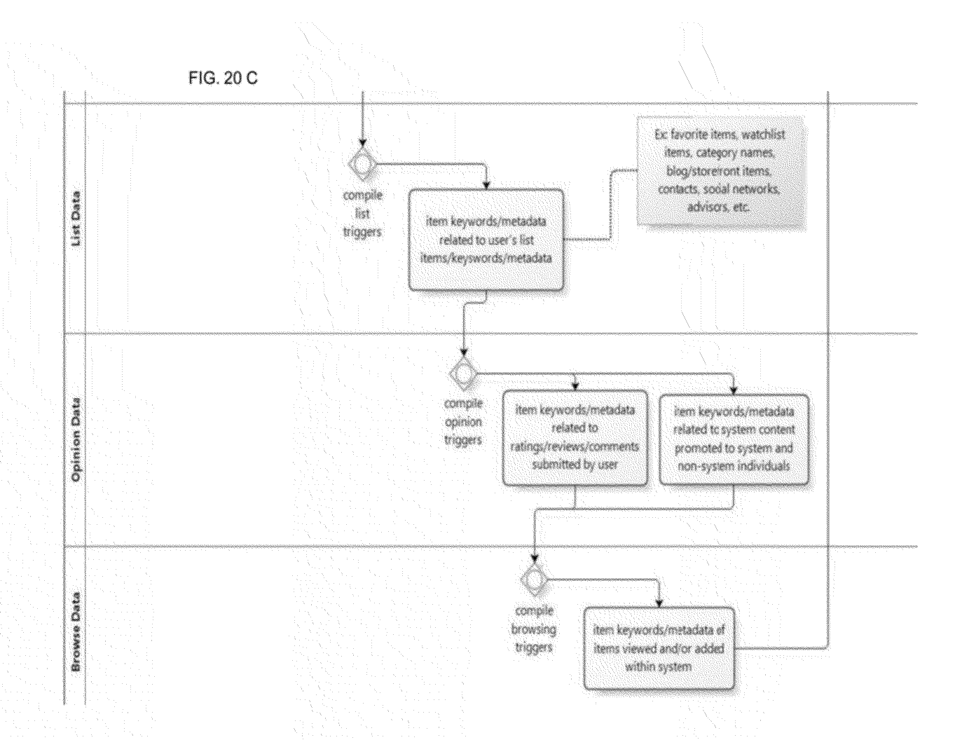

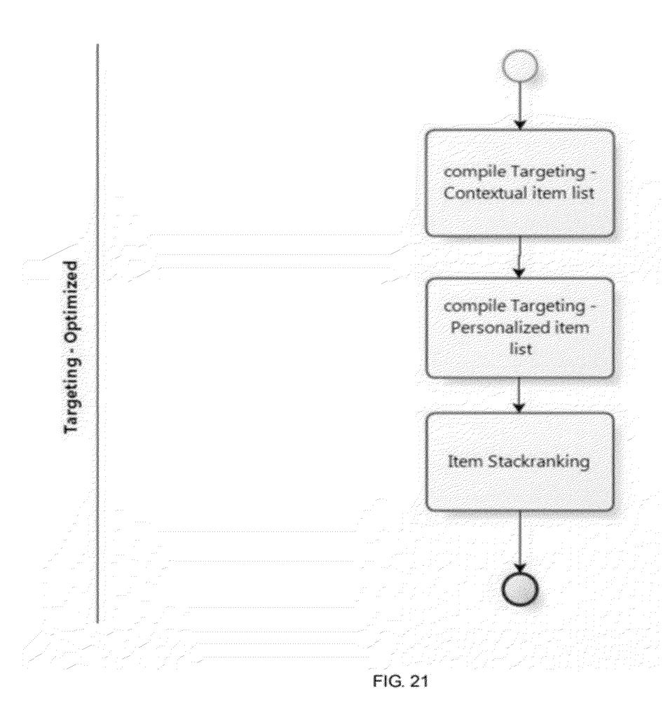

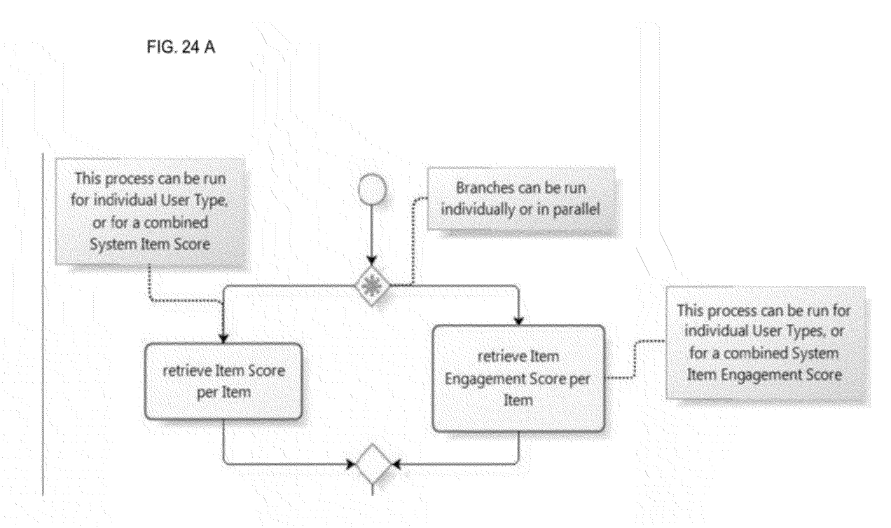

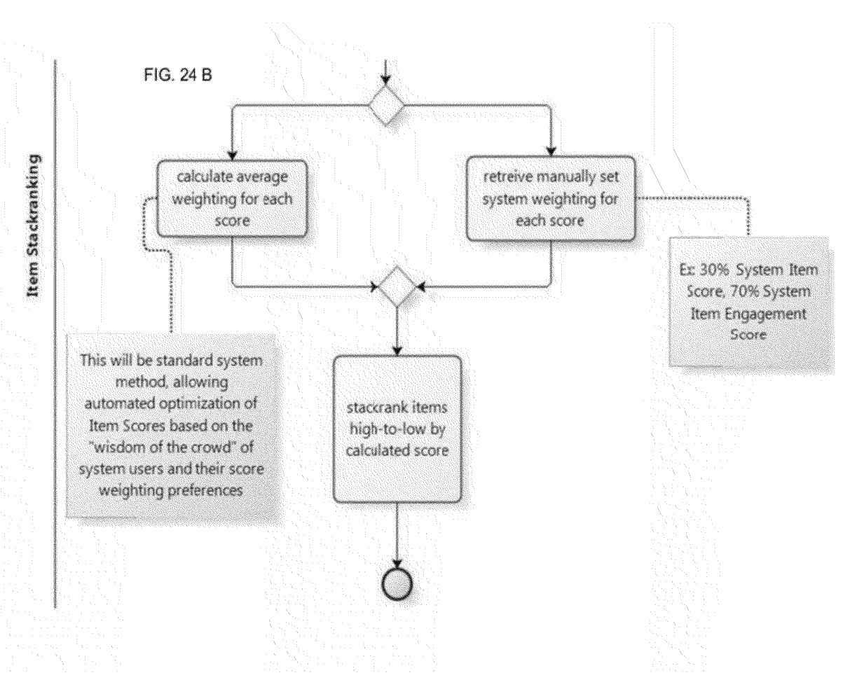

Embodiments of the systems and methods determine optimal targeting of Item/Item List(s) shown as highly-relevant advertisements by utilizing multiple targeting processes, including, but not limited to [shown individually and some methods combined, in the following figures]: (1) Item Quality Targeting [FIGS. 24A and 24B], (2) Item Engagement Targeting [FIGS. 24A and 24B], (3) Buyer-validated/Customer-Type-validated Item Targeting [FIGS. 24A and 24B], (4) Personalized/Community Targeting [FIGS. 20A-20C] (5) Contextual/Channel Targeting, [FIGS. 19A and 19B] and (6) Optimized Targeting [FIG. 21] to target, deliver and display highly-engaging, Customer-endorsed, Buyer-validated, and user/content-relevant Items endorsements back across multiple sales channels, as shown in figures listed above.

Embodiments of the systems and methods create the novel ability to capture Customers (“buyers” and “non-buyers”) opinion feedback and endorsement about Items, contained in the system-provided Item catalog including, but not limited to: (1) the value, quality and other Customer-defined properties for each Item, (2) contextual relevancy for each Item in various Sales Channels, (3) channel relevancy for each Item and (4) relevancy of each Item to various Customer types/interests/demographics/etc (used individually and/or with several combined for each targeting method, as well as all together for “Optimized Targeting”).

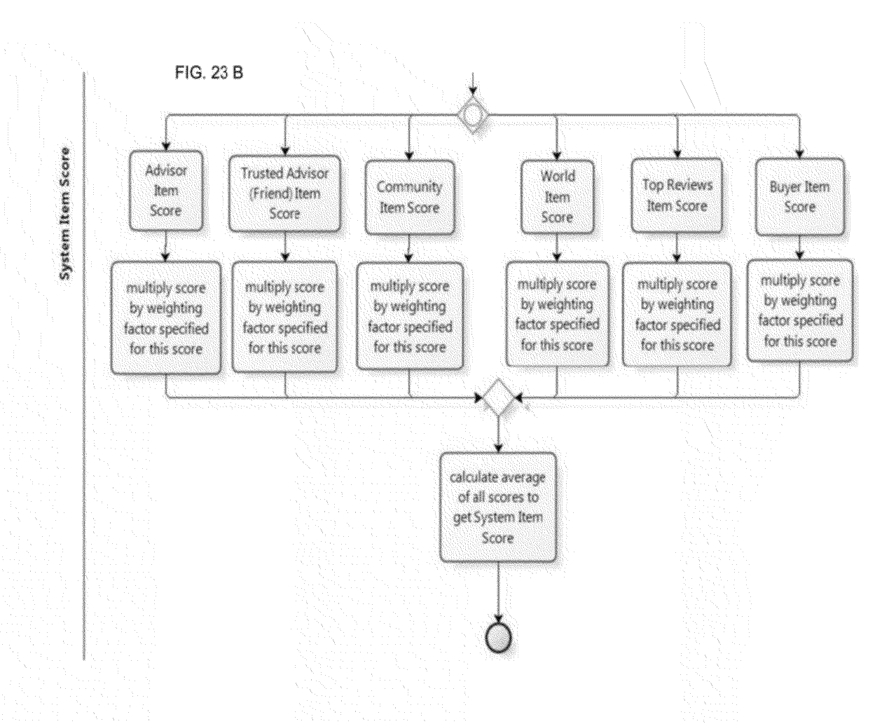

Embodiments of the systems and methods deliver and display stack-ranked (highest to lowest value) lists of Items in a channel based on contextual relevancy within a Sales Channel, relevancy to the Customer viewing the Item list and Customer opinion feedback about the quality/value of each Item. The method and system calculates the System Item Score for each Item, based on quantified Customer opinion feedback and endorsement, which is used to compare an individual Item against other Items (e.g. quality, engagement, relevancy, etc.) before being displayed as advertisements in the system, as shown in FIGS. 23A and 23B.

Embodiments of the systems and methods create the novel ability to deliver and display Item lists as Customers navigate within a Sales Channel. The method and system modify these Item Lists as appropriate when content and context change in the channel. The method and system enable the Customer (or groups of Customers) to tune and personalize their Item lists based on their individual preferences (“Personalized/Community Targeting”), as shown in FIGS. 20A-20C.

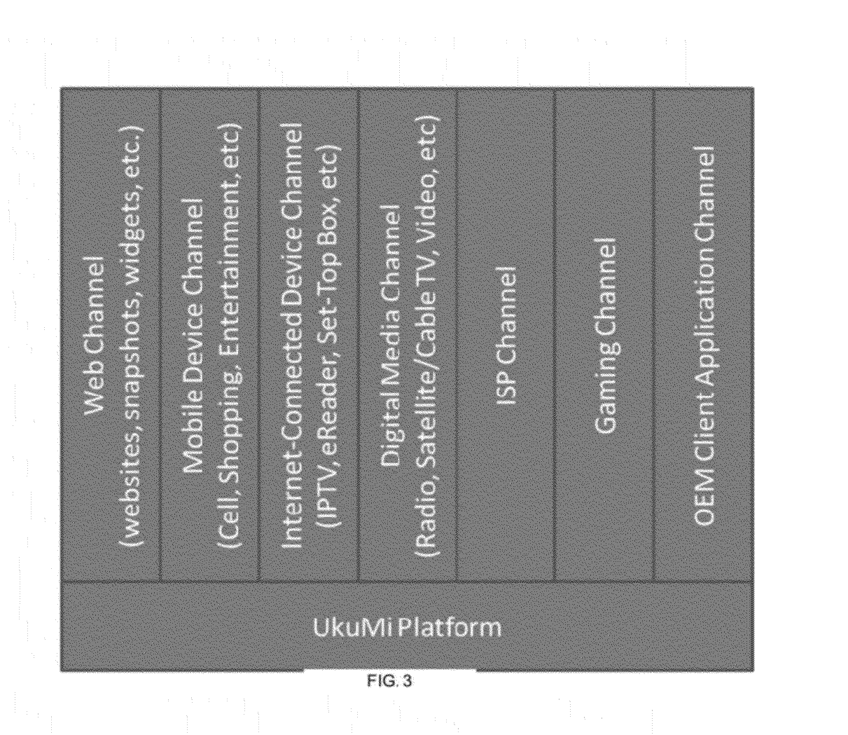

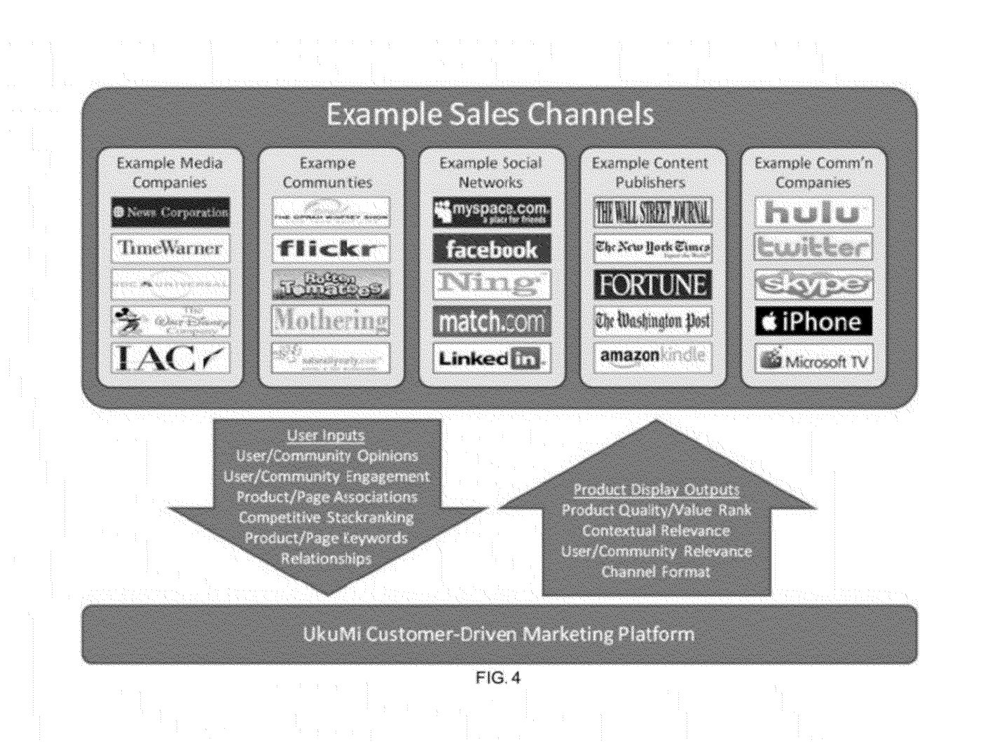

Embodiments of the systems and methods deliver and display interactive Item Lists as highly-relevant advertisements across multiple internet-connected device Sales Channels. The method and system delivers and displays interactive Item Lists in multiple web channels including, but are not limited to, eCommerce website, embedded Item images, cross-website browser toolbar, advertising delivery system, social network(s), social media platform(s), social business platform(s) as well as embeddable widgets and storefronts for partner websites. The method and system delivers interactive Item Lists to be displayed on/in mobile devices, IPTV shows, Cable/Satellite TV channels, eReaders, digital broadcasts (incl. radio), gaming and smart appliances, as shown in two embodiments in FIG. 3 “Sales Channels” and FIG. 4 “Display Channels”.

Embodiments of the systems and methods enable a User or groups of Users to select, decide, influence, endorse and/or pull which Item or Item Lists are targeted and displayed as highly relevant advertisements across multiple sales channels. FIGS. 1B-1D are an illustration of an embodiment of a method whereby a Customer uses various presentation layers (“Sales Channels”) to view and purchase Item endorsements made by the system (“Platform as a Service”) based on Customer Item opinions, system interaction and personal preferences. Various feedback loops exist within the system to gather opinion data of the users in order to enable continuous improvement of the system's ability to select the most highly-valued and highly-relevant Items are displayed to specific users interacting with specific content in specific Sales Channels. In addition, if a Customer decides to purchase an Item, the system also displays the most highly-valued Brand as indicated by the opinion data of the system users. Furthermore, the system captures and factors in opinions of Item buyers using the Buyer CSAT survey.

Embodiments of the systems and methods enable a User or groups of Users (“User Types”, including online Communities) to select, decide and/or influence which Item or Item Lists of highly engaging, Customer-endorsed, Buyer-validated and relevant to channel context and user are shown as advertisements across multiple sales channels. FIGS. 2A and 2B are an illustration of an embodiment of systems and methods whereby a User (“Customer”), groups of Users (“Community”) and/or the system, (“Platform as a Service”) directly or indirectly select (e.g. to endorse, recommend/not recommend, provide opinion, etc.) an Item by filtering a system-targeted Item or Item List (e.g. containing content, products, services, etc.) which are displayed as advertisements (e.g. brand campaigns, TV commercials, etc.) to other system and non-system Users (“User-Driven Advertising Display”).

Embodiments of the systems and methods manage an extensive catalog/database of entities (Items, Users, User Types, etc.), including their detailed descriptions, associated branded/non-branded content (e.g. videos, audio, TV commercials, interactive games, etc.), pricing, fulfillment Brands, reviews, quality/value scores, content engagement scores, etc. Embodiments of the systems and methods utilize multiple communication and distribution channels to target and display Item endorsements/advertisements to Customers including, but not limited to, eCommerce website, cross-website browser toolbar, advertising delivery system, social media platform(s), social business platform(s), social network(s), embeddable interactive widget and/or storefront (for use by Community “Partner” website owners), mobile devices, internet-connected devices, digital broadcasts, hardware devices, client-side applications, server-side applications, etc., as shown in FIGS. 1B-1D and as another embodiment, in FIG. 4 “Display Channels”). The systems and methods can display advertisements endorsements in multiple formats including, but not limited to, images, text, video, audio, interactive Flash, etc. or any other digital advertising format.

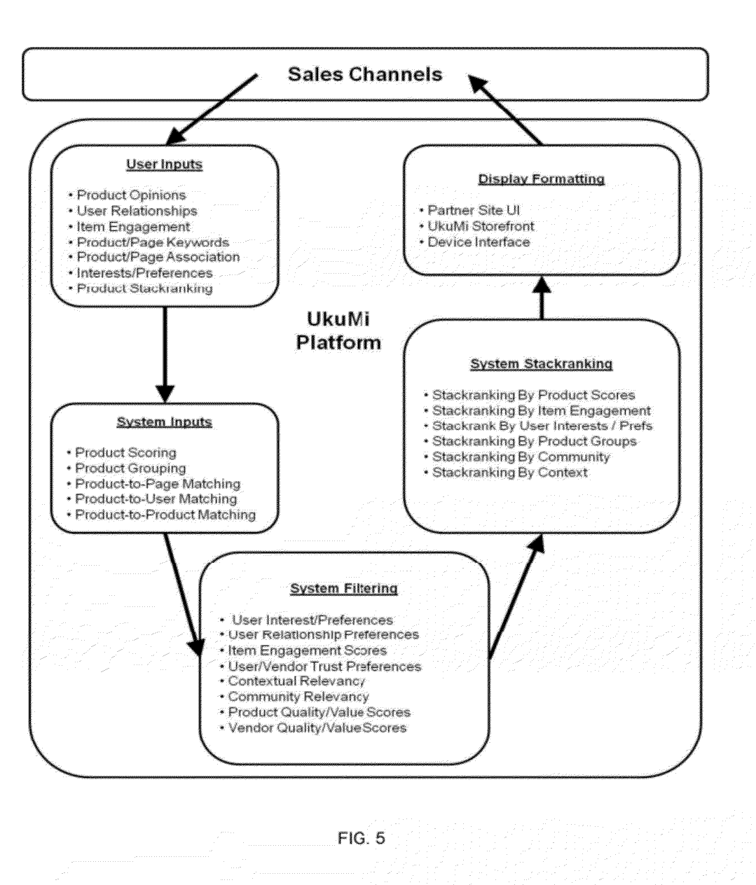

Embodiments of the systems and methods capture and utilize various data inputs, including: (1) User Inputs (e.g. Item opinions, Item endorsement, Item pull, User relationships, Content Engagement, Preferences (etc.), (2) System Inputs (e.g. Item Scoring, Item grouping, Product-to-Page matching, Product-to-User matching, etc.), (3) System Filtering (e.g. by User interests/preferences, User/Brand/Brand Trust preferences, Contextual relevancy, Community relevancy, etc.), (4) System Stackranking (e.g. Item/Item List stackranked by System Item Score, Item/Item List stackranked by Community Item Score/preferences, Item/Item List stackranked by contextual relevance, etc., (5) Display Formatting (e.g. embeddable interactive widget within a Partner site UI, UkuMi storefront, etc.) in order to display highly-engaging, Customer-endorsed, Buyer-validated, and user/content-relevant Items endorsements back across multiple sales channels, and (6) 3^{rd} Party information/services such as content feeds, data manipulation, reporting engines/dashboards, etc., as shown in FIG. 5 (“Platform Data/Feedback”).

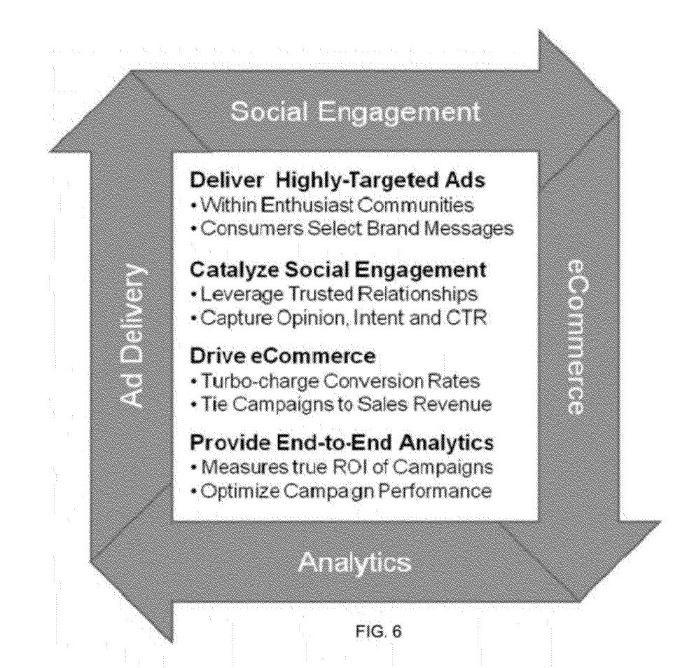

Embodiment of systems and methods utilize User and/or User Type engagement with Item(s) (e.g. digital display advertisements, non-branded content, etc.) and other user/system data inputs (collectively, “Entity Engagement Capture”) captured across multiple processes, in order to change which Items are displayed as advertisements, by closing-the-loop between: (1) ad/branded content delivery processes (“Ad Delivery”), (2) user engagement with delivered ad/branded content processes (“Social Engagement”), (3) Items purchased based on delivered ad/branded content processes (“eCommerce”) and (4) data/analytics to improve the relevancy of ad/branded content processes (“Analytics”). The systems and methods utilize this user/system input captured during these processes of delivering advertising campaigns (and eCommerce products/services), in order to: (1) optimize the order of Items (e.g. stackranked by highest-to-lowest quality, etc.) and/or (2) improve campaign content performance (e.g. stackraked by highest-to-lowest user engagement) to display highly-engaging, Customer-endorsed, Buyer-validated, and user/content-relevant Items endorsements back across those same and other sales channels, as shown in, and/or (3) optimize the display frequency of the Items, and/or (4) optimize the display Channel/Format of the items, as shown in FIG. 6 (“Closed-Loop Advertising Engagement Model”).

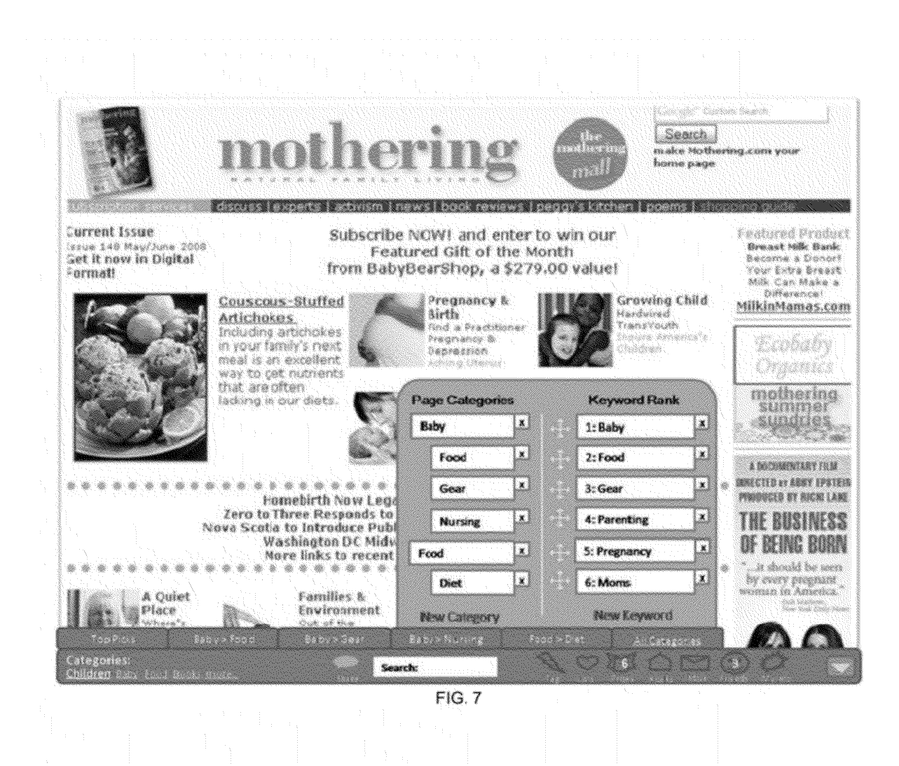

Embodiments of the systems and methods deliver stackranked Item Lists of highly engaging, Customer-endorsed, Buyer-validated and user/content-relevant advertisements to other Customers (“users”) in a consistent process and methodology across multiple internet-connected Sales Channels. An example embodiment of the various companies/properties/assets typifying the sales channels across which the systems and methods can: (1) collect and quantify Item quality opinion, Item endorsement/pull, Item content engagement and other user/system data, (2) update and re-stackrank the Item/Item List and then (3) deliver and display highly-engaging, Customer-endorsed, Buyer-validated and user/content-relevant Item/Item Lists as advertisements to those and other sales channel, including, but not limited to, media company properties (e.g. News Corp/FOX Broadcasting, Time Warner/Roadrunner/Warner Bros, etc.), online communities (e.g. Mothering.com, Flickr.com, etc.), social networks (e.g. Facebook, MySpace, etc.), content publishers (e.g. Wall Street Journal Online, Fortune Magazine online, etc.), communication channels (e.g. Hulu, Twitter, Skype, etc.), mobile devices (e.g. iPhone, Blackberry) and others, is shown in FIG. 7 (“Display Channels”)

FIG. 5 a process diagram illustrating an example embodiment of how the system intakes various example user and data inputs across Sales Channels in order to display highly-relevant, highly-engaging, Customer-endorsed, Buyer-validated and channel-formatted product endorsements back across those same channels in a closed-loop process. Data can be input by users (both system members and non-members) simultaneously from any Sales Channel interface, analyzed and processed within the system, and fed back out to any user in interface in any Sales Channel. For example, person “Alpha” viewing an Item (a particular bike) displayed by the system in a widget installed on a Partner website (for instance a roadbiking enthusiast site) can indicate their opinion of the bike by clicking a thumb up/down button, writing a review, etc. The system intakes Alpha's opinion data, analyzes it in comparison to all other opinion data on the Item, and updates the aggregate System Item Score for that particular bike based on Alpha's opinion data input. A second person, “Beta”, viewing content in a different Sales Channel—for instance by Beta scanning the bar code of that same roadbike in a retail store in order to read reviews of that bike via a mobile device application—could choose to see just the subset of reviews that were generated on the previously mentioned roadbiking enthusiast website—thus allowing Beta to see opinion/description data on a particular Item (the bike that Alpha gave an opinion on) that is contextually relevant based on their circumstances (the scanned barcode), that was generated from a community they trust (the road-bike enthusiast site Alpha visited), and displayed in a Sales Channel (a mobile application) of Beta's choice. The system also displays other System/User/Brand generated information such as pricing, value ranking, and user-preferred Brands. Upon comparing the retail store's price to more favorable price from a trusted Brand in the system, Beta decides to purchase the bike from that Brand through the system using his mobile device. The system then sends out a customer satisfaction survey to Beta after an appointed time, and Beta inputs his “Buyers” opinion of the bike, thus updating the System Item Score for the bike. A third person, “Gamma”, viewing content in another Sales Channel—for instance an IPTV broadcast on bicycling that contains a system-recognized reference to the same bike—can request information on that Item (for example by pausing the broadcast and selecting the bike) and see the updated System Item Score for that particular bike. Gamma can also choose to filter the opinions of that bike for ones that were generated solely by system users that have purchased that particular bike (the bike's “Buyer Item Score”), that is the aggregated Item Score for the bike as given by buyers of the bike such as Beta.

Embodiments of the systems and methods determine content and context within a media channel, in order to increase the relevance of displayed Item Lists, via Customer input, website categorization, and automated analysis capability. The method and system solicits Customers to input context descriptors (tags, keywords, descriptions, etc.) as they navigate content within a particular channel (e.g. webpage, IPTV show, Cable/Sat TV channel, etc.). For example, the Customer can manually enter and prioritize single or multiple keyword(s) or category(s) of keywords that describe what the user believes is the context within a particular Sales Channel (e.g. the main topic of a particular webpage). FIG. 7 is an illustration of an example embodiment of method for Customer to provide metadata-based descriptors for an entity (in this case categories and keywords associated with a webpage).

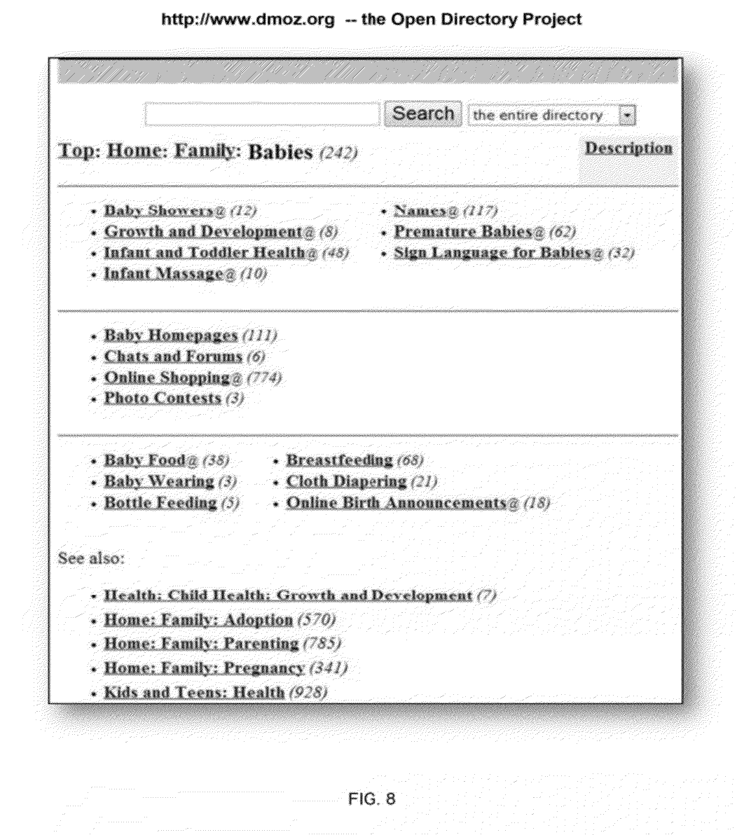

Embodiments of the systems and methods can utilize various Entity categorization methodologies to establish additional categories and keywords for each Entity. FIG. 8 is an illustration of an example embodiment of method to utilize a webpage directory schema (in this case, a DMOZ categorization) to categorize system entities. The method and system establishes the priority of categories and keywords based on the priority determined by the categorization methodology (e.g. DMOZ).

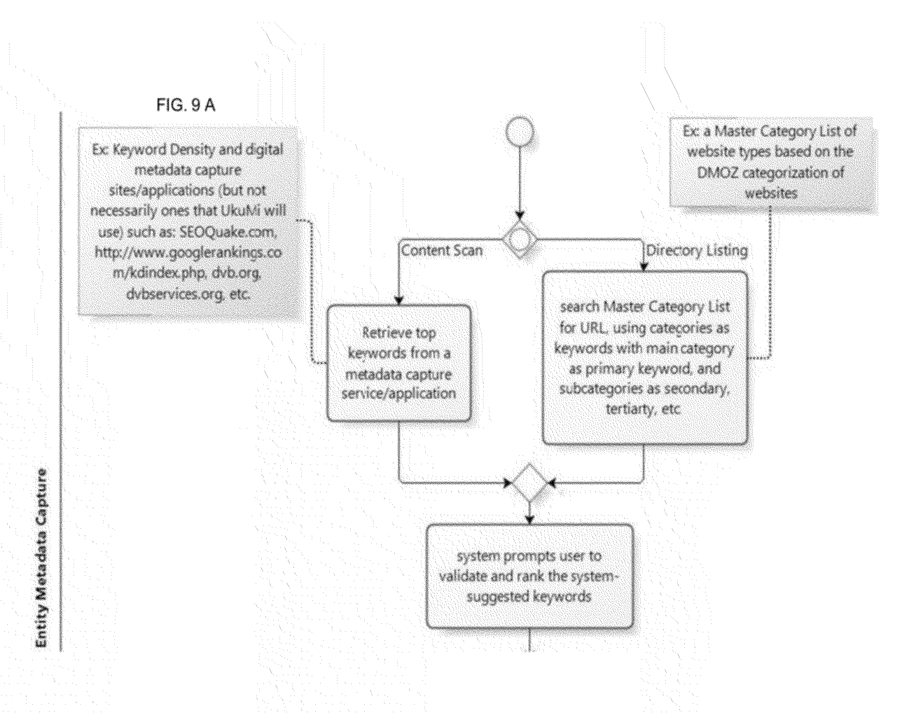

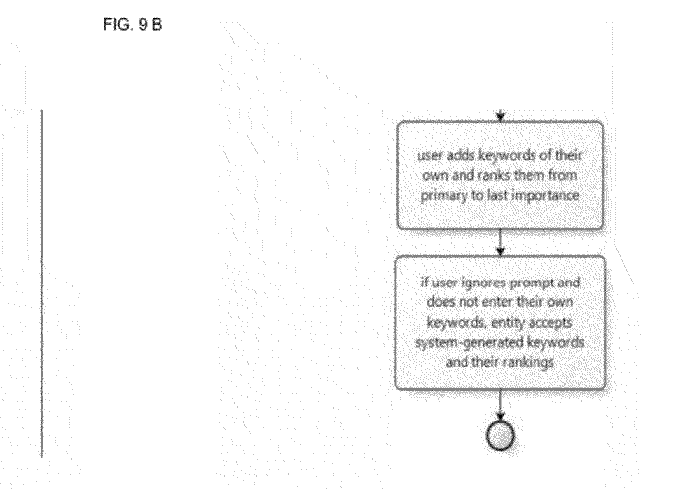

Embodiments of the systems and methods utilize various manual and automated methods to establish additional keywords to be used to determine and prioritize the context of an Entity. FIGS. 9A and 9B are an illustration of an example embodiment of an automated method to associate keywords and their relative relevancies with an Entity by analyzing metadata attached to that Entity (e.g. URLs, website source code, IPTV broadcast metadata, digital radio show metadata, etc.). The method and system establishes the priority of keywords by various methods, including, but not limited to, manual stackranking by system users of keywords associated with the Entity, using DMOZ categories as keywords, the returned results from a keyword density or SEO application installed as a part of the system (such as http://SEOQuake.com, http://ibusinesspromoter.com, etc.), the returned results of metatdata capture service (such as from http://submitexpress.com/analyzer, http://dvbservices.com, etc.), etc.

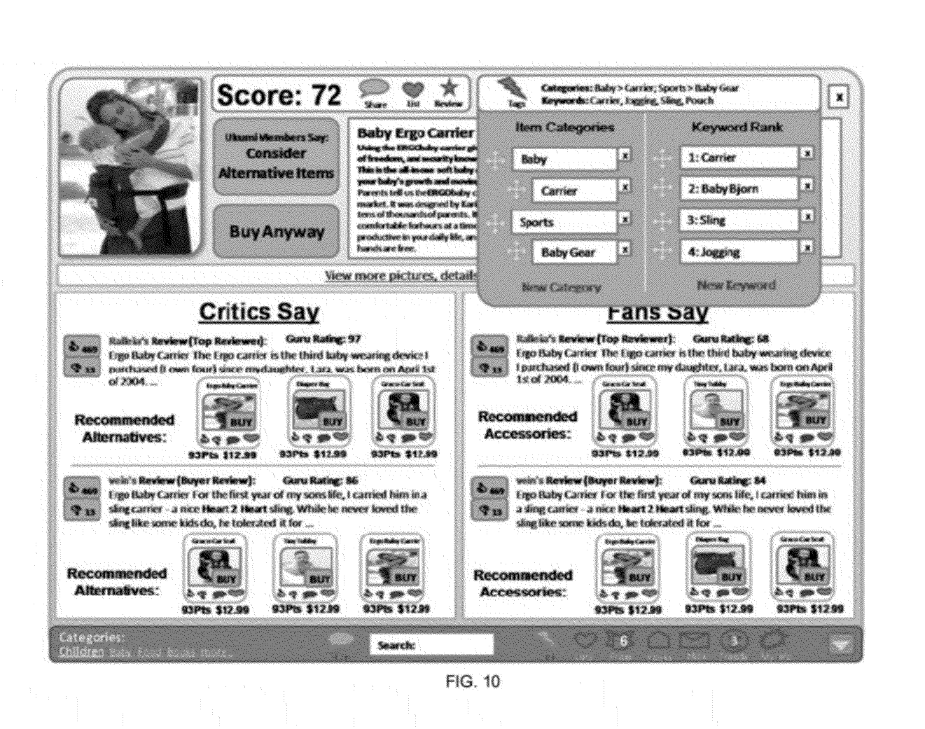

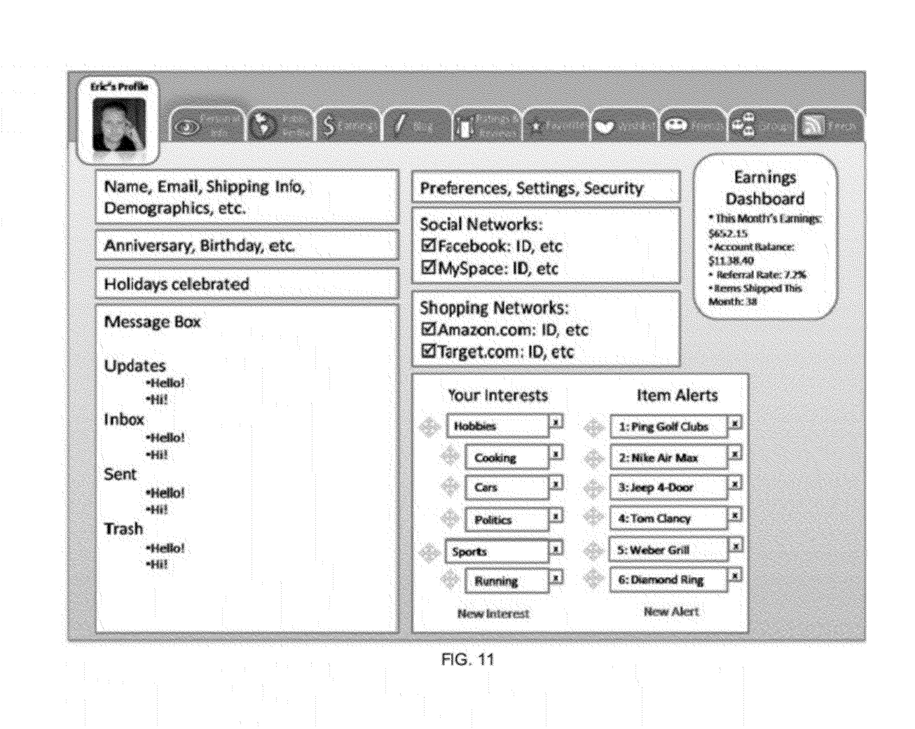

Embodiments of the systems and methods utilize Customers to further prioritize, modify and delete contextual metadata that were system-generated by Entity categorization (e.g. DMOZ method), provided by scan of an Entity (e.g. SEOQuake), or manually entered by system users, as shown in FIG. 10. Customers can either manually input new metadata, or edit and improve existing metadata (and their relevancy) provided by the system or by other users. Customers can provide metadata keywords that they believe describes each Item (e.g. shoe, running, Nike, high performance, etc.) as well as the categories/subcategories that are most relevant to that Entity, in this case an Item. The method and system enable Customers to validate, prioritize or delete Item keywords that were applied to Items by the system or other Customers.

Embodiments of the systems and methods enables Customers to provide metadata (e.g. interests, hobbies, etc.) indicating how they would like to be categorized in the system and what Entities in the system they should be associated with. FIG. 11 is an illustration of an example embodiment of a Customer providing metadata-based description of an entity (in this case the User's interest and preferences [e.g. social/community affinities used for “social targeting”, shopping preferences, alert preferences, etc.). The Customer profile data will be used in determining highly-relevant Items that should be displayed in Item Lists to that Customer.

Embodiments of the systems and methods display contextually-relevant Item Lists within a channel by utilizing associations between Entities (e.g. context/content, Items, Users, Brands) to determine which Items are highly relevant to the content displayed in a channel. The method and system gathers Customer-determined associations and system-generated associations between Entities including, but not limited to, content/context within a channel, Entity categories, Entity metadata, etc. The method and system utilize a novel metadata matching process to generate a contextually-relevant Item List to be displayed in a Sales Channel being viewed by a Customer (e.g. specific webpage).

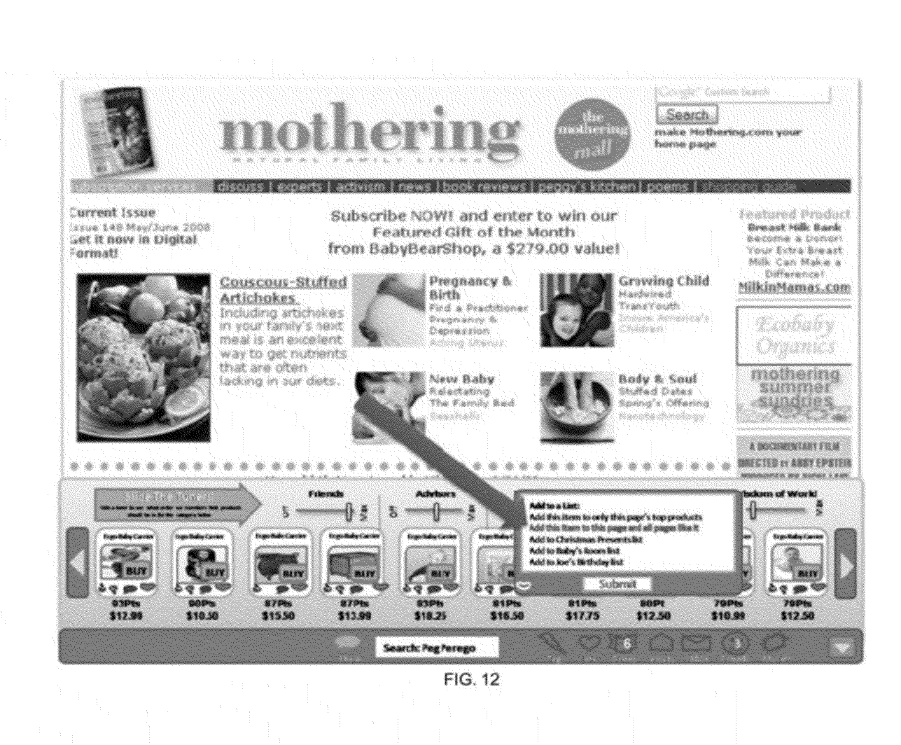

Embodiments of the systems and methods enable Customers to manually associate Entities which they believe are related. FIG. 12 is an illustration of an example embodiment of method for Customer to manually provide associations between multiple Entities (e.g. single-Item-to-many-webpages, many-Items-to-many-webpages, Community(ies) or Users-to-Items, Items-to-specific sales channel, etc.). This data input can be used by the system to display Entities that have been associated with one another by system users. For example, a Customer viewing a webpage whose topic is roadbikes can associate their favorite roadbike Item with that website, thus informing the system that there is a higher relevancy for that bike with that page than other roadbikes.

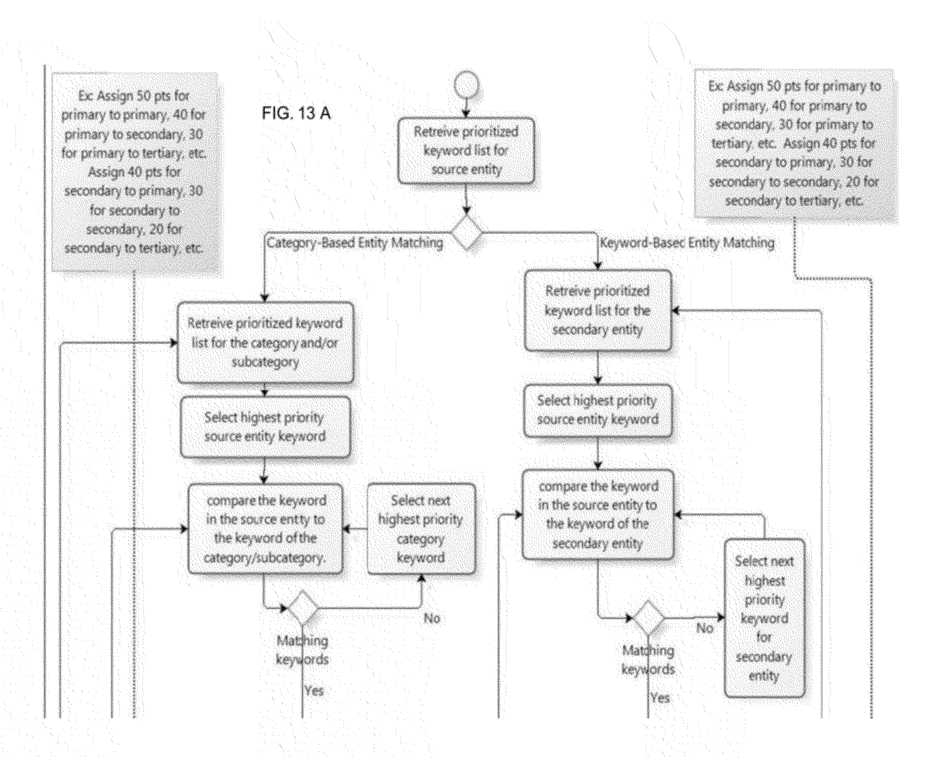

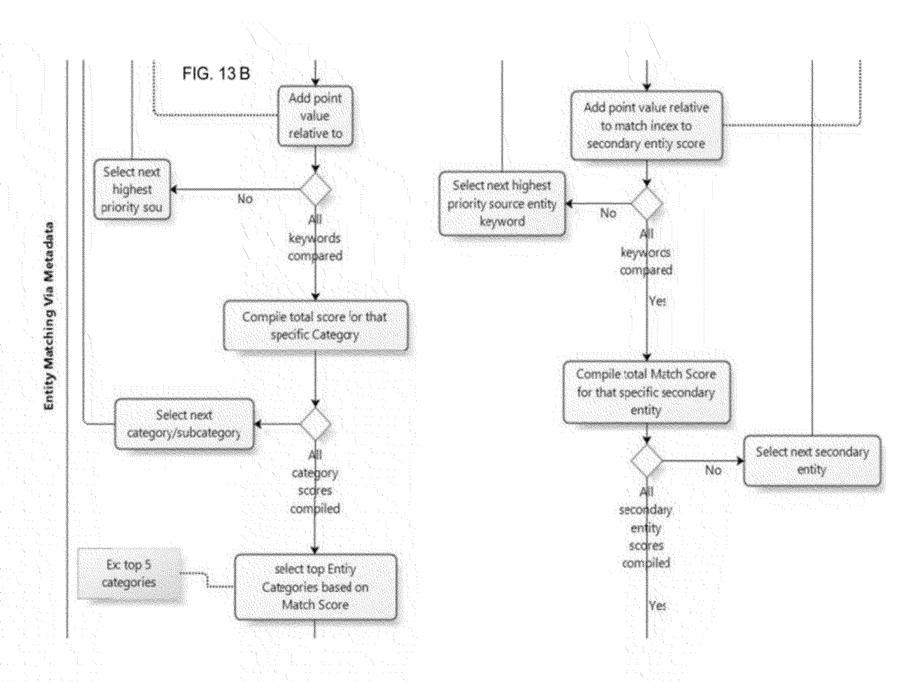

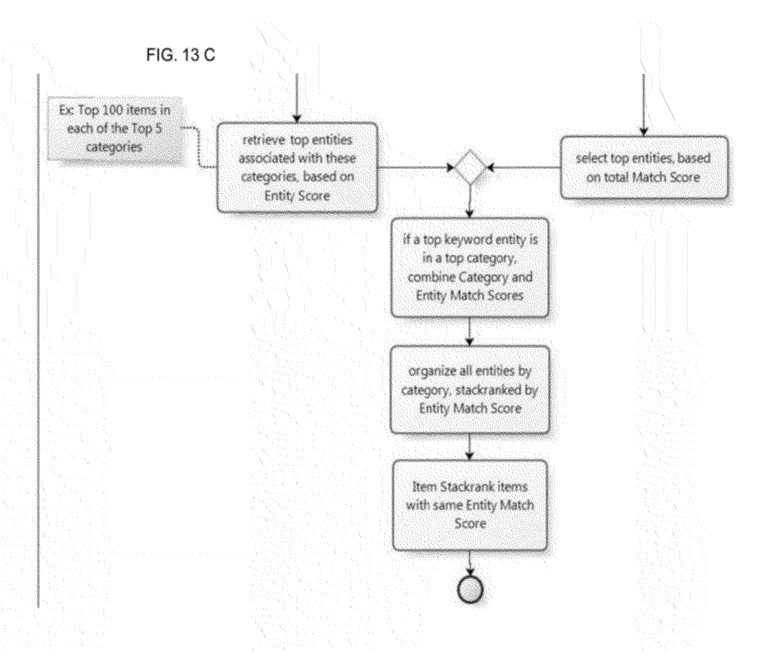

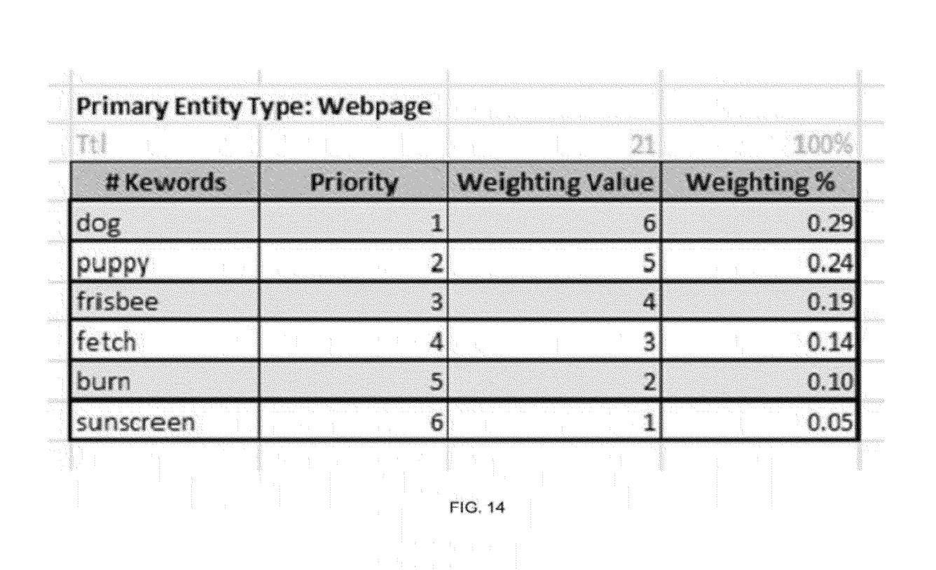

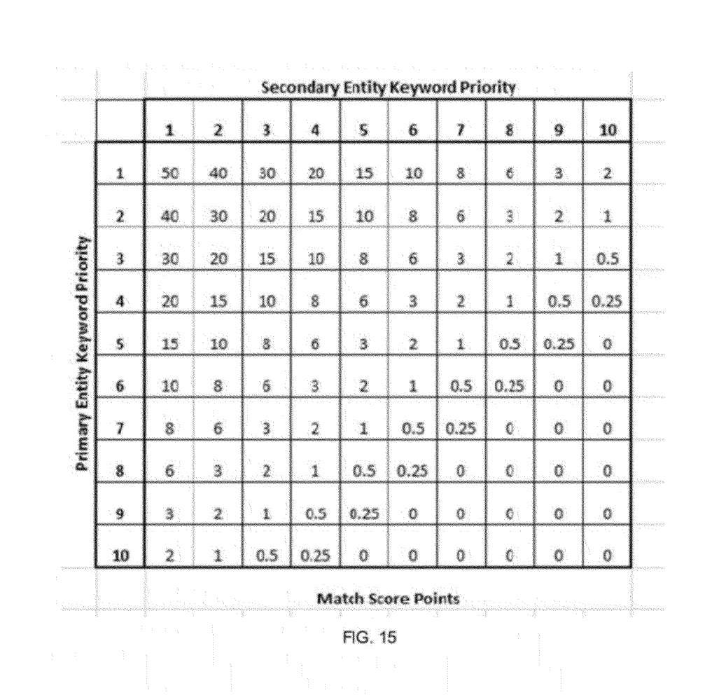

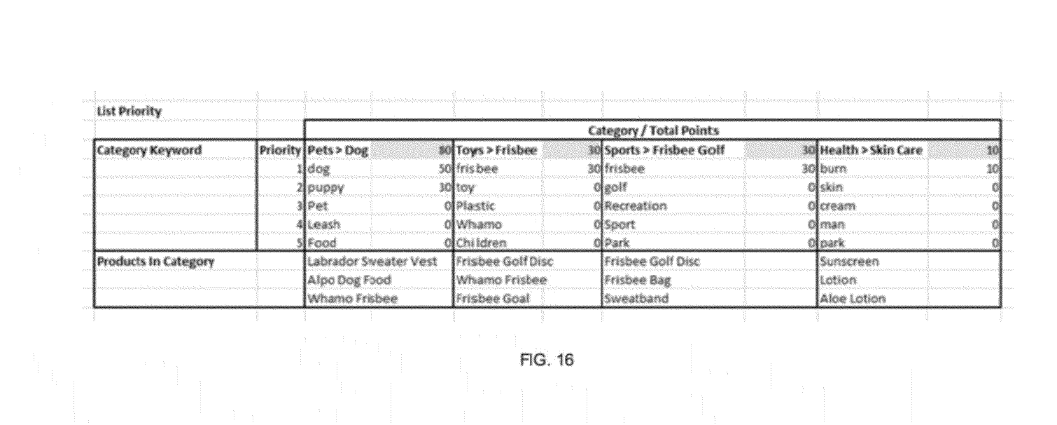

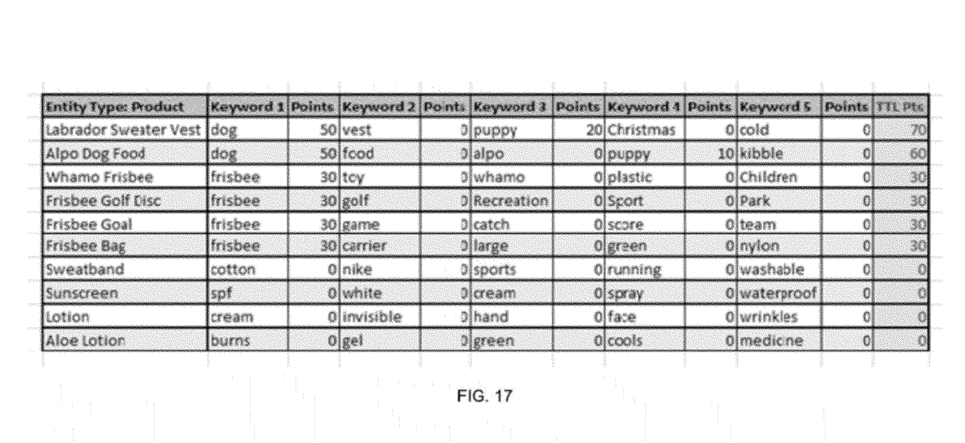

Embodiments of the systems and methods can create automated associations between Entities as well, primarily for the sake of displaying highly-relevant Items in relation to a particular piece of Content (such as a webpage). FIGS. 13A-13C are an illustration of an example embodiment of a process diagram showing how the system takes metadata keywords generated and prioritized by the system and/or users, associates them with Entities, and analyzes them to identify matches and their relevancy between Entities. The system does this primarily for the purpose of determining and displaying Item Lists related to a specific piece of content (such as a unique webpage), Item categories and Customer interests. FIG. 14 is an illustration of an example embodiment of a priority value matrix that keywords are assigned to an Entity (for example a webpage whose context is a man playing Frisbee in a park with his dog on a hot sunny day) based on their prioritization by either the system or by users (as shown in FIGS. 7 through 12). The keywords of the “Primary Entity” (the webpage) are compared in prioritization ranking with the categorical/organizational and descriptive keywords associated with all other Entities in the system (in particular, for Items), which are considered “Secondary Entities” in relation to the Primary Entity being analyzed. FIG. 15 is an illustration of an example of an embodiment of a scoring matrix that determines how many “Match Score Points” are assigned to a Secondary entity when either it's categorical/organization keywords, or its descriptive keywords, match the priority of the Primary Entity keywords they are being compared to. FIG. 16 is an illustration of an example embodiment in which Entity Categories (a type of Secondary Entity) are given a cumulative score based on how many of their keywords match those of the Primary Entity. For example (using the scoring system in FIGS. 13A-13C), if the primary keyword of the Primary Entity matches the primary keyword of the Secondary Entity, that Entity Category is given 50 Match Score Points. If the secondary keyword of the Primary Entity matches the secondary keyword of the Secondary Entity, that Entity Category is given an additional 30 Match Score Points. If no other keywords match between the Primary and Secondary Entities, that Entity Category receives a cumulative Match Score of 80 Points. FIG. 17 is an illustration of an example embodiment in which descriptive keywords associated with an Entity (a different type of Secondary Entity) are given a cumulative score based on how many of their keywords match those of the Primary Entity. For example (using the scoring system in FIG. 15), if the primary keyword of the Primary Entity matches the primary keyword of the Secondary Entity, that Entity is given 50 Match Score Points. If the secondary keyword of the Primary Entity matches the tertiary keyword of the Secondary Entity, that Entity is given an additional 20 Match Score Points. If no other keywords match between the Primary and Secondary Entities, that Entity receives a cumulative Match Score of 70 Points. As shown in FIGS. 13A-13C, all Secondary Entities (both categorical/organizational and descriptive keywords associated with Entities) are put through this process. They are then stackranked and the top Entity Categories and Entities (for example, the top 100 of each) are then selected from this stackranked list of Categories. If a Top Entity is also a categorized within a Top Category, the Match Points for the Entity and the Entity Category are combined for that Entity. Then, the Entities are re-stackranked, resulting in a list of Entities (Items) that the system determines are most closely associated with the Primary Entity (the webpage).

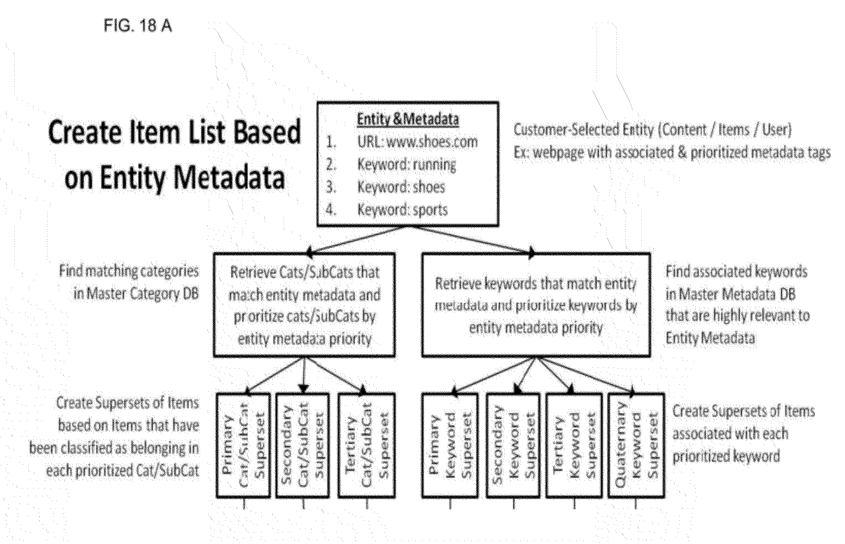

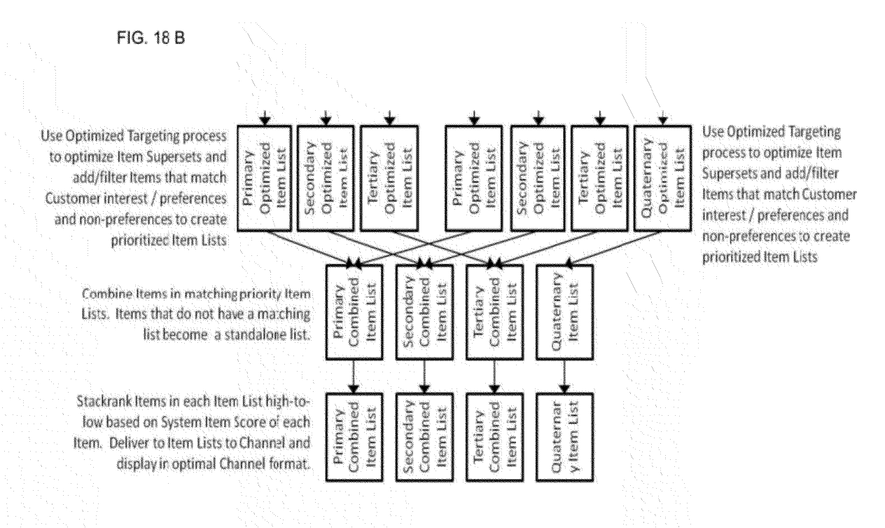

Embodiments of the systems and methods aggregate each matching Item into a displayable Item Lists, which is relevant to the content/context of the Sales Channel. FIGS. 18A and 18B are a block diagram illustration of an example embodiment of method to determine and display prioritized Item Lists based on a stackranking of Entity Category and Description compiled in relation to the channel context (“Contextual Targeting”) as well as in relation to a Customer's interests (“Personalized Targeting”). For example, the process in FIGS. 13A-13C may result in multiple Categories of Items that are associated with a webpage. Using the processes in FIGS. 13 and 18, those Item Categories can be stackranked so that the Customer is presented with a prioritized list of Categories, each containing a stackranked list of Items within that Category, which are relevant both to the webpage he is viewing, as well as his interests (together, called “Optimized Targeting”).

Embodiments of the systems and methods refine the Item Lists displayed to a user based on the context of the content they a Customer is viewing in any given Sales Channel at any given time. FIGS. 19A and 19B are an illustration of an example embodiment of method to determine, target and display Item Lists based on Item's relevancy to the topic/context/theme of a given piece of content in particular channel (used for “channel targeting”) in order to increase the relevancy of the Items shown to the user (“Contextual Targeting”). This contextual targeting is based on, but not limited to, keywords entered by system users (as illustrated in FIG. 7), as well as keywords captured by the system in an automated fashion (as illustrated in FIGS. 9A-9B). The method and system can utilize the contextual keywords associated with content to further expand or narrow the display list of endorsed Items. The method and system also generates and displays Item Lists based on, but not limited to, Customer relationships and communication with other Customers in the system regarding content the users give opinions on, as shown in FIGS. 19A and 19B (“Contextual Targeting”).

Embodiments of the systems and methods refine the Item Lists displayed to a user based on their system activity. FIGS. 20A-20C are an illustration of an example embodiment of method to determine, target and display Item Lists based on Item's relevancy to the Customer (e.g. social/community affiliations [used for “social targeting”] using the system (“Personalized Targeting”). This personalized targeting is based on, but not limited to: (1) Item endorsements, opinion/engagement data and other data entered by the User (“Data Aggregation”); (2) System Configuration data (e.g. user interests/preference the user has input into their personal profile, user-generated lists of Entities they are interested in, user activity history, system configuration, etc.), (3) Transactional data (e.g. purchased made by user, items saved in cart, etc., (4) Relationship data (e.g. social/community affiliations, friends list, sharing/endorsements made, etc.) and (5) historical search/list/opinion/browse data, etc. The method and system utilize the system activity of Customers that have similar personal profiles and preferences including, but not limited to, watchlists, blog entries, purchases and other system data to further expand or narrow the display list of endorsed Items. The method and system also generates and displays Item Lists based on, but not limited to, Customer relationships and communication with other Customers in the system, as shown in FIGS. 20A-20C (“Personalized Targeting”).

Embodiments of the systems and methods create novel ability to display optimized Item Lists by combining Contextual and Personalized Targeting in order to generate highly-relevant and highly-engaging lists of Customer-endorsed, Buyer-validated Items for a particular Customer. The system and method create the optimized Item list by gathering the Contextually Targeted Item list, as shown in FIGS. 19A and 19B, and then applying the Personalized Targeting parameters, as shown in FIGS. 20A-20C, that will either filter out certain Items or add in certain Items based on user preferences and system activity in order to produce an Item list that is both relevant to the content a User is viewing, as well as relevant to their personal interests and system activity. The combined list is then stackranked (high to low) based on their System Item/Item Engagement Scores or scores generated from other User Type(s) (e.g. Buyers, Trusted Advisors, Community, etc.). FIG. 21 is an illustration an example embodiment of method to determine and display these optimized Item Lists based on the combined relevancy of the context within the channel and the relevancy to the Customer using the system (“Optimized Targeting”).

Embodiments of the systems and methods utilize the Multi-dimensional scaling methodology to determine and optimize the relevancy between system entities (Items, Users, User Types, Brands, Channels, etc.) using entity properties (such as Item Quality, Item Engagement and Interest Type/Community Type Item interest keyword, Item identifier keywords, Community preference keyword, Community identity keyword, etc.) in order to determine, for instance, which Items in the system to display in relation to a webpage visited by member of a particular User Type in the system.

Embodiments of the systems and methods utilize the MDS methodology to analyze entity-entity data as a matrix of I vectors in N-dimensional space (specified a priori) in which a distance function is defined, δi,j:=distance between i th and j th objects. These distances produce a dissimilarity matrix, such as shown in FIG. 65.

As an example embodiment, the goal of MDS is, given Δ, to find I vectors χ₁, . . . , χ_{I}ε [symbol] ^{N} such that |χᵢ−χⱼ∥≈δ_{i,j} for all i,jεI, where ∥•∥ where is a vector norm. This norm is usually the Euclidean distance, but more generally it may be a metric or arbitrary distance function. MDS attempts to find an embedding from the I objects into R^{N} such that distances are preserved. If the dimension N is chosen to be 2 or 3, vectors xᵢ can be plotted to obtain a visualization of the similarities between the I objects. Note that the vectors xi are not unique: with the Euclidean distance, they may be arbitrarily translated and rotated since these transformations do not change the pairwise distances ∥χᵢ−χⱼ∥. There are various approaches to determining the vectors xᵢ. By examining variations of (χ₁, . . . χ_{I}) for example,

$${min}_{{x}_{1} , … , {x}_{I}} {\sum }_{i < j} {( ‖ {x}_{i} - {x}_{j} ‖ - {δ}_{i , j} )}^{2} ,$$

MDS can be used to optimize data sets. Embodiments of the systems and methods utilize MDS to optimize entity similarities and maximize advertising relevancy to Users. As an alternative approach, the weighted multi-dimensional methodology (WMDS) can be utilized to optimize the advertising relevancy between the Item quality, Item engagement and User/Community Interest(s) (as well as Contextual Interests). As seen in FIGS. 65-70, this data can be compiled as scores, matrices, charts, graphs, etc. used to determine the optimal match of an entity (usually an Item) with another entity (usually a User/User Type) in relation to any number of additional entities (such as a Channel or user interface), in turn driving the optimized display of advertisements of those Item in relation to other entities.

Embodiments of the systems and methods stackrank Items to be displayed within Item categories/subcategories, based on data captured in a novel “head-to-head” competitive environment where Customers (both Item buyers and non-buyers) provide Item feedback (e.g. quality, engagement, buyer CSAT, etc.) and Item endorsement/pull via multiple methods including, but not limited to, item ratings, direct “word-of-mouth” endorsements, item reviews, content engagement (e.g. User actions such as impressions, views, sharing, commenting, etc.). The systems and methods stackrank Item Lists in a descending order, from highest to lowest value, based on their calculated System Item Scores.

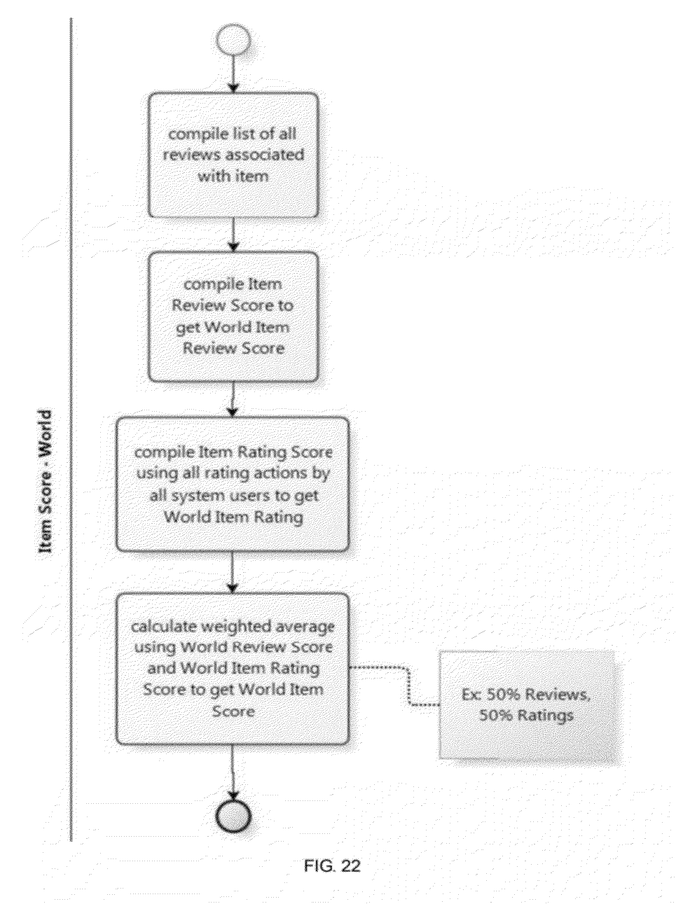

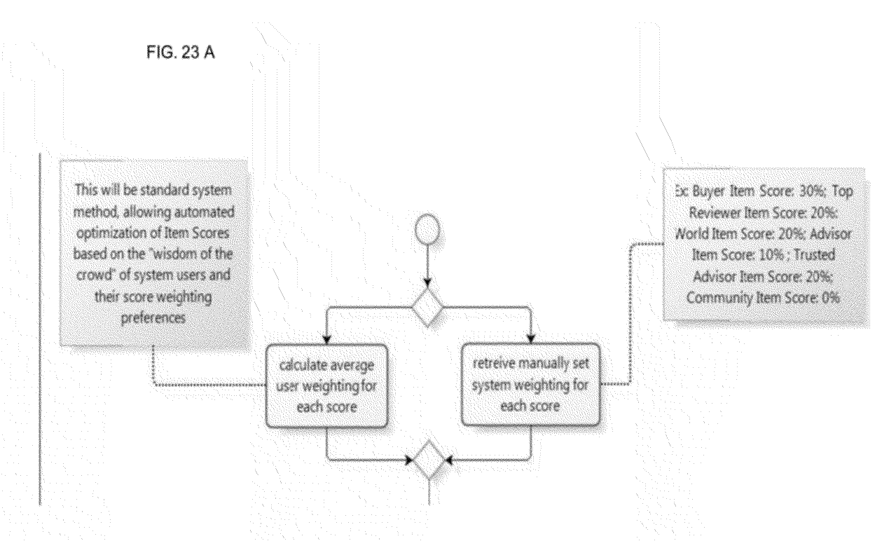

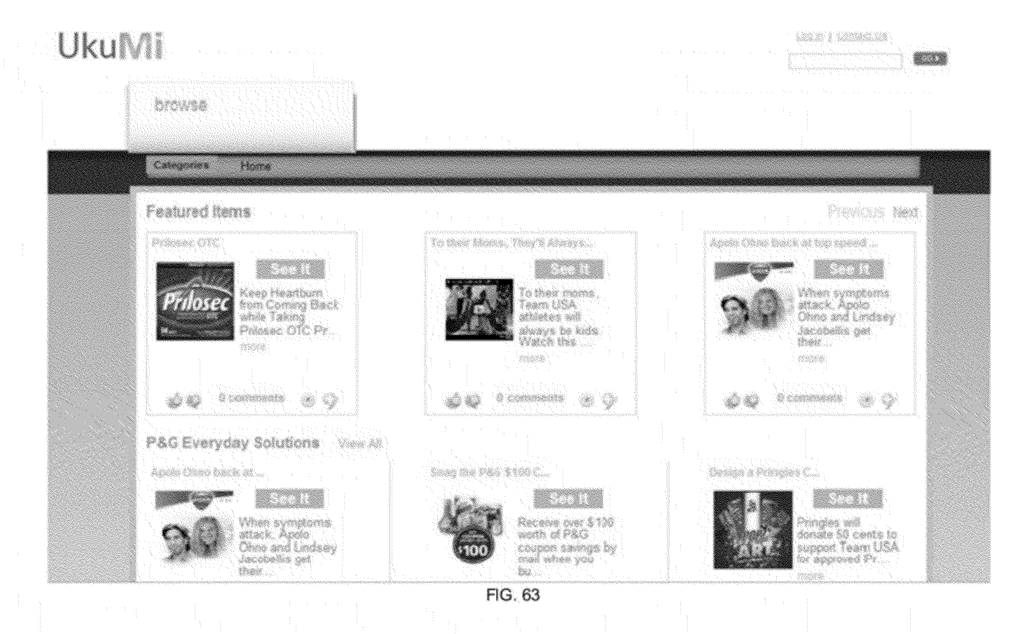

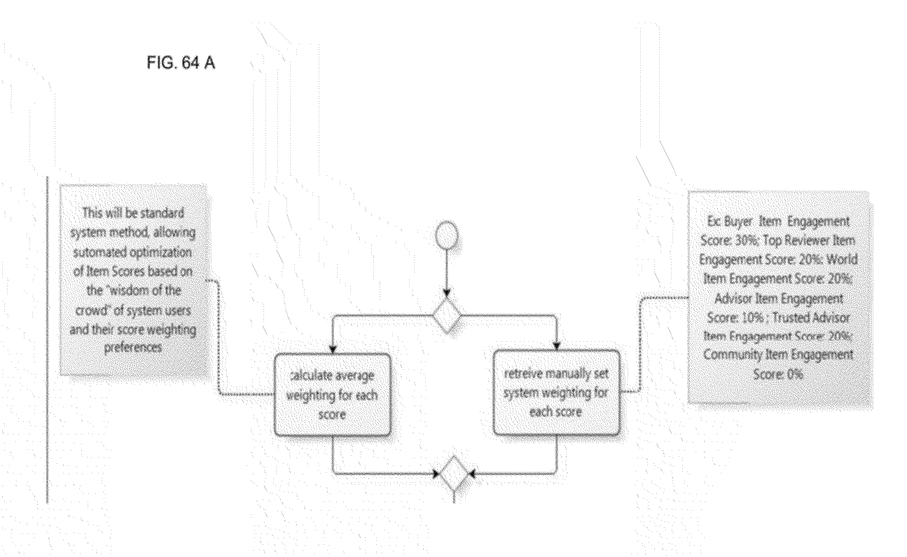

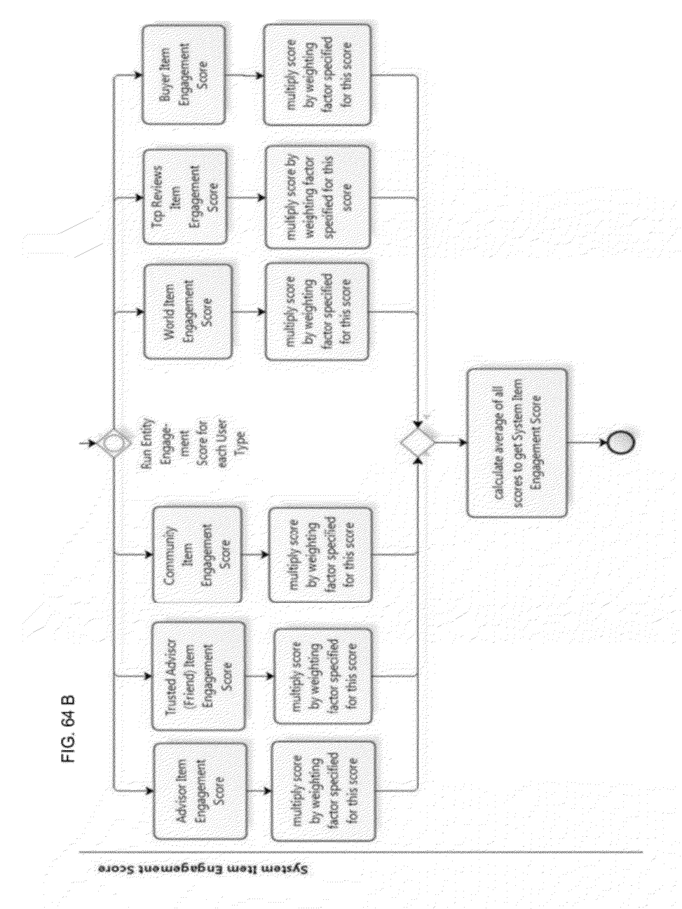

Embodiments of the systems and methods calculate a System Item Score based on gathered opinion feedback about which Items are most-highly and least valued, rated, endorsed and engaged with by Customers. The System Item Score is a weighted average of Item Scores provided by Customer sub-groups (“User Types) in the system. FIG. 22 is an illustration of an example embodiment of method to calculate Item Score (in this case, World Item Score for all system users) based on quantified Customer opinion/endorsement feedback. FIG. 63 is an illustration of an example method to calculate the System Item Engagement Score for an Item by aggregating the average Item Engagement Scores for a particular Item provided by each User Type of Customers, including World (all Customers), Buyers, Top Reviews, Community, Advisors (experts) and Trusted Advisors (friends) in the system.

FIGS. 23A and 23B are an illustration of an example embodiment of method to calculate System Item Score based on opinion feedback and content engagement from/by Customers including, but not limited to, World (all Customers), Buyers, Top Reviews, Community, Advisors (experts) and Trusted Advisors (friends). FIGS. 24A and 24B are an illustration of a process diagram showing an example embodiment of method for calculating the stack-ranking (from highest score to lowest score) of all Items based on weighted individual System Item Scores and System Item Engagement Scores.

Embodiments of the systems and methods create novel ability to target and display highly-relevant, highly-engaging, Customer-endorsed, Buyer-validated Items based on their calculated relevancy to the context of the media channel, relevancy to the Customer using the system and well as the System Item Score (i.e. item quality, item engagement, etc.). The method and system display Item Lists, in various channels, generated by contextual, personalized and/or optimized targeting processes.

Embodiments of the systems and methods create the novel ability to display Item Lists based on Customer opinion/endorsement feedback, Item scoring/stackranking and context/channel/Community/user-relevancy in a consistent method simultaneously across the platform's various Sales Channels including, but not limited to, the Web (eCommerce websites, cross-website browser toolbar, embeddable partner widgets/storefronts, advertising delivery system, etc.), and various other internet-connected channels including, but not limited to, mobile devices, IPTV/Cable/SAT broadcasts, Internet Service Providers (ISPs), set-top devices (DVRs, etc.), portable media devices/eReaders, digital media broadcasts (incl. radio), gaming system, smart appliances, etc. The method and system utilize the same Item scoring, stack-ranking and display (contextual/channel, personalized/community, optimized) processes regardless of the display Sales Channel, to ensure a consistent Item endorsement and Customer experience. For example, the same men's running shoes that have the highest quality/value scores in the system should be displayed to an individual user in every web channel, as long as the content/context within the channels relates to that specific pair of running shoes, the Customer does not change their preferences regarding this shoe, and users that the Customer is pulling opinion data from do not change their preferences/opinions regarding that specific pair of running shoes.

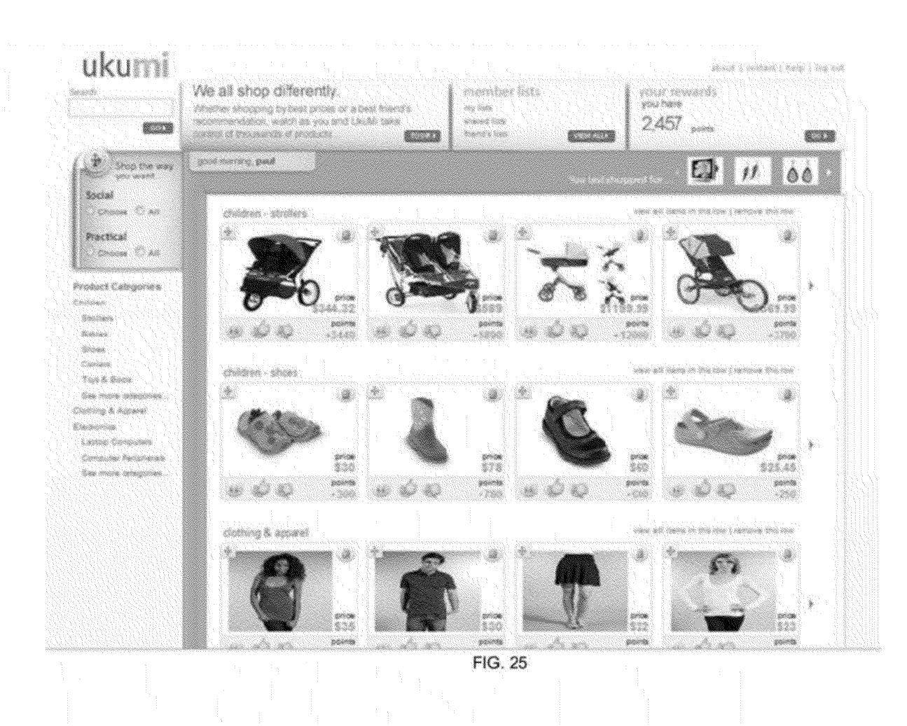

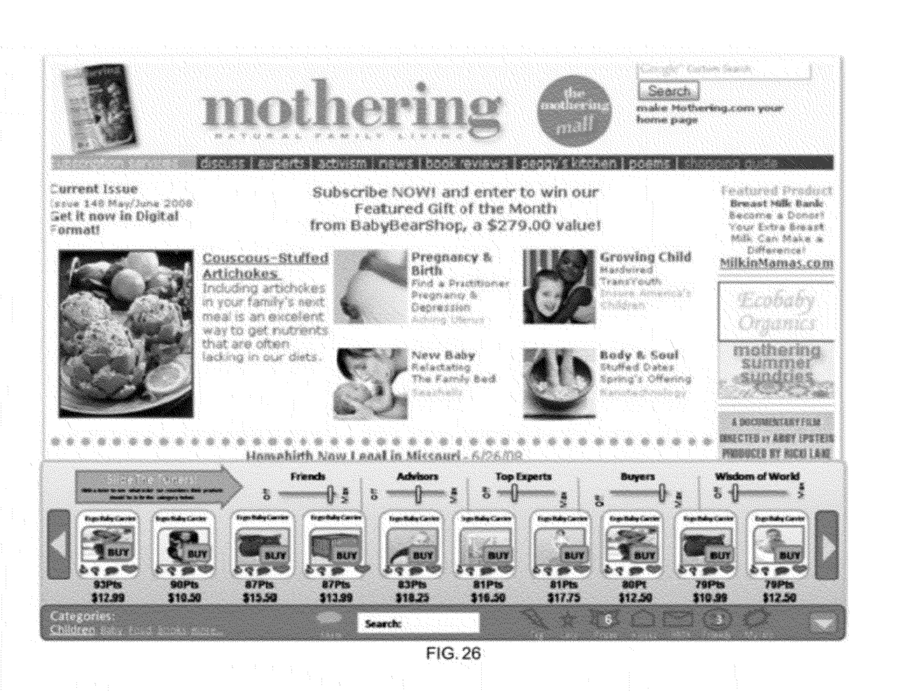

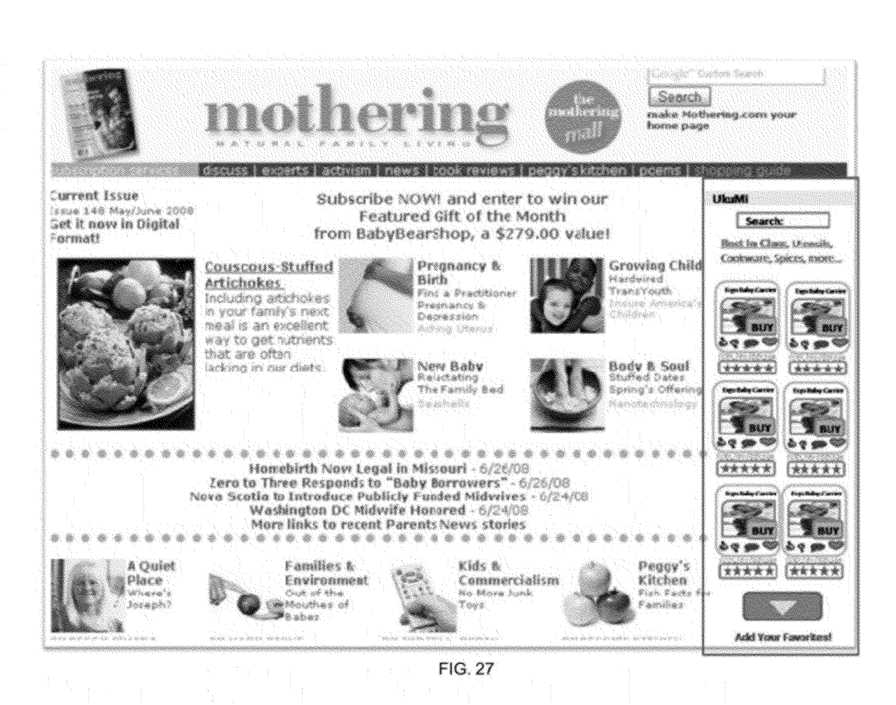

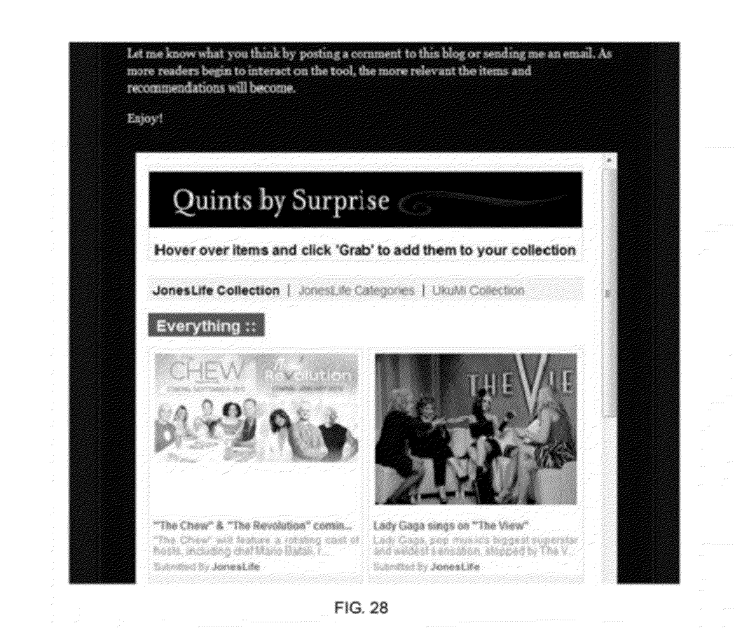

Embodiments of the systems and methods display Item Lists within categories and subcategories across multiple internet-connected Sales Channels. The method and system targets, delivers and displays Item lists as highly-relevant advertisement formatted for display and interaction across a variety of web interfaces. FIG. 25 is an illustration of an example embodiment of method and system to display a stack-ranked highly-relevant, highly-engaging, Customer-endorsed, Buyer-validated Item List to a Customer utilizing an advertising delivery/eCommerce website. FIG. 26 is an illustration of an example embodiment of method and system to display a stack-ranked highly-relevant, highly-engaging, Customer-endorsed, Buyer-validated Item list to a Customer utilizing a cross-website browser toolbar. FIG. 27 is an illustration of an example embodiment of method and system to display a stack-ranked highly-relevant, highly-engaging, Customer-endorsed, Buyer-validated Item list to a Customer utilizing a system-provided widget embedded in a Partner website. FIG. 28 is an illustration of an example embodiment of systems and methods to utilize an embeddable widget to deliver Item or Item List endorsements as advertisements (in this case, branded content as part of brand campaign, shown one Item at a time) to a Customer in a sales channel (in this case, the interactive widget is embedded in a Partner website property).

Embodiments of the systems and methods enable Customers to customize the display of stackranked Item Lists “on demand” by changing filters in the system. The method and system enable the Customer to refine their Item Lists based on selecting and de-selecting Item filters including, both not limited to, favorite Item brands, Vendors, Item categories and other criteria. The method and system utilizes these filters, when the user is system-identified, to further personalize the Item List display across any Sales Channel in the platform. Embodiments of the systems and methods enable individual Customers to establish Item display preferences during their system use session. The personalization capabilities include, but are not limited to: (a) filtering Items by Item Property preferences such selecting/deselecting brand types, price thresholds, style scores, Item categories, etc.; (b) filtering Items by personal preferences of the User Types from whom Item endorsements will be included in their Item display, such as which friends, community advisors, experts, etc.; and (c) a hybrid mode, which filters combining both Item Property and User Type filters.

Embodiments of the method and system retain and manage the Customer's item display preferences in the central Platform and utilize (and potentially locally store) them across every Sales Channel the Customer traverses, as illustrated in FIG. 3. The method and system enable a Customer to additionally retain all locally personalized preferences in any internet-connected Sales Channel. For example, a Customer can select to be displayed Items from only five different brands and those preferences would be maintained in every Sales Channel. The method and system enables the Customer to modify their preferences in a single Sales Channel and those preferences are propagated across every Sales Channel.

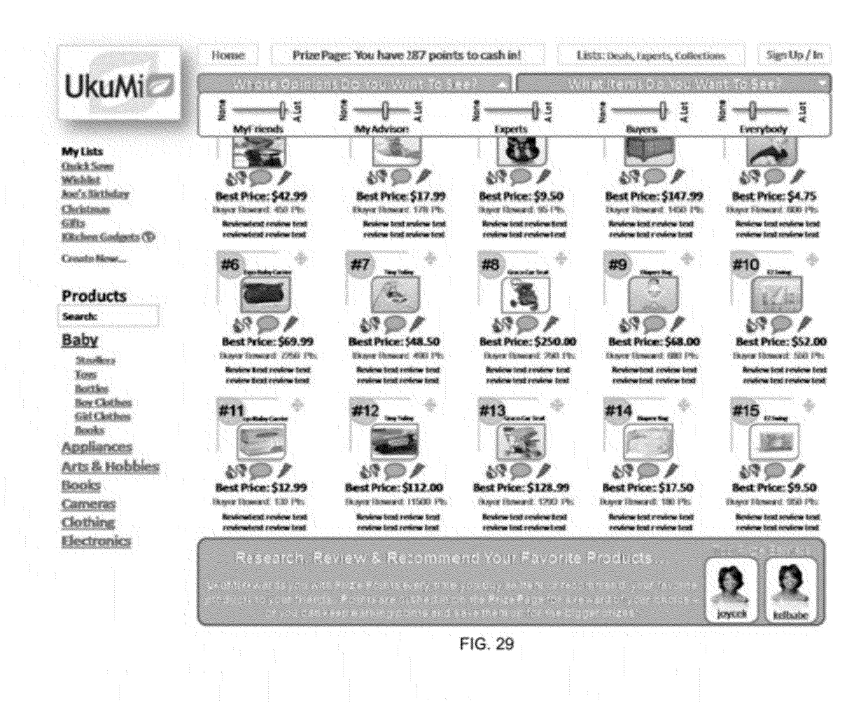

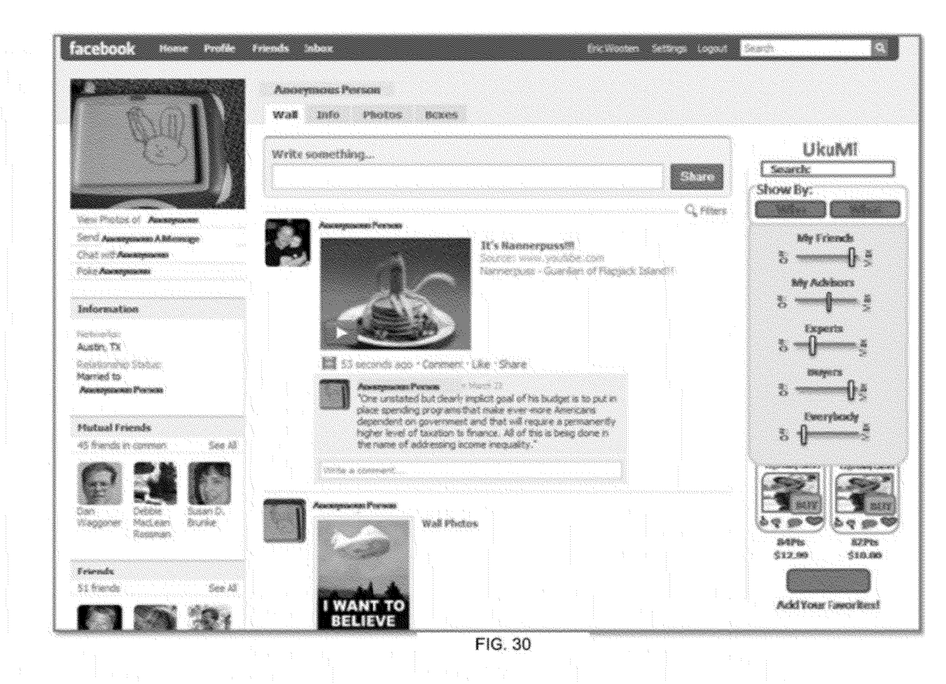

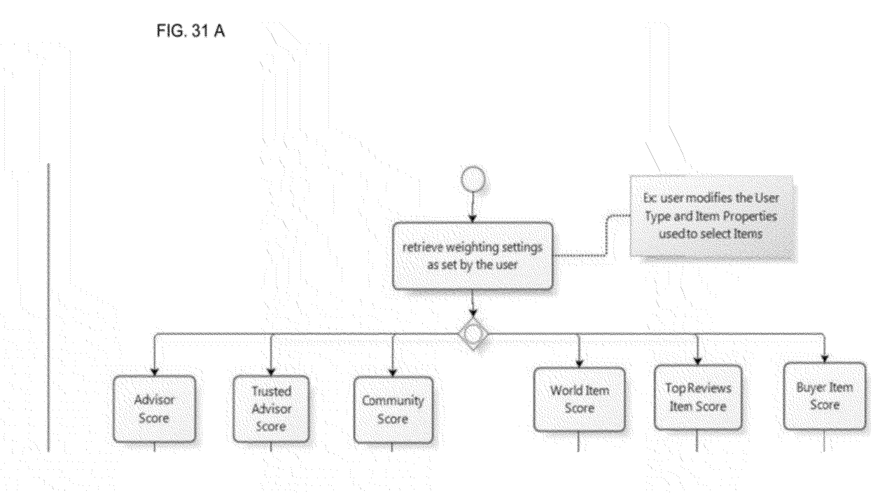

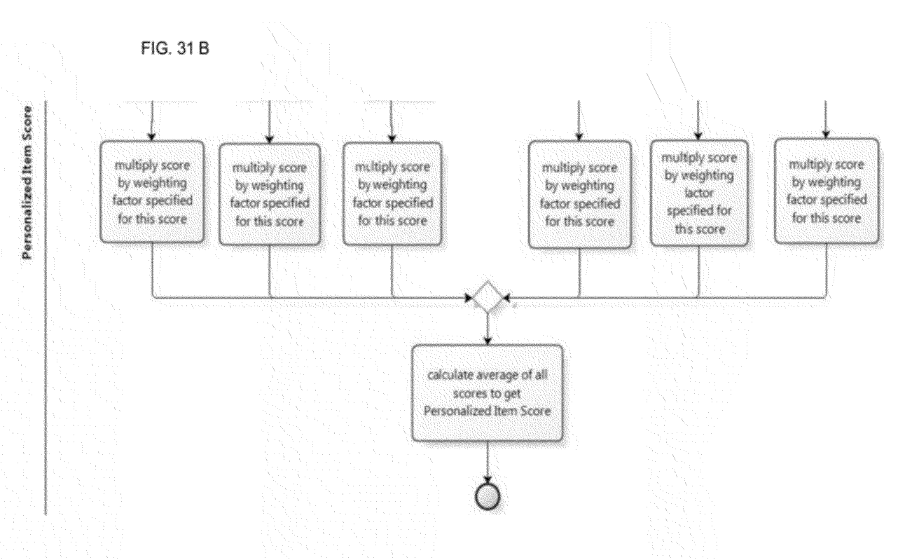

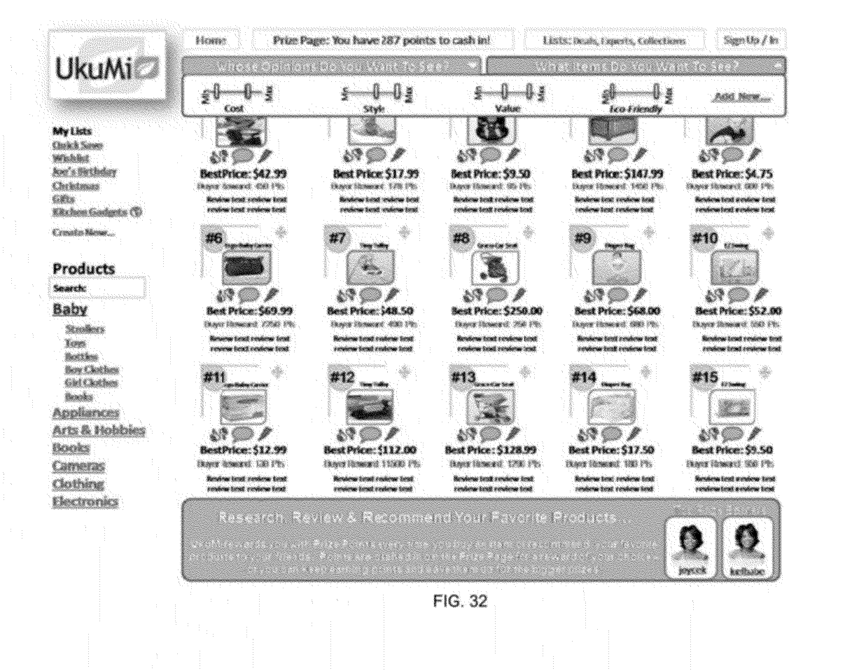

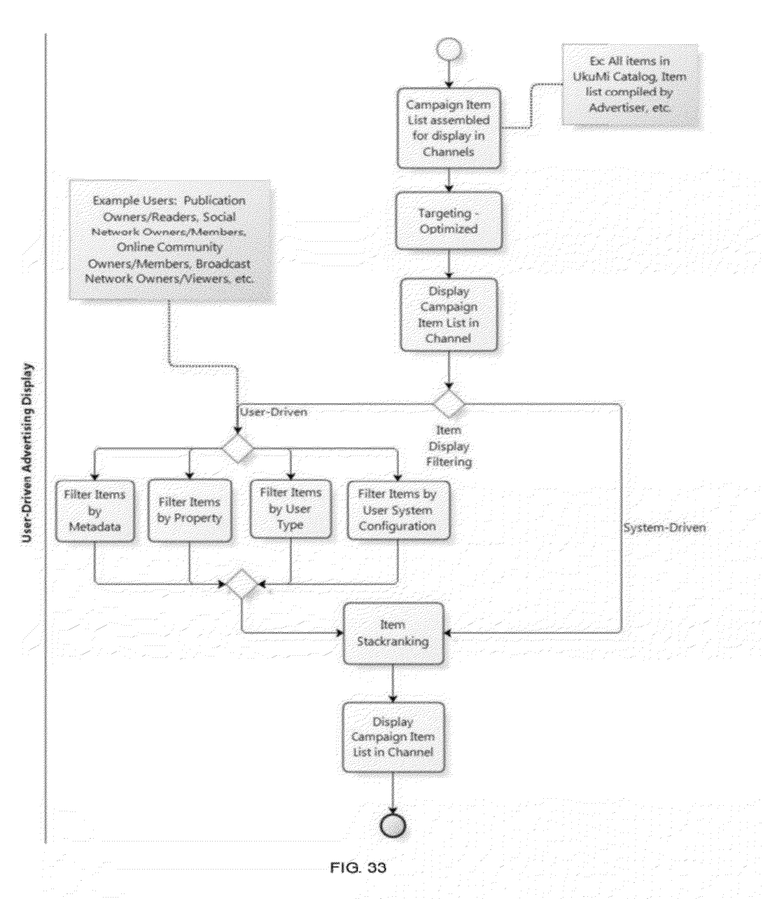

The method and system enable Customers to personalize the display of their Item Lists (e.g. influencing which Items are shown to them) by setting how much value they place on opinions from each Customer sub-group. The method and system capture and aggregate Customer opinion feedback about Items within established Customer sub-groups (“User Types”). The User Types include, but are not limited to, World (all Customers), Buyers, Top Reviews, Advisors (experts), Community (e.g. users of a particular Partner website, in a particular demographic, interested in a particular brand, etc.), and Trusted Advisors (friends/community members). FIG. 29 is an illustration of an example embodiment showing a method to determine and display personalized/customized highly-relevant, highly-engaging, Customer-endorsed, Buyer-validated Item Lists in a advertising delivery/eCommerce website, based the Customer's level of importance given to average Item Scores provided by each User Type in the system. FIG. 30 is an illustration of an example embodiment showing this same capability in a system widget embedded in a Partner website, for example a social network including, but not limited to, in this case Facebook (e.g. Ning, MySpace, Bebo, Twitter, etc.). FIGS. 31A and 31B are an illustration of an embodiment of a process diagram showing how Personalized Item Scores are calculated in the system based on the Customer's User Type preference inputs. For example, the Personalized Item Score could be set by the Customer to factor in score weighting as follows: 30% of World Item Score (all Customers), 10% of Buyer Item Score, 10% of Top Reviews Item Score, 40% of Advisor Item Score, 0% of Community Item Score and 10% of Trusted Advisor Item Score. The Personalized Item Score is used to stackrank Item/Item Lists in order to target and display the most relevant advertisements to that specific User. FIG. 30 is an illustration of example embodiment in an advertising delivery/eCommerce website showing a method to determine and display personalized/customized highly-relevant, highly-engaging, Customer-endorsed, Buyer-validated Item Lists, based the Customer's level of importance given to average Item Property Scores such as cost, style, value, etc.

Embodiments of the systems and methods enable recalculation, re-stackranking and display of new highly-relevant, highly-engaging, Customer-endorsed, Buyer-validated Item Lists in channels anytime new Customer interactions or system updates have been made. For example, the system and method can display a newly re-stackranked Item List, delivered in the same format as the original, which includes a different set of Items based on Item scoring changes or Customer filter changes.

Embodiments of the systems and methods enable system users to customize their display of Item Lists by additional methods including, but not limited to, a Partner website owner selecting specific highly-relevant, highly-engaging, Customer-endorsed, Buyer-validated Items for display in their embedded system widget, a system user manually selecting which Items they want to display in their personal storefront, etc. FIG. 33 is an illustration of an example embodiment of a process diagram showing a method to determine and display filtered highly-relevant, highly-engaging, Customer-endorsed, Buyer-validated Item Lists based on whether the system is the primary Item list display driver or whether the user (in particular, Partner site owners and/or Partner-selected Community members) is the driver. An example of an implementation where the system is the primary driver would be the system website, whereas an example of a user/Partner being the primary driver would be a Partner-branded storefront in which the Partner is manually selecting specific Items for display.

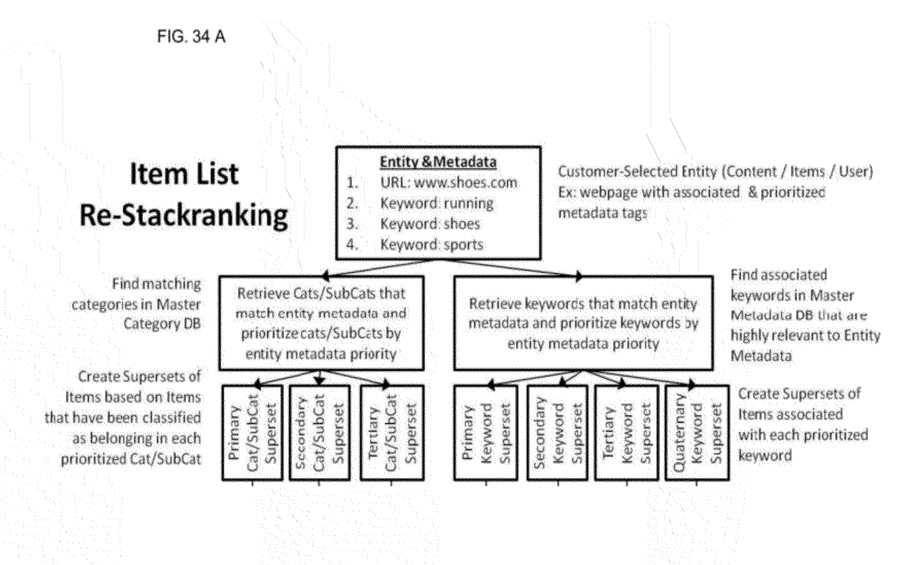

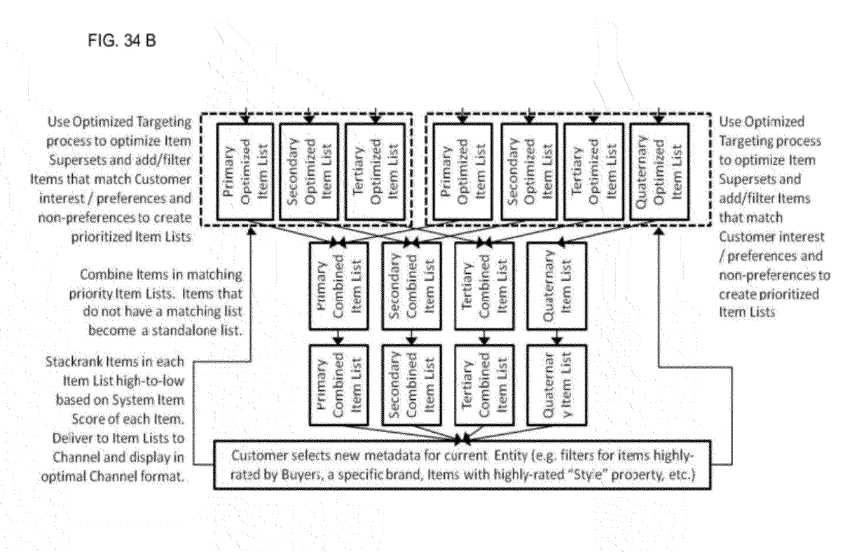

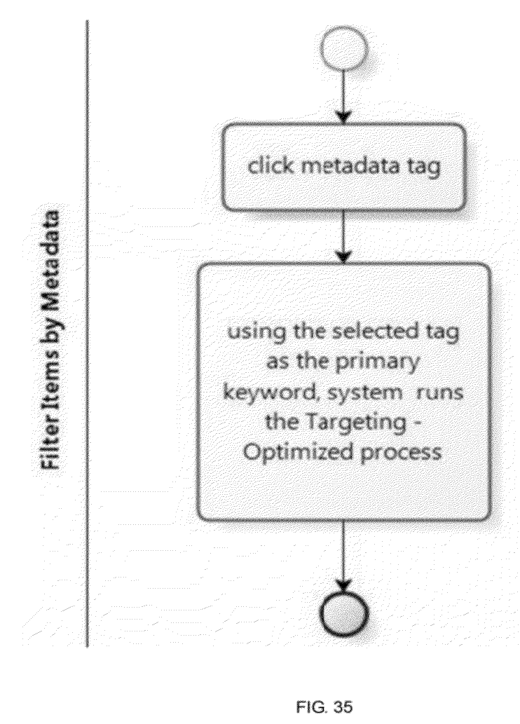

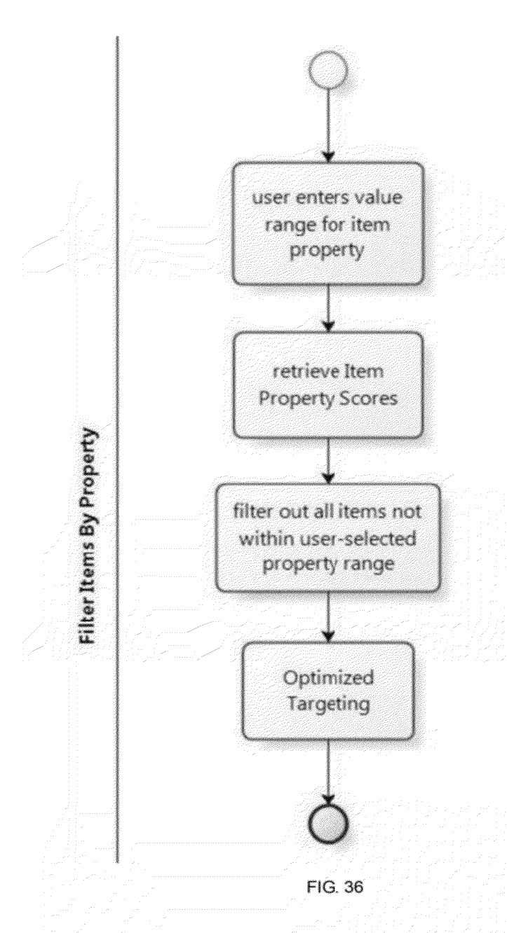

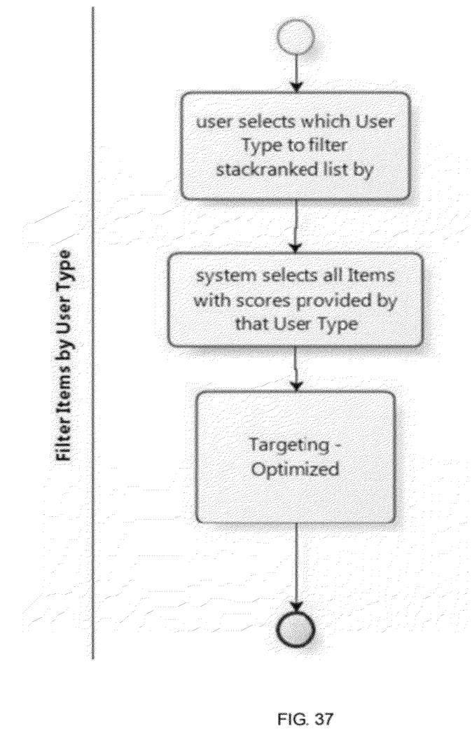

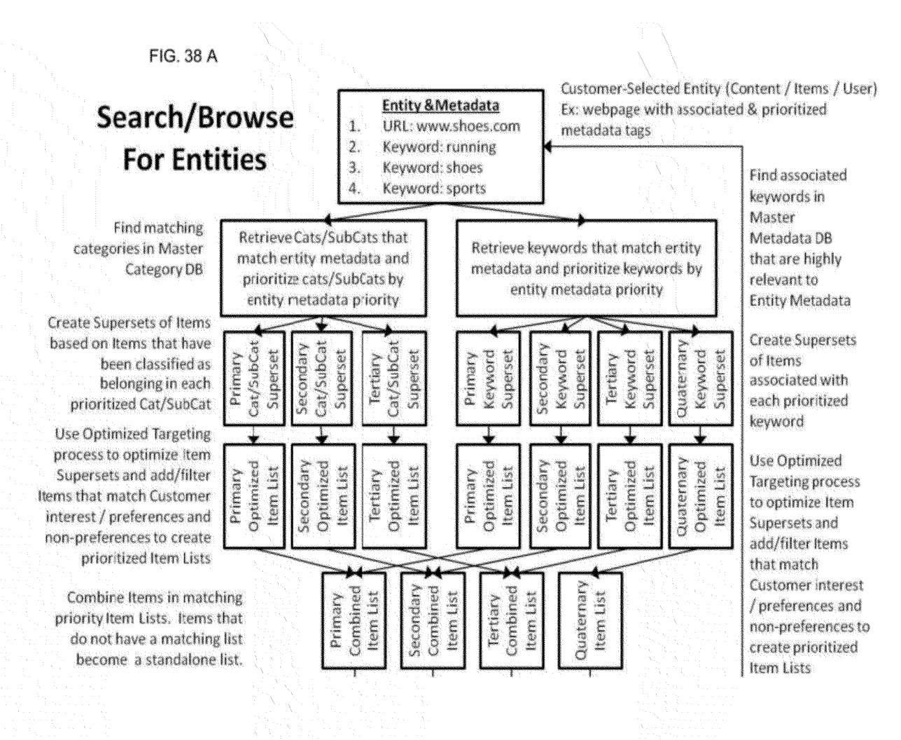

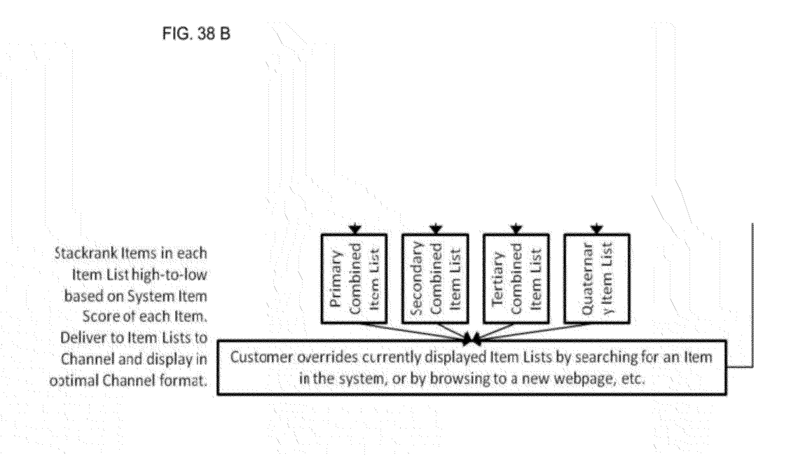

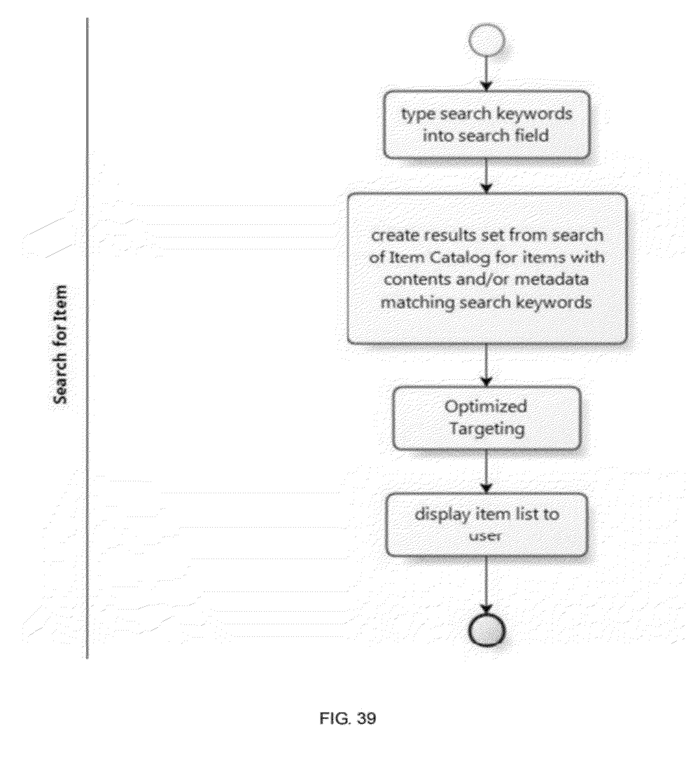

Embodiments of the systems and methods enable Customers to customize their display of highly-relevant, highly-engaging, Customer-endorsed, Buyer-validated Item Lists by additional methods including, but not limited to, searching by keyword, selecting different Item category/subcategory, choosing alternative Item metadata, changing user-types, and browsing to a new webpage. FIGS. 34A and 34B are an illustration of example embodiment of a process diagram showing a method to determine, target and display new stackranked highly-relevant, highly-engaging, Customer-endorsed, Buyer-validated Item Lists based on the Customer selecting new Item metadata to personalize the displayed Item List. FIG. 35 is an illustration of an example embodiment of process diagram showing a method to determine, target and display new stackranked highly-relevant, highly-engaging, Customer-endorsed, Buyer-validated Item Lists based on the Customer selecting new keyword/search metadata to personalize the displayed Item List. FIG. 36 is an illustration of an example embodiment of process diagram showing a method to determine, target and display new stackranked highly-relevant, highly-engaging, Customer-endorsed, Buyer-validated Item Lists based on the Customer selecting new value setting for an Item Property (e.g. cost, value, style, MPG, etc.) to personalize the displayed Item List. FIG. 37 is an illustration of an example embodiment of process diagram showing a method to determine, target and display new stackranked highly-relevant, highly-engaging, Customer-endorsed, Buyer-validated Items Lists based on the Customer selecting new User Type (Advisor, Buyer, Top Reviews, etc.) to personalize the displayed Item List. FIG. 38A, FIG. 38B, and FIG. 39 are illustrations of example embodiments of a method for determining and displaying new stackranked highly-relevant, highly-engaging, Customer-endorsed, Buyer-validated Item Lists that are relevant to the Customer when they override the currently displayed Item Lists by searching for an Item in the system, browsing to a new webpage, etc.

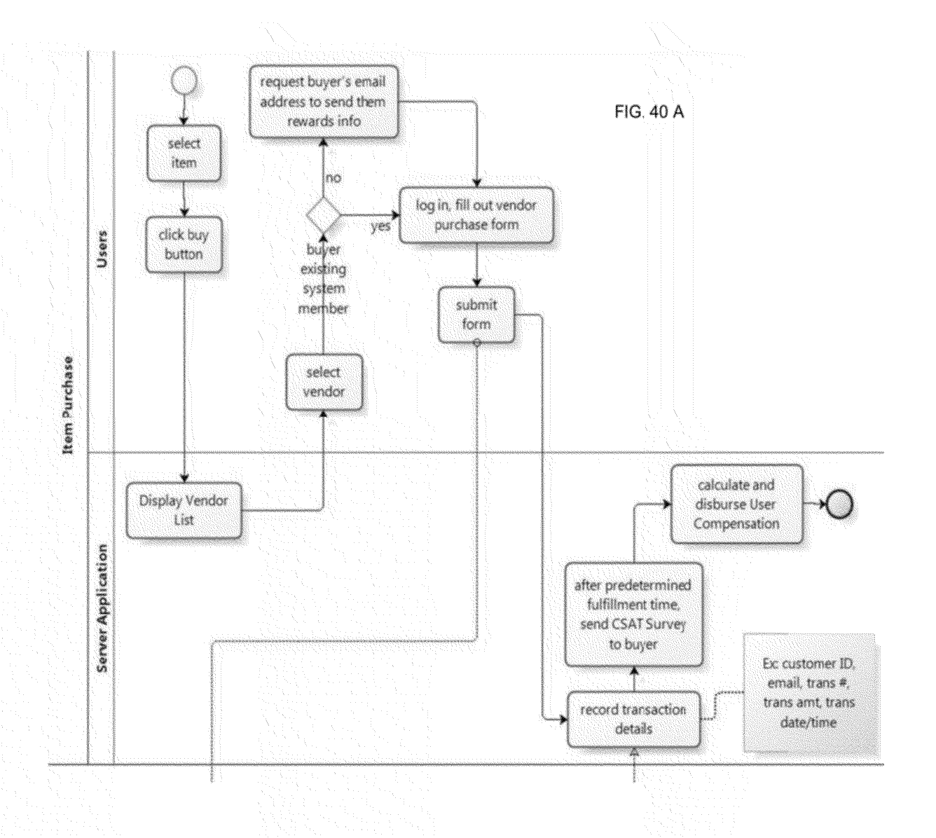

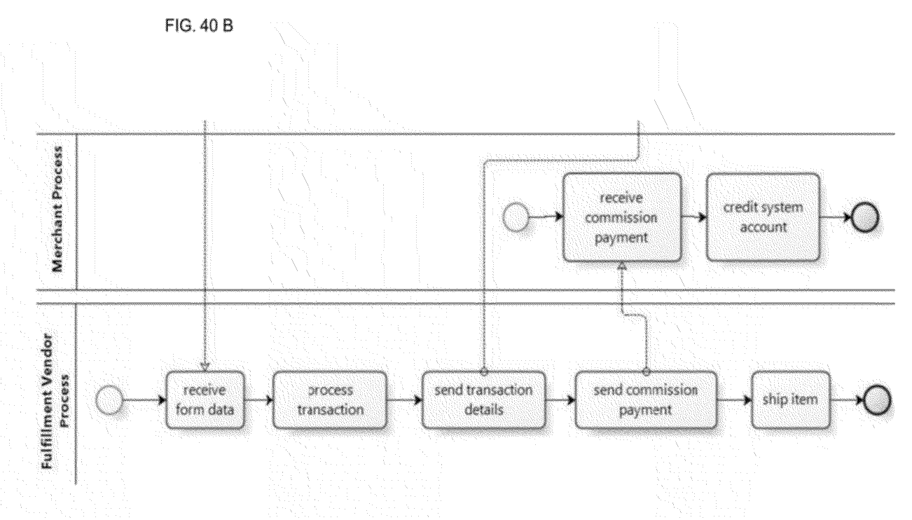

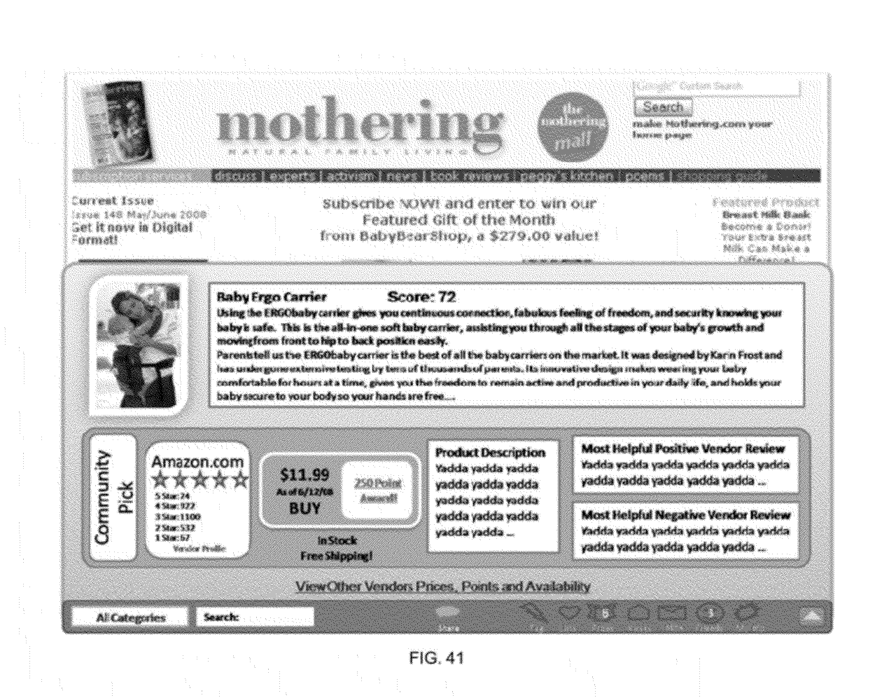

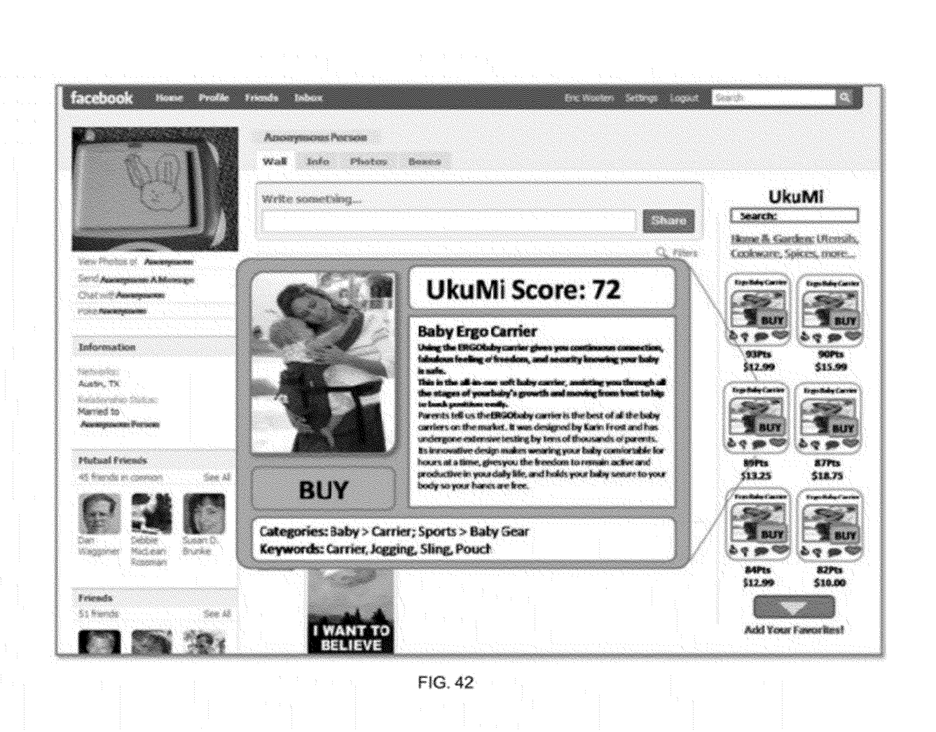

Embodiments of the systems and methods enable Customers to purchase highly-relevant, highly-engaging, Customer-endorsed, Buyer-validated Items directly from the Item Lists in each web channel including, but not limited to, the eCommerce website, cross-website browser toolbar, advertising delivery system, and embeddable widget on a partner website. FIGS. 40A and 40B are an illustration of process diagram showing how the Customer makes a purchase, of highly-relevant, highly-engaging, Customer-endorsed, Buyer-validated Item(s), in the system. FIG. 41 is an illustration of an example embodiment of method and system to enable the Customer to make a purchase, of highly-relevant, highly-engaging, Customer-endorsed, Buyer-validated Item(s), in the cross-website browser. FIG. 42 is an illustration of an example embodiment of Customer making purchase, of highly-relevant, highly-engaging, Customer-endorsed, Buyer-validated Item(s) while staying/remaining on partner website, including, but not limited to social networks in this case Facebook (e.g. Ning, MySpace, Twitter, etc.), enthusiast communities (e.g. Octamom [Austin], NaturallyCurly.com, Mothering.com, etc.), etc.

Embodiments of the systems and methods enable website partners (e.g. online communities, bloggers, content publishers, etc.) to share their own and/or their community members' favorite Items and displaying them in stackranked highly-relevant, Community-endorsed, Community Buyer-validated Item Lists to their website visitors, via embeddable widgets and/or storefronts. The method and system enables a visitor to the partner website to validate the Item endorsement(s) with their selected Advisors (incl. World, Advisors [experts], Trusted Advisors [friends], all Buyers, etc.) before purchasing the Item, as shown in FIG. 41.

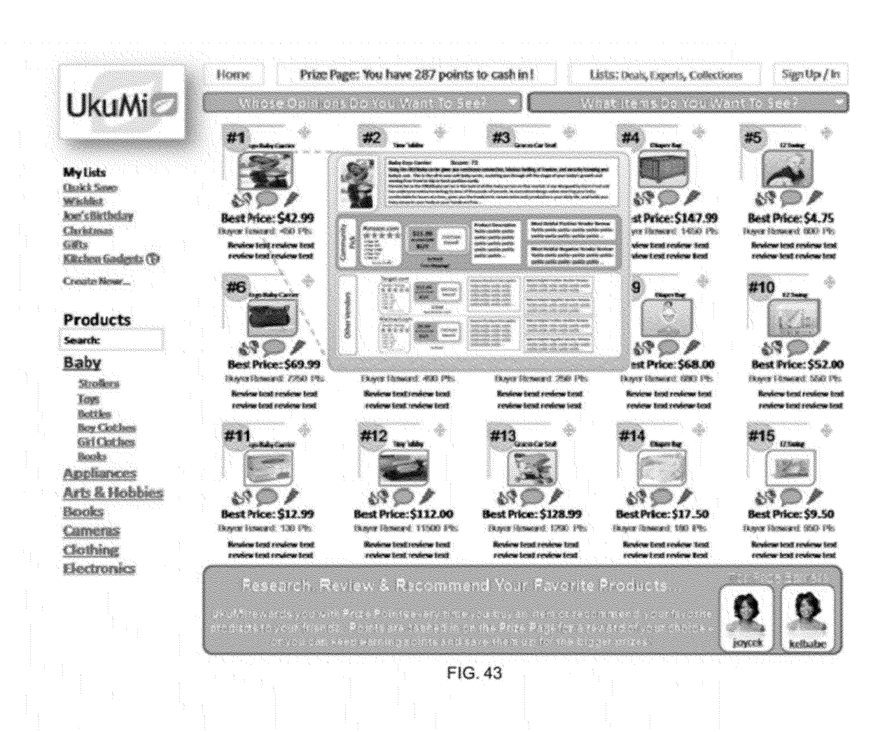

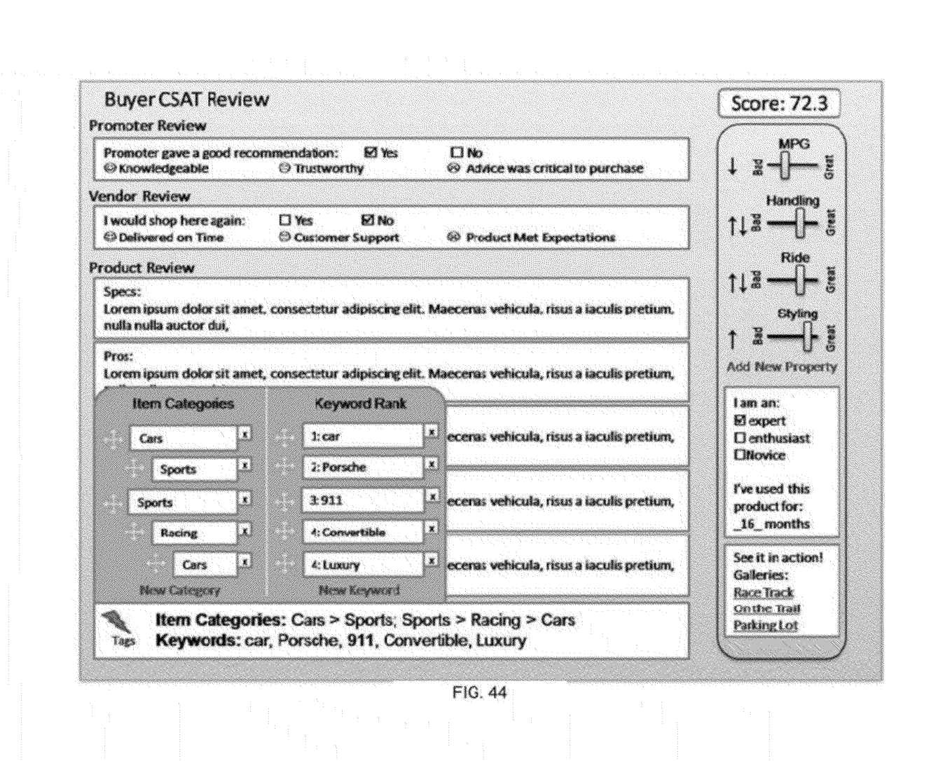

Embodiments of the systems and methods enable the Customer to select the Customer-endorsed, Buyer-validated Item Vendor based on the opinion feedback from other Customers. The method and system capture vendor feedback after Customers complete purchase, vendor fulfills their order and Items are delivered to the Customer. FIG. 43 is an illustration of an example embodiment of Customer selecting a vendor that has been highly endorsed by other system users.

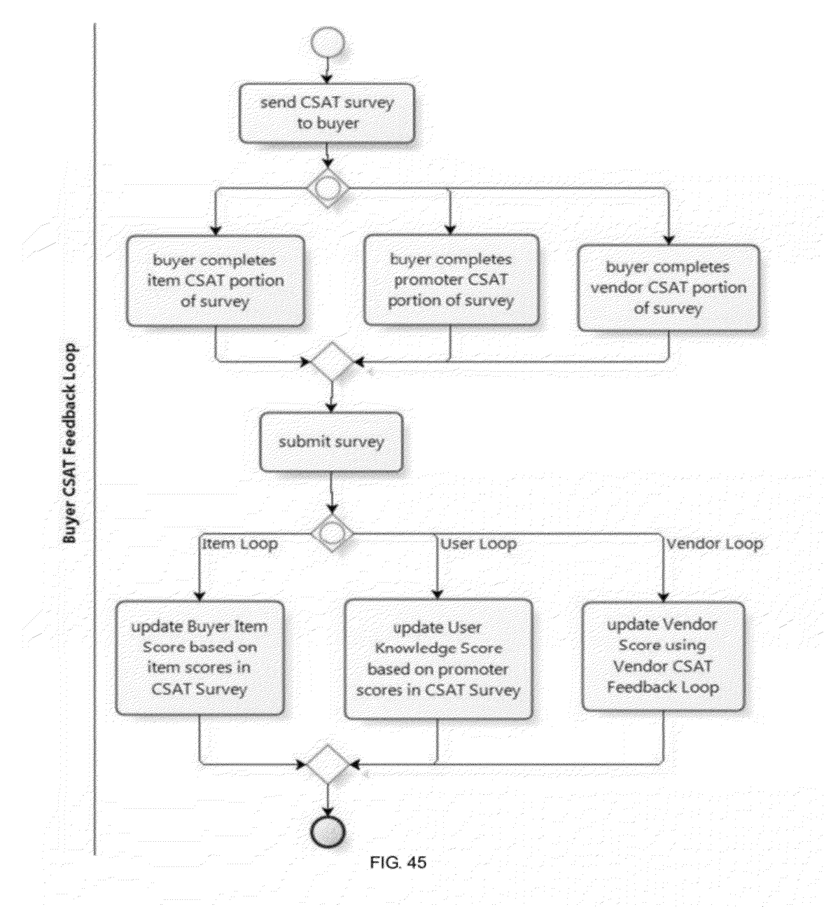

Embodiments of the systems and methods enable display of only Buyer-validated Items in Item Lists, based on direct Buyer opinion feedback, after an Item purchase has been made in the system. The method and system send the Customer (“Buyer”) a Buyer Satisfaction Survey (“CSAT”) to verify the quality/value of the purchased Item, the Item Vendor and, if applicable, Item Endorser (“Promoter”). FIG. 44 is an illustration of an example embodiment of method and system to solicit Customer feedback via the Buyer Satisfaction survey. FIG. 45 is an illustration of an example embodiment of method to determine and display Buyer-validated Items in Item List. The system updates the Entity (Item/User/Vendor) Scores and associated metadata based on the opinions of a Customer that has purchased an Item in the system and completed the Buyer satisfaction survey (“CSAT”). The Buyer Item Score (as calculated for an individual Customer User Type) is also used to validate each Customer User Type Item Score.

Embodiments of the systems and methods utilize the opinion feedback provided in the Buyer Satisfaction Survey to update the System Item Score, as shown in FIG. 23. The system and method utilizes the updated Item Score when performing the subsequent stack-ranking and display of that particular Item across the platform.

Embodiments of the systems and methods utilize the opinion feedback provided in the Buyer Satisfaction Survey to update vendor endorsement ranking. The system and method utilizes the updated Vendor Score when performing the subsequent stack-ranking and display of vendors for a particular Item across the platform, as shown in FIGS. 40A and 40B.

Embodiments of the systems and methods enable the Customer to select, share, endorse and/or pull an Item or Items, which have been Customer/Advisor/Community-endorsed and Buyer-validated from stack-ranked Items lists, in multiple channels across the platform, and share them with other users and non-users (including within collection(s) of User(s)'s favorite Items), across multiple communication channels. The method and system enables the Customer to send these Items, including manufacturer information, user-endorsed vendors, Item description and user Item opinions using all Sales Channels. The method and system enables the Customer receiving the Item endorsement to validate this Item endorsement(s) with their selected Advisors (incl. world, community, experts, friends, buyers, etc.) before purchasing the Item directly in the system.

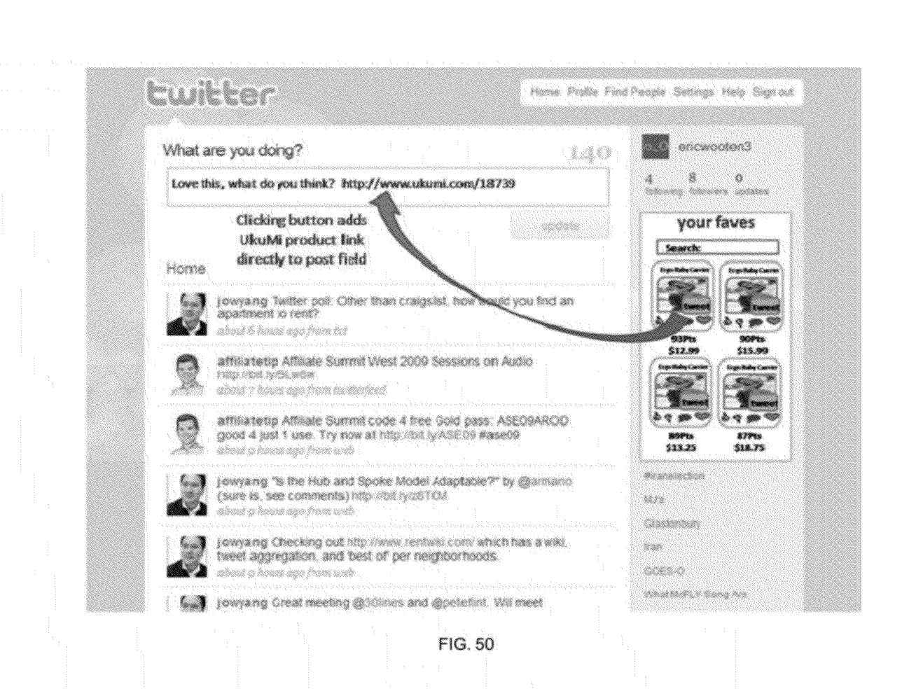

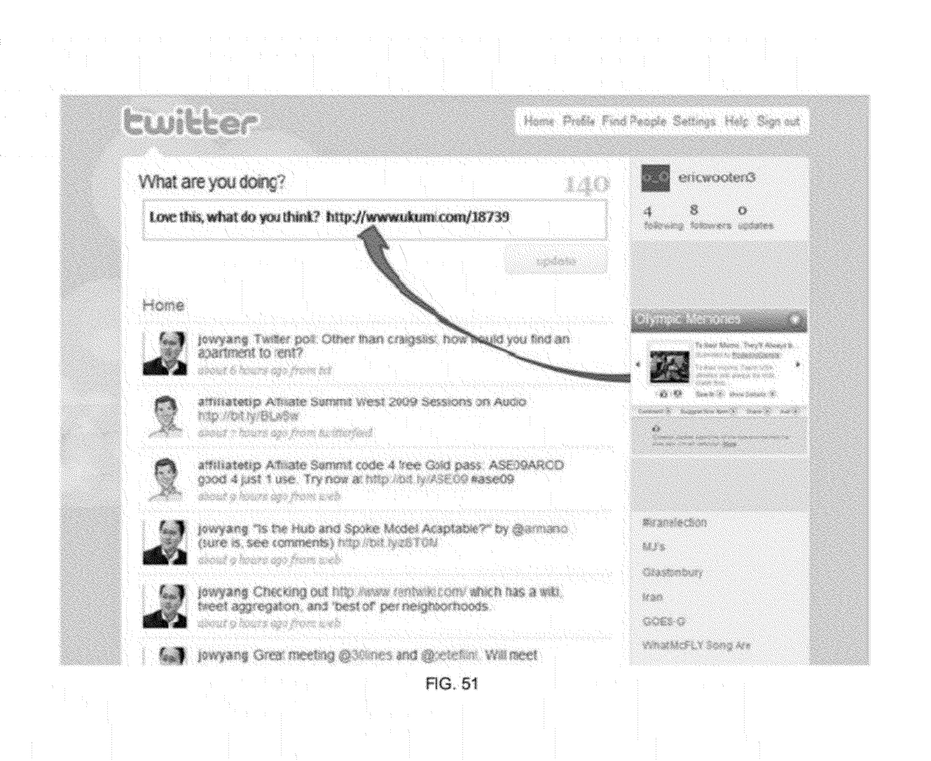

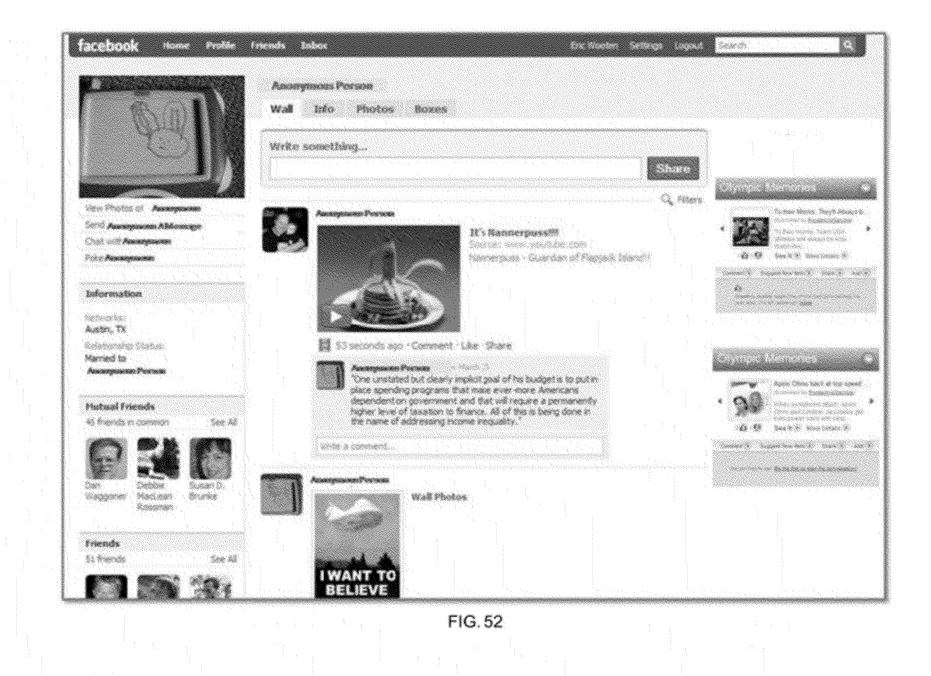

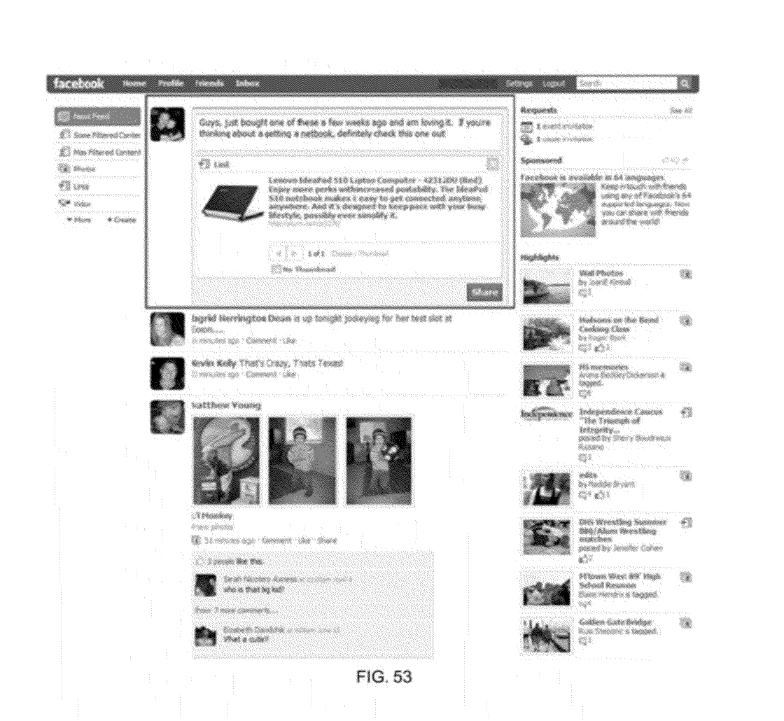

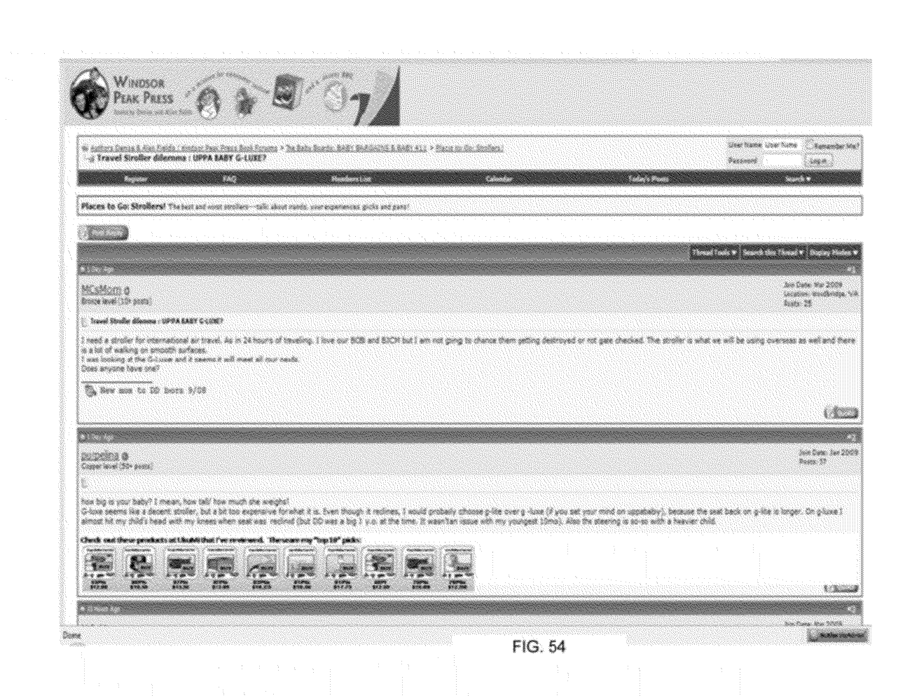

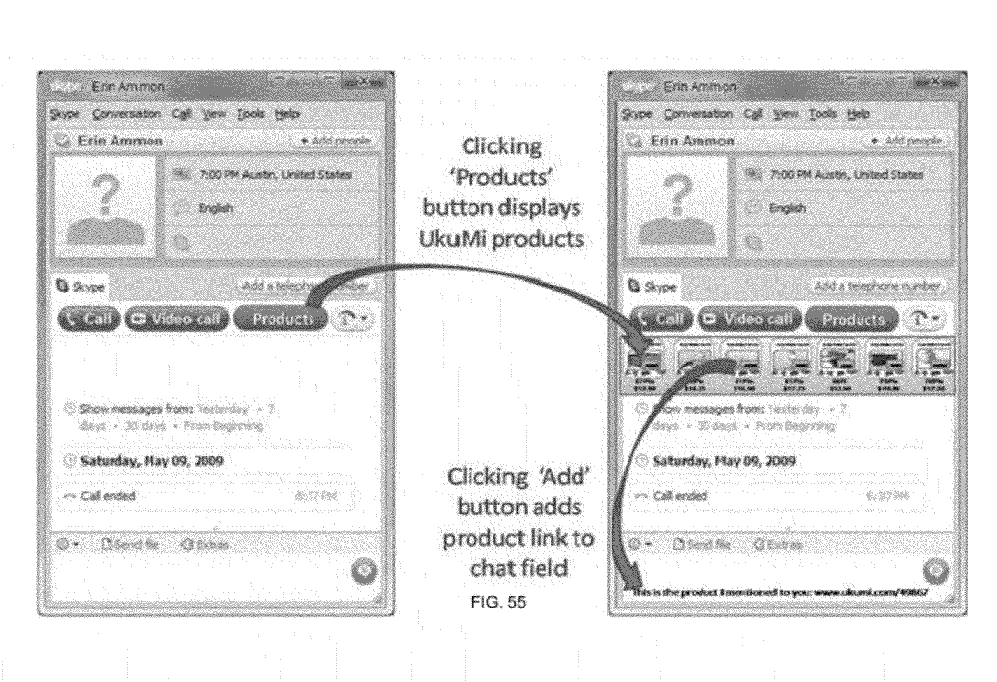

FIG. 50 is an illustration of an example embodiment of Customer sharing a Customer-endorsed, Buyer-validated Item display with another Customer (“system member” and/or “non system member”) utilizing a social network channel including, but not limited to, in this case Twitter (e.g. Facebook, Myspace, Bebo, Ning, etc.). FIG. 53 an illustration of example embodiment of Customer sharing a highly-relevant, highly-engaging, Customer-endorsed, Buyer-validated Item display (within their personal space [e.g. Facebook “Wall”]) via a social network including, but not limited to, in this case Facebook (e.g. Ning, MySpace, Bebo, LinkedIn, etc.). FIG. 54 is an illustration of example embodiment of Customer sharing a highly-relevant, highly-engaging, Customer-endorsed, Buyer-validated Item display via an online forum including, but not limited to, in this case Mothering.com (e.g. blog, etc.). FIG. 55 is an illustration of an example embodiment of Customer sharing a highly-endorsed, Customer-endorsed, Buyer-validated Item display to another Customer (“system member” and/or “non system-member”) via a messaging client including, but not limited to, in this case Skype.

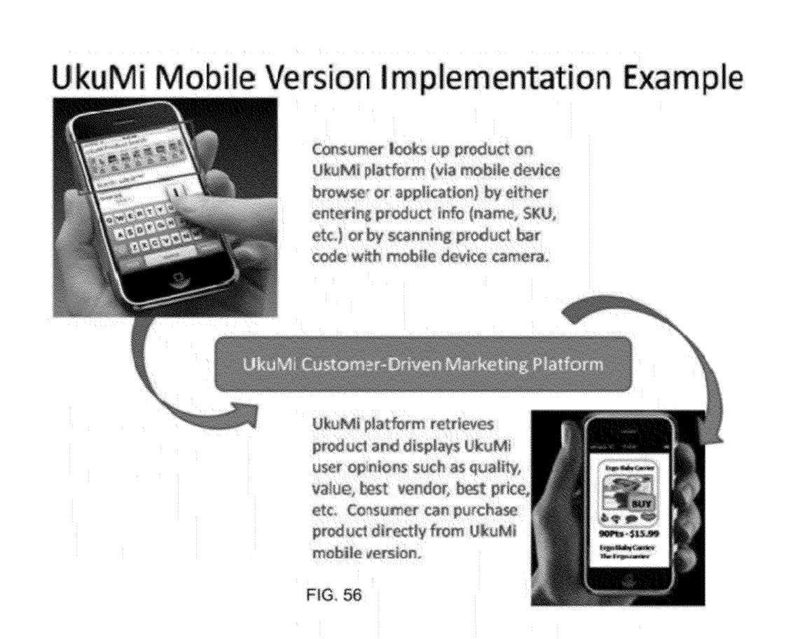

Embodiments of the systems and methods display stack-ranked highly-relevant, highly-engaging, Customer-endorsed, Buyer-validated Item lists on mobile devices. FIG. 56 is an illustration of an example embodiment of method and system to display a stack-ranked highly-relevant, highly-engaging, Customer-endorsed, Buyer-validated Item list to a Customer (“system user”) utilizing a mobile device including, but not limited to, in this case an iPhone (e.g. Blackberry, Verizon Hub, etc.).

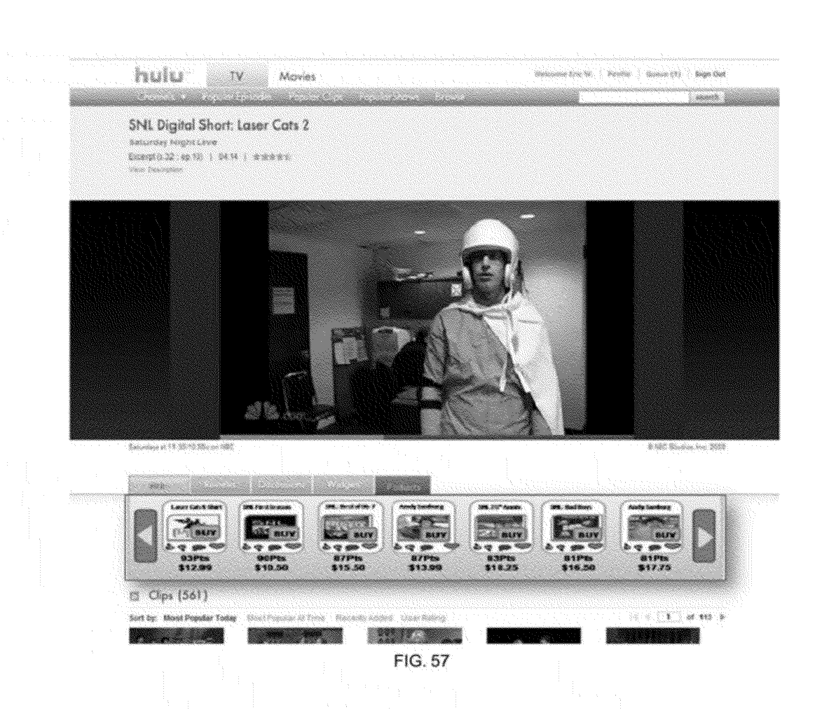

Embodiments of the systems and methods display stack-ranked highly-relevant, highly-engaging, Customer-endorsed, Buyer-validated Item lists on internet-connected media channels. FIG. 57 is an illustration of an example embodiment of method and system to display a stack-ranked highly-relevant, highly-engaging, Customer-endorsed, Buyer-validated Item list to a Customer (“system user”) utilizing a media show provided by Hulu.

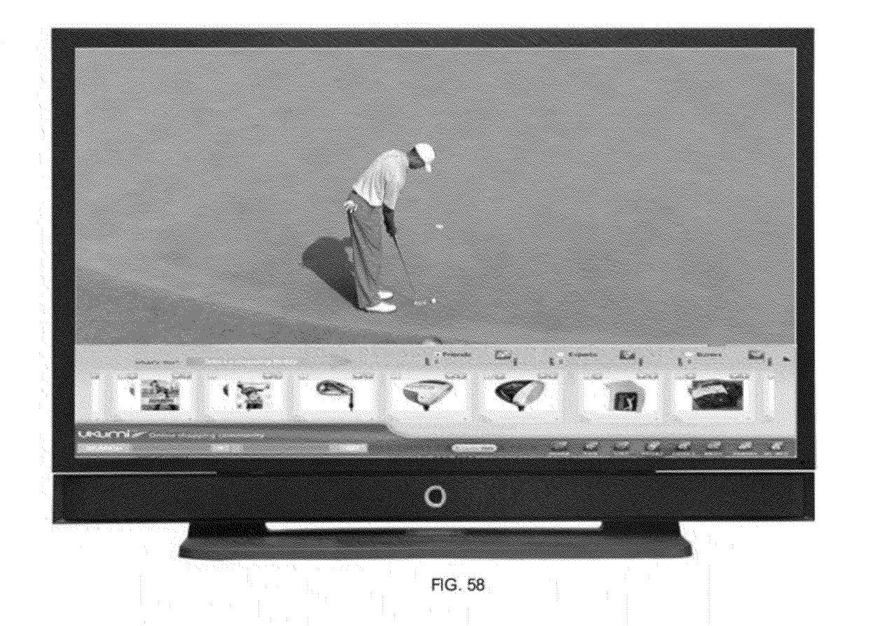

Embodiments of the systems and methods display stack-ranked highly-relevant, highly-engaging, Customer-endorsed, Buyer-validated Item lists on cable and satellite television channels. FIG. 58 is an illustration of an example embodiment of method and system to display a stack-ranked highly-relevant, highly-engaging, Customer-endorsed, Buyer-validated Item list to a Customer (“system user”) utilizing a digital Cable (e.g. Time Warner Cable, ComCast) or Satellite (e.g. DirecTV, Dish Network, etc.) broadcast provided by, but not limited to, in this case NBC Universal (e.g. Fox, ABC/ESPN/Disney, Viacom/CBC, etc.).

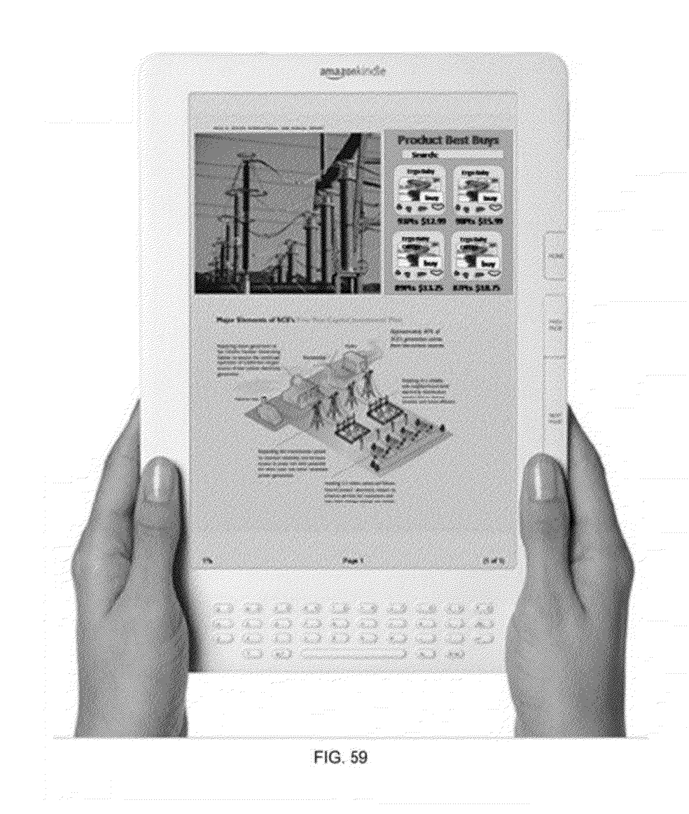

Embodiments of the systems and methods display stack-ranked highly-relevant, highly-engaging, Customer-endorsed, Buyer-validated Item lists on portable communication/content devices such as eReaders. FIG. 59 is an illustration of an example embodiment of method and system to display a stack-ranked highly-relevant, highly-engaging, Customer-endorsed, Buyer-validated Item list to a Customer (“system user”) utilizing an eReader (e.g. Amazon Kindle).

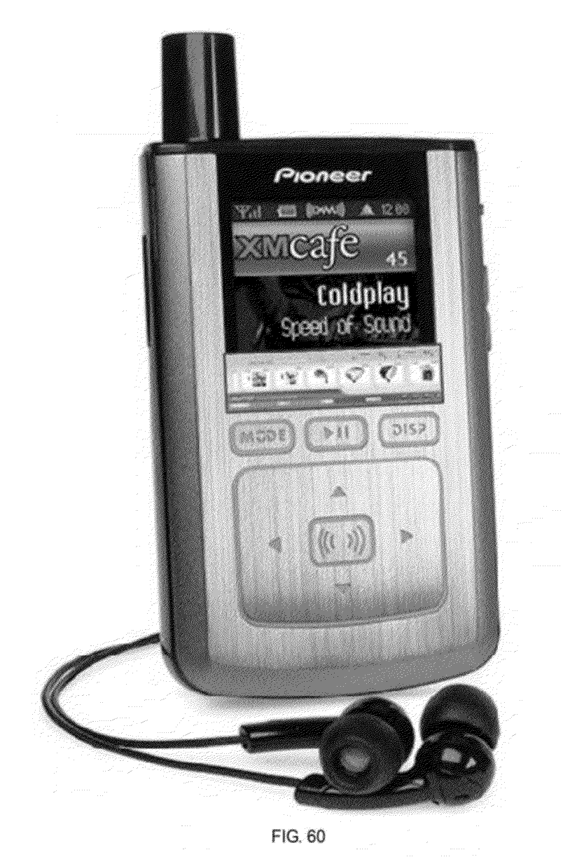

Embodiments of the systems and methods display stack-ranked highly-relevant, highly-engaging, Customer-endorsed, Buyer-validated Item lists on digital radio broadcasts. FIG. 60 is an illustration of an example embodiment of method and system to display stack-ranked highly-relevant, highly-engaging, Customer-endorsed, Buyer-validated Item Lists on smart appliances. Item list to a Customer (“system user”) utilizing a digital radio broadcast (e.g. Sirius/XM radio).

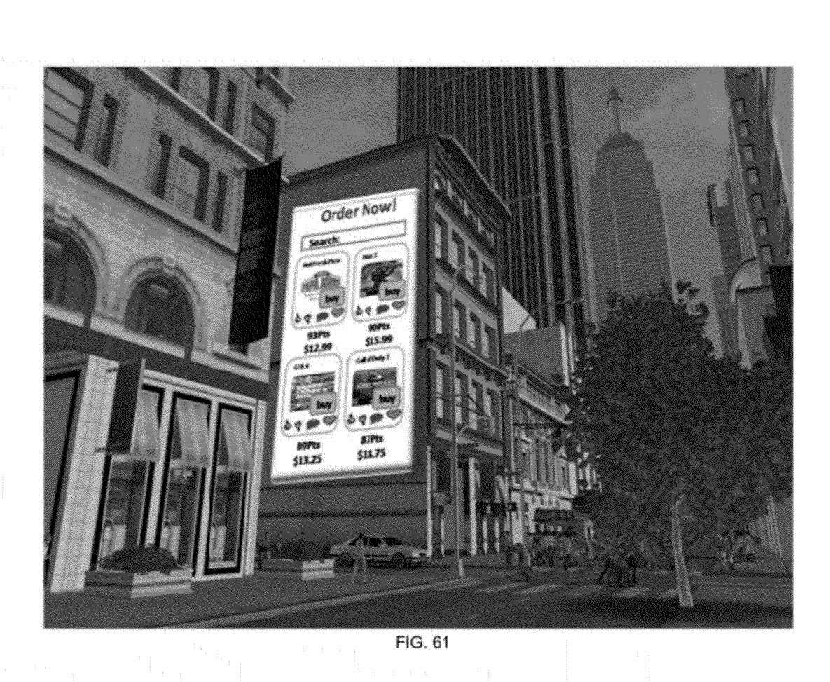

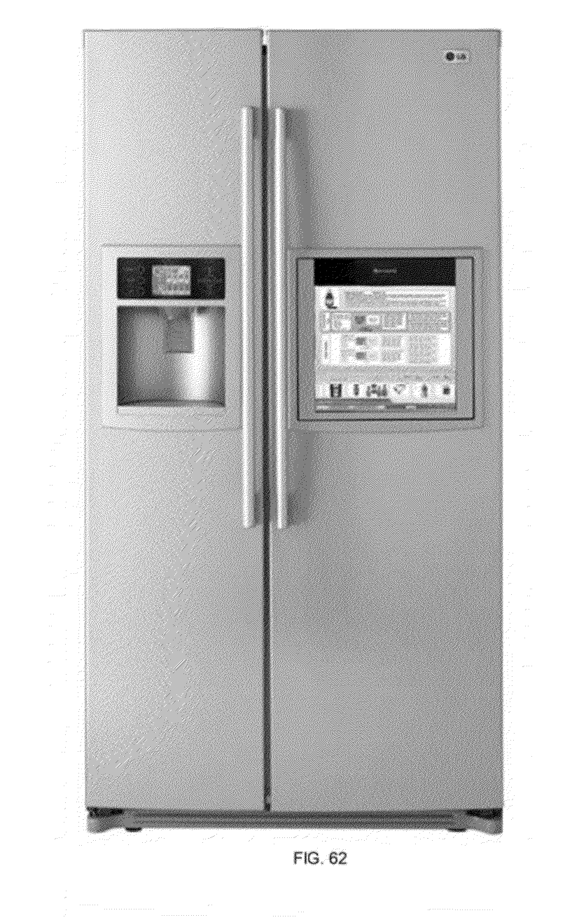

Embodiments of the systems and methods display stack-ranked highly-relevant, highly-engaging, Customer-endorsed, Buyer-validated Item lists within internet-connected games. FIG. 61 is an illustration of an example embodiment of method and system to display a stack-ranked highly-relevant, highly-engaging, Customer-endorsed, Buyer-validated Item list to a Customer (“system user”) utilizing internet-connected gaming (e.g. Grand Theft Auto, Farmville, XBox, PS3, NCSoft, etc.).

Embodiments of the systems and methods display stack-ranked highly-relevant, highly-engaging, Customer-endorsed, Buyer-validated Item lists on smart appliances. FIG. 62 is an illustration of an example embodiment of method and system to display a stack-ranked highly-relevant, highly-engaging, Customer-endorsed, Buyer-validated Item list to a Customer (“system user”) utilizing a smart appliance (e.g. certain LG refrigerator, Fugoo appliance, etc.)

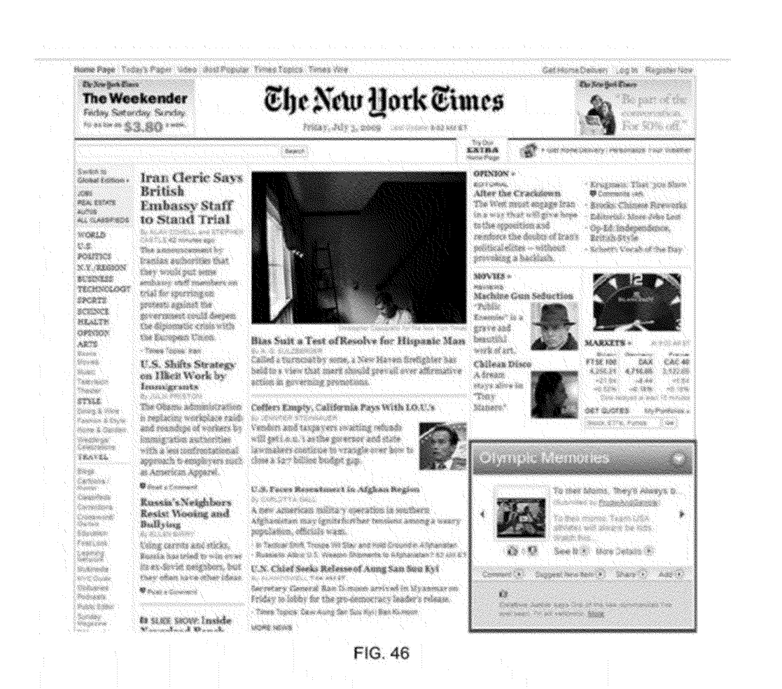

Embodiments of the systems and methods display stack-ranked highly-relevant, highly-engaging, Customer-endorsed, Buyer-validated Item Lists on internet-connected content provider assets. FIG. 46 is an illustration of method and system to display a stack-ranked highly-relevant, highly-engaging, Customer-endorsed, Buyer-validated Item list to a Customer (“system user”) utilizing an internet-connected content provider asset including, but not limited to, in this case NewYorkTimes.com (e.g. WallStreetJournal.com, CNNMoney.com (e.g. Fortune.com), etc.)

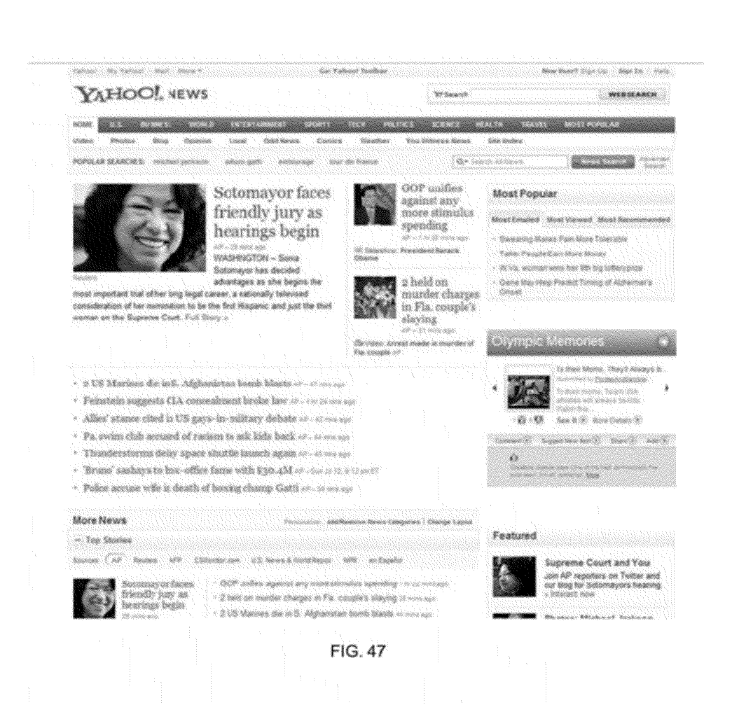

Embodiments of the systems and methods display stack-ranked highly-relevant, highly-engaging, Customer-endorsed, Buyer-validated Item Lists on content aggregation asset properties. FIG. 47 is an illustration of an example embodiment of method and system to display a stack-ranked highly-relevant, highly-engaging, Customer-endorsed, Buyer-validated Item List via an embedded widget to a Customer viewing a content aggregation site including, but not limited to, in this case Yahoo News (e.g. Google News, Digg.com, MSN News, AOL News, YouTube, etc.).

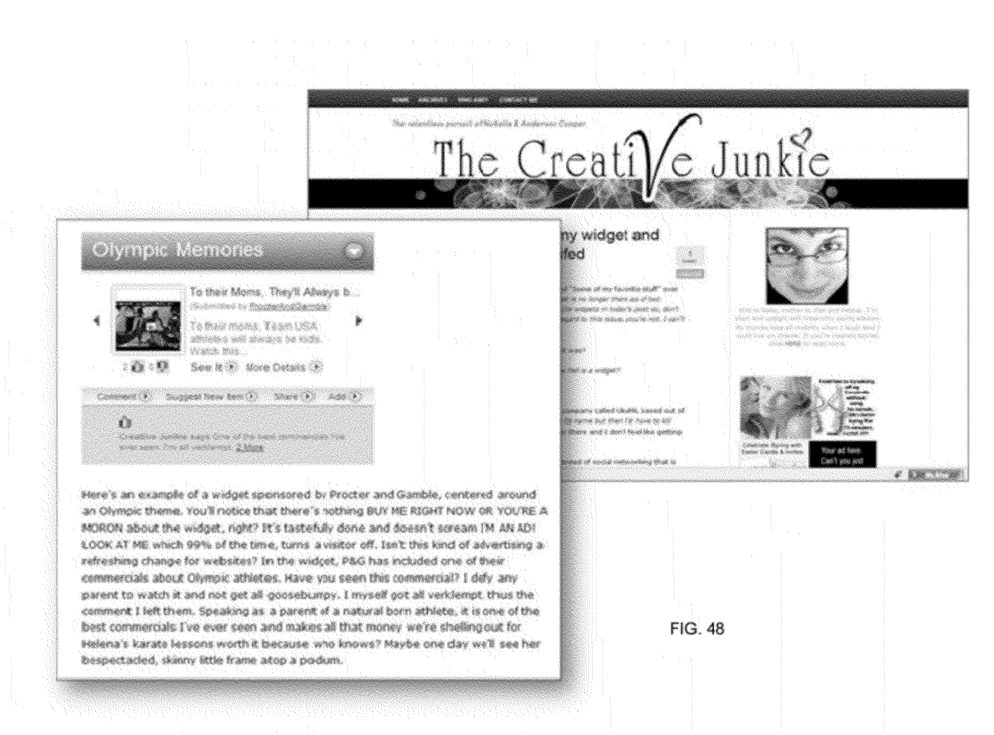

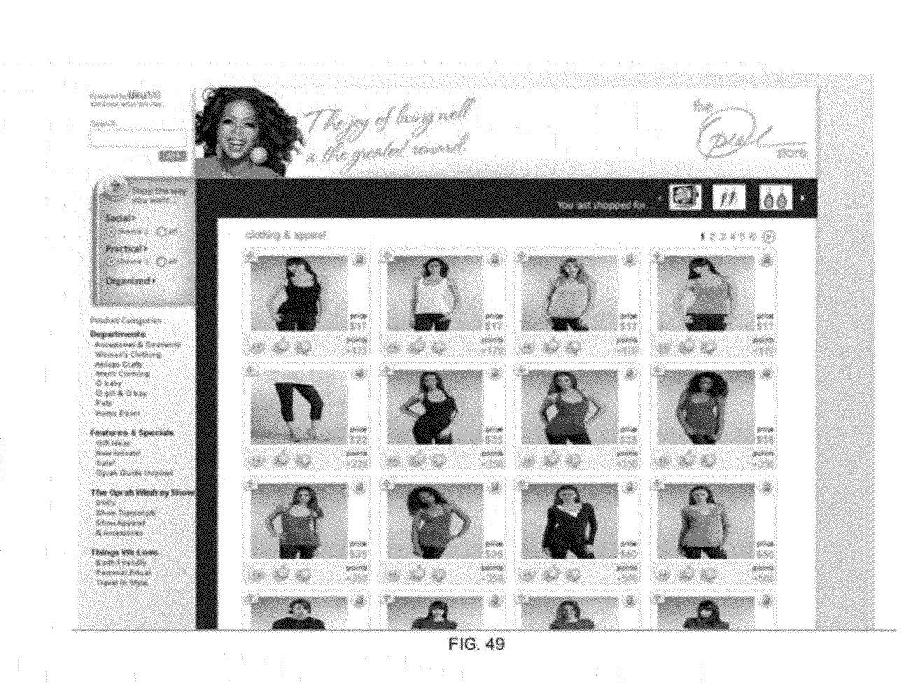

Embodiments of the systems and methods display stack-ranked highly-relevant, highly-engaging, Customer-endorsed, Buyer-validated Item Lists via “Partner-branded”, internet-connected assets including, but not limited to, eCommerce website, embeddable eCommerce storefront, cross-website browser toolbar, advertising delivery system, social network(s), social media platform(s), social business platform(s), embeddable interactive widget, etc. FIG. 48 is an illustration of an example embodiment of method and system to display a stack-ranked highly-relevant, highly-engaging, Customer-endorsed and Community Buyer-validated Item List via a “Partner branded” version of the system interface. In the Partner-branded site, the Partner is the primary driver of the method whereby Items are displayed in the list (e.g. the Partner decides if they want to manually select which Items display, whether their Partner site users (their “Community”) can influence Item display, or whether the Partner wants to use the overall system recommendations from other Sales Channels). FIG. 63 is an illustration of example embodiment of systems and methods delivering highly-relevant, highly-engaging, Customer-endorsed, Buyer-validated Item display (in this case, multiple branded advertising campaigns including TV commercials, celebrity endorsements, eCommerce products, interactive games, etc.) delivered via the system's advertising delivery/eCommerce system.

Embodiments of the systems and methods enable User(s) that created an Item or Item List to update individual Item(s) so that other User(s) viewing and/or engaging with the updated Item(s) or Item List to automatically see the Item(s) updates, across all Sales Channels. FIG. 72 is an illustration of example embodiment of systems and methods to enable User(s) viewing an Item(s) or Item List to endorse and/or pull (“grab”) an individual Item(s) or Item List into that User(s)'s collection of Item(s), across all Sales Channels. FIG. 73 is an illustration of example embodiment of systems and methods to enable User(s) to update an Item(s) that they created, and for the update to be automatically seen by other User(s) viewing the Item, including within a collection of Item(s) endorsed and/or pulled (“grabbed”) by any User(s), across all Sales channels.

Embodiments of the systems and methods enable a User(s) that has indicated an interest (e.g. system activity, searches, user profile entries, social relationship, Item endorsement, etc.) to automatically or manually approve and receive, across all Sales Channels, new Item(s) or Item Lists from other system User(s) that are similar (e.g. category, tag, brand, use, type, etc.) to Item(s) or Items Lists that the User has previously added to their collection of Item(s) or Item Lists. FIG. 74 is an illustration of example embodiment of systems and methods to enable a User(s) to automatically or manually approve and receive, across all Sales Channels, new Item(s) or Item Lists which are similar to Item(s) or Item List that the User has previously added to their collection of Item(s) or Item Lists.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A non-transitory processor-readable medium storing code representing instructions to be executed by a processor, the code comprising code to cause the processor to:
provide a plurality of content items to a user based on at least one of an association with an interest group, the user browsing a brand content inventory, or the user browsing a user-generated grouping of content;
receive, from the user, a signal representing an opinion associated with a content item from the plurality of content items;
receive, from the user, a signal representing a request to pull the content item to a content collection of the user based on the opinion, the request indicating an endorsement of the content item; and
modify, based on the opinion and the endorsement, a status of the content item such that a second user is presented with the content item based on the status and not with the remaining content items from the plurality of content items.
